(19) United States
(12) Patent Application Publication
(10) Pub. No.: US 2024/0089577 A1
(43) Pub. Date: Mar. 14, 2024

(54) IMAGING DEVICE, IMAGING SYSTEM, IMAGING METHOD, AND COMPUTER PROGRAM

(71) Applicant: Sony Group Corporation, Tokyo (JP)

(72) Inventors: Kenji SUZUKI, Tokyo (JP); Suguru AOKI, Tokyo (JP); Ryuta SATOH, Tokyo (JP)

(73) Assignee: Sony Group Corporation, Tokyo (JP)

(21) Appl. No.: 18/262,380

(22) PCT Filed: Dec. 6, 2021
(86) PCT No.: PCT/JP2021/044798

§ 371 Date: Jul. 21, 2023

(30) Foreign Application Priority Data
Jan. 29, 2021 (JP) 2021-013993

(51) Int. Cl. H04N 23/61

(52) U.S. Cl. CPC H04N 23/61

(57) ABSTRACT

An imaging device includes: an imaging section that has a pixel region where a plurality of pixels is arrayed, a readout unit control section that controls readout units each set as a part of the pixel region, a readout control section that controls readout of pixel signals from the pixels included in the pixel region for each of the readout units set by the readout unit control section, a recognition section that has a machine learning model trained on the basis of leaning data, and a determination basis calculation section that calculates a determination basis of a recognition process performed by the recognition section. The recognition section performs the recognition process for each of the readout units. The determination basis calculation section calculates a determination basis for each of the readout units.

### TECHNICAL FIELD

A technology disclosed in the present description (hereinafter referred to as the “present disclosure”) relates to an imaging device, an imaging system, an imaging method, and a computer program that have an image recognition function to recognize a captured image.

### BACKGROUND ART

Studies on a machine learning system using deep learning have been actively conducted in recent years. For example, face detection and object recognition at levels exceeding human abilities are realizable by applying deep learning to an imaging field. Moreover, to handle an issue that a machine learning system performs black-box processes to obtain a recognition result, studies have been further conducted to achieve presentation of a determination basis of a machine learning system (e.g., see NPL 1).

For example, there has been proposed an analysis program written so as to generate, during an image recognition process, a map indicating degrees of attention to respective image portions of a false inference image, to which attention is paid at the time of inference by using a Grad-CAM method, at the time of formation of a refine image with a change of the false inference image, which is an input image at the time of inference of a false label, such that a score of a ground truth label of the inference becomes maximum (see PTL 1).

In a case where an image recognition technology is applied to automated driving or the like, real-time presentation of a determination basis to a driver needs to be achieved. However, there is a limitation to speed-up of calculation of a determination basis for moving images. Moreover, a processing load increases with improvement of image quality of cameras. In this situation, real-time presentation of a determination basis is more difficult to achieve.

### CITATION LIST

### Patent Literature

[PTL 1]
   Japanese Patent Laid-Open No. 2020-197875

### Non Patent Literature

[NPL 1]
   David Gunning, “Explainable Artificial Intelligence (XAI),” [online] DARPA, [searched November 9, 2020], Internet (URL: https://www.darpa.mil/program/explainable-artificial-intelligence)
[NPL 2]
   R. Selvaraju et al, “Grad-CAM: Visual Explanations from Deep Networks via Gradient-based Localization”
[NPL 3]
   Grad-CAM: Visual Explanations from Deep Networks via Gradient-based Localization <https://arxiv.org/abs/1610.02391>
[NPL 4]
   “Why Should I Trust You?”: Explaining the Predictions of Any Classifier <https://arxiv.org/abs/1602.04938>
[NPL 5]
   Interpretability Beyond Feature Attribution: Quantitative Testing with Concept Activation Vectors (TCAV)<https://arxiv.org/pdf/1711.11279.pdf>

### SUMMARY

### Technical Problem

An object of the present disclosure is to provide an imaging device, an imaging system, an imaging method, and a computer program that perform a recognition process for recognizing a captured image by using a trained machine learning model and have a function of calculating a determination basis of the recognition process.

### Solution to Problem

The present disclosure has been developed in consideration of the aforementioned problem. A first aspect of the present disclosure is directed to an imaging device including an imaging section that has a pixel region where a plurality of pixels is arrayed, a readout unit control section that controls readout units each set as a part of the pixel region, a readout control section that controls readout of pixel signals from the pixels included in the pixel region for each of the readout units set by the readout unit control section, a recognition section that has a machine learning model trained on the basis of leaning data, and a determination basis calculation section that calculates a determination basis of a recognition process performed by the recognition section. The recognition section performs the recognition process for the pixel signals for each of the readout units, and the determination basis calculation section calculates a determination basis for a result of the recognition process performed for each of the readout units.

The recognition section learns learning data for each of the readout units by using a neural network model. In addition, the determination basis calculation section infers a part that is included in the pixel region of each of the readout units and that affects respective classes, in an inference result of classification obtained by the neural network model.

The recognition section executes a machine learning process using an RNN for pixel data of a plurality of the readout units in an identical frame image, to execute the recognition process on the basis of a result of the machine learning process.

In addition, a second aspect of the present disclosure is directed to an imaging system including an imaging device and an information processing device. The imaging device includes an imaging section that has a pixel region where a plurality of pixels is arrayed, a readout unit control section that controls readout units each set as a part of the pixel region, and a readout control section that controls readout of pixel signals from the pixels included in the pixel region for each of the readout units set by the readout unit control section. The information processing device includes a recognition section that has a machine learning model trained on the basis of learning data, and a determination basis calculation section that calculates a determination basis of a recognition process performed by the recognition section. The recognition section performs the recognition process for the pixel signals for each of the readout units, and the determination basis calculation section calculates a determination basis for a result of the recognition process performed for each of the readout units.

Note that the “system” herein refers to a logical set of a plurality of devices (or function modules practicing specific functions). The respective devices or function modules of the system are not particularly required to be accommodated in a single housing.

In addition, a third aspect of the present disclosure is directed to an imaging method executed by a processor, the imaging method including a readout unit control step that controls readout units each set as a part of a pixel region that is included in an imaging section and contains an array of a plurality of pixels, a readout control step that controls readout of pixel signals from the pixels included in the pixel region for each of the readout units set by the readout unit control step, a recognition step based on a machine learning model trained on the basis of leaning data, and a determination basis calculation step that calculates a determination basis of a recognition process performed by the recognition step. The recognition step performs the recognition process for the pixel signals for each of the readout units, and the determination basis calculation step calculates a determination basis for a result of the recognition process performed for each of the readout units.

In addition, a fourth aspect of the present disclosure is directed to a computer program written in a computer-readable form, the computer program causing a computer to function as a readout unit control section that controls readout units each set as a part of a pixel region that is included in an imaging section and contains an array of a plurality of pixels, a readout control section that controls readout of pixel signals from the pixels included in the pixel region for each of the readout units set by the readout unit control section, a recognition section that has a machine learning model trained on the basis of leaning data, and a determination basis calculation section that calculates a determination basis of a recognition process performed by the recognition step. The recognition section performs the recognition process for the pixel signals for each of the readout units, and the determination basis calculation section calculates a determination basis for a result of the recognition process performed for each of the readout units.

The computer program according to the fourth aspect of the present disclosure is defined as a computer program written in a computer-readable form so as to achieve predetermined processes by using a computer. In other words, the computer program according to the fourth aspect of the present disclosure after installed into a computer enables this computer to exert cooperative operations and achieve operational effects similar to operational effects offered by the imaging device according to the first aspect of the present disclosure.

### Advantageous Effects of Invention

The present disclosure can provide an imaging device, an imaging system, an imaging method, and a computer program that achieve a high-speed recognition process for recognizing a captured image by using a trained machine learning model and high-speed calculation of a determination basis of the recognition process.

Note that advantageous effects described in the present description are presented only by way of example. Advantageous effects produced by the present disclosure are not limited to these. Moreover, the present disclosure offers further additional advantageous effects other than the above advantageous effects in some cases.

Further different objects, characteristics, and advantages of the present disclosure will become obvious in the light of more detailed explanation based on embodiments described below and accompanying drawings.

### BRIEF DESCRIPTION OF DRAWINGS

FIG. 1 is a diagram depicting a functional configuration example of an imaging device 100.

FIG. 2 is a diagram depicting an implementation example of hardware of the imaging device 100.

FIG. 3 is a diagram depicting another implementation example of hardware of the imaging device 100.

FIG. 4 is a diagram depicting a stacked-type image sensor 400 having a double-layer structure.

FIG. 5 is a diagram depicting a stacked-type image sensor 500 having a triple-layer structure.

FIG. 6 is a diagram depicting a configuration example of a sensor section 102.

FIG. 7 is a diagram depicting a mechanism of an image recognition process using a CNN.

FIG. 8 is a diagram depicting a mechanism of an image recognition process which obtains a recognition result from a part of an image corresponding to a recognition target.

FIG. 9 is a diagram depicting an example of an identification process (recognition process) using a DNN in a case where time-series information is not applied.

FIG. 10 is a diagram depicting an example of the identification process (recognition process) using a DNN in a case where time-series information is not applied.

FIG. 11 is a diagram depicting a first example of the identification process using a DNN in a case where time-series information is applied.

FIG. 12 is a diagram depicting the first example of the identification process using a DNN in a case where time-series information is applied.

FIG. 13 is a diagram depicting a second example of the identification process using a DNN in a case where time-series information is applied.

FIG. 14 is a diagram depicting the second example of the identification process using a DNN in a case where time-series information is applied.

FIG. 15 is a diagram depicting a configuration example of a DNN using a multilayer convolutional neural network.

FIG. 16 is a diagram depicting a configuration example which calculates a determination basis of a DNN that performs the identification process for time-series information.

FIG. 17 is a diagram for explaining an outline of the present disclosure.

FIG. 18 is a flowchart illustrating processing procedures for executing respective processes for image recognition and determination basis calculation achieved by a recognition processing section 104.

FIG. 19 is a diagram depicting an example of image data of one frame.

FIG. 20 is a diagram depicting a flow of a recognition process executed for the image data depicted in FIG. 19.

FIG. 21 is a diagram depicting a functional configuration example around a sensor control section 103, the recognition processing section 104, and an image processing section 106.

FIG. 22 is a diagram depicting a processing example performed within the recognition processing section 104.

FIG. 23 is a diagram for explaining functions of the recognition processing section 104.

FIG. 24 is a diagram depicting a frame readout process (first embodiment).

FIG. 25 is a diagram depicting an example in which a recognition process for an image frame is performed for each line unit.

FIG. 26 is a diagram depicting an example in which the recognition process is ended in response to acquisition of a valid recognition result in the middle of the frame readout for each line unit.

FIG. 27 is a diagram depicting an example in which the recognition process is ended in response to acquisition of a valid recognition result in the middle of the frame readout for each line unit.

FIG. 28 is a flowchart illustrating procedures for recognition and a determination basis calculation process corresponding to readout of pixel data for each readout unit from a frame.

FIG. 29 is a diagram illustrating a time chart example (in a case where a blank period blk is provided) of control of readout and also the recognition process and determination basis calculation.

FIG. 30 is a diagram illustrating a time chart example (in a case where blank periods blk are provided) of control of readout and also the recognition process and determination basis calculation.

FIG. 31 is a diagram illustrating a time chart example (in a case where a blank period blk is not provided) of control of readout and also the recognition process and determination basis calculation.

FIG. 32 is a diagram depicting a frame readout process (first modification).

FIG. 33 is a diagram depicting a frame readout process (second modification).

FIG. 34 is a diagram depicting a frame readout process (third modification).

FIG. 35 is a diagram depicting an example in which a recognition process for an image frame is performed for each area unit having a predetermined size.

FIG. 36 is a diagram depicting an example in which the recognition process is ended in response to acquisition of a valid recognition result in the middle of frame readout for each area unit.

FIG. 37 is a diagram depicting an example in which the recognition process is ended in response to acquisition of a valid recognition result in the middle of frame readout for each area unit.

FIG. 38 is a diagram depicting a frame readout process (fourth modification).

FIG. 39 is a diagram depicting an example in which a recognition process for an image frame is performed for each predetermined sample region unit.

FIG. 40 is a diagram illustrating a time chart example (fourth modification) of control of readout and also the recognition process and determination basis calculation.

FIG. 41 is a diagram depicting an example in which the recognition process is ended in response to acquisition of a valid recognition result in the middle of frame readout for each predetermined sample region unit.

FIG. 42 is a diagram depicting an example in which the recognition process is ended in response to acquisition of a valid recognition result in the middle of frame readout for each predetermined sample region unit.

FIG. 43 is a diagram depicting a frame readout process (fifth modification).

FIG. 44 is a diagram depicting a frame readout process (sixth modification).

FIG. 45 is a diagram depicting an example of a pattern for performing frame readout and the recognition process (another example of sixth modification).

FIG. 46 is a diagram depicting a frame readout process (first example of seventh modification).

FIG. 47 is a diagram depicting a frame readout process (second example of seventh modification).

FIG. 48 is a diagram depicting a frame readout process (third example of seventh modification).

FIG. 49 is a diagram depicting a frame readout process (fourth example of seventh modification).

FIG. 50 is a diagram for explaining functions of the recognition processing section 104.

FIG. 51 is a flowchart illustrating procedures for recognition and a determination basis calculation process corresponding to readout of pixel data performed on the basis of a feature value.

FIG. 52 is a diagram for explaining a first processing procedure of an eighth modification.

FIG. 53 is a diagram for explaining a second processing procedure of the eighth modification.

FIG. 54 is a diagram depicting a processing example performed by the recognition processing section 104 according to the eighth modification.

FIG. 55 is a diagram for explaining functions of the recognition processing section 104.

FIG. 56 depicts a functional configuration example of a readout determination section 2114 according to a second embodiment.

FIG. 57 is a diagram depicting an example of readout unit patterns.

FIG. 58 is a diagram depicting an example of readout order patterns.

FIG. 59 is a diagram depicting an example of readout order patterns.

FIG. 60 is a diagram depicting an example of readout order patterns.

FIG. 61 is a diagram for explaining a method for setting a readout region on the basis of recognition information.

FIG. 62 is a diagram for explaining a method for setting a readout region on the basis of recognition information.

FIG. 63 is a diagram for explaining a method for setting a readout region on the basis of recognition information.

FIG. 64 is a diagram for explaining a method for setting a readout region on the basis of recognition information.

FIG. 65 is a diagram for explaining a method for setting a readout region on the basis of recognition information.

FIG. 66 is a diagram for explaining a method for setting a readout region on the basis of recognition information.

FIG. 67 is a diagram depicting fields to which the present disclosure is applicable.

FIG. 68 is a diagram depicting a schematic configuration example of a vehicle control system 6800.

FIG. 69 is a diagram depicting an example of an installation position of an imaging section 6830.

### DESCRIPTION OF EMBODIMENTS

The present disclosure will hereinafter be described in the following order with reference to the drawings.

A. Outline of machine learning
B. Configuration of imaging device

### C. Outline of DNN

D. Outline of present disclosure
E. Embodiment of present disclosure
F. Second embodiment
G. Application fields
H. Application example

### A. OUTLINE OF MACHINE LEARNING

For example, Grad-CAM (Gradient-weighted Class Activation Mapping), LIME (LOCAL Interpretable model-agnostic Explanations),” SHAP (SHapley Additive exPlanations) as a successor form of LIME, and the like are known in an image field as a technology for visualizing a determination basis of a recognition process performed by a machine learning system trained by deep learning.

Under the current circumstances, however, only a determination basis for a still image is presentable, and a determination basis for a moving image is difficult to present at high speed. For example, in a case where deep learning is applied to image recognition performed by an in-vehicle camera for automated driving, a basis for determination of the image recognition needs to be processed at high speed and presented to a driver. However, there is a limitation to speed-up of calculation of a determination basis for a moving image. Moreover, a processing load increases with improvement of image quality of cameras. In this situation, real-time presentation of a determination basis is more difficult to achieve.

It is assumed in the present disclosure that an image recognition function and a function of presenting a determination basis for image recognition are provided on a small-sized imaging device such as a digital camera. The present disclosure achieves speed-up of a recognition process and real-time presentation of a determination basis by performing an image recognition process and a determination basis calculation process for each of readout units which are partial regions of a pixel region included in an imaging section.

### B. CONFIGURATION OF IMAGING DEVICE

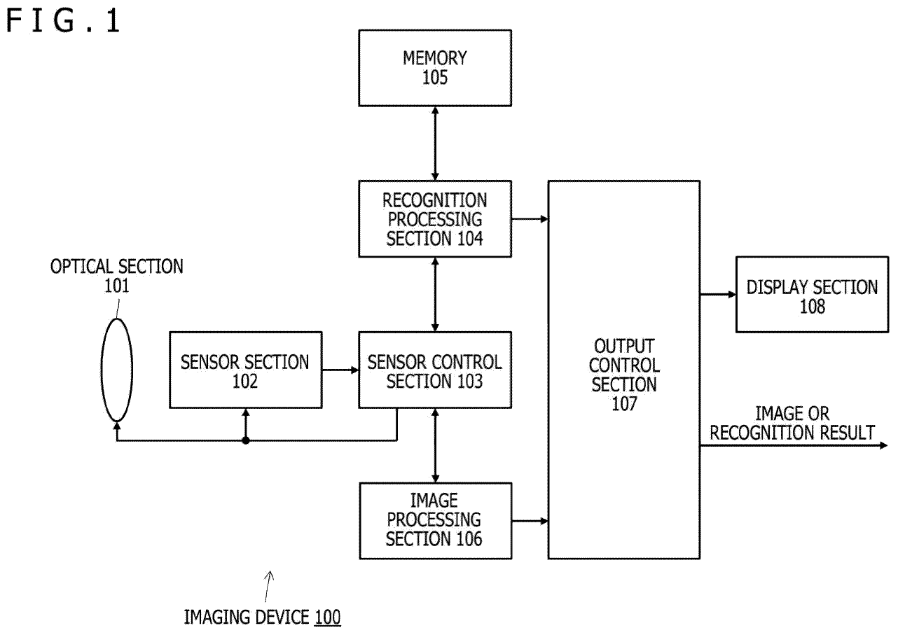

The present disclosure is applicable to various types of devices each using a machine learning model. FIG. 1 depicts a functional configuration example of an imaging device 100 to which the present disclosure is applicable. The imaging device 100 depicted in the figure includes an optical section 101, a sensor section 102, a sensor control section 103, a recognition processing section 104, a memory 105, an image processing section 106, an output control section 107, and a display section 108. For example, a CMOS (Complementary Metal Oxide Semiconductor) image sensor integrating the sensor section 102, the sensor control section 103, the recognition processing section 104, and the memory 105 may be formed using a CMOS. However, the imaging device 100 may be an infrared sensor which performs imaging with infrared light, or other types of optical sensors.

The optical section 101 includes a plurality of optical lenses, for example, for converging light from a subject on a light receiving surface of the sensor section 102, a diaphragm mechanism which adjusts an aperture size relative to incident light, and a focus mechanism which adjusts a focus of irradiation light applied to the light receiving surface. The optical section 101 may further include a shutter mechanism which adjusts a period of time of irradiation of light on the light receiving surface. The diaphragm mechanism, the focus mechanism, and the shutter mechanism included in the optical section are controlled by the sensor control section 103, for example. Note that the optical section 101 may be formed either integrally with the imaging device 100 or separately from the imaging device 100.

The sensor section 102 includes a pixel array where a plurality of pixels is arranged in matrix. Each of the pixels includes a photoelectric conversion element. The respective pixels arranged in matrix constitute the light receiving surface. The optical section 101 forms an image of incident light on the light receiving surface. Each of the pixels of the sensor section 102 outputs a pixel signal corresponding to irradiation light. The sensor section 102 further includes a driving circuit for driving the respective pixels within the pixel array, and a signal processing circuit which performs predetermined signal processing for signals read from the respective pixels and outputs the processed signals as pixel signals of the respective pixels. The sensor section 102 outputs pixel signals of respective pixels within a pixel region as image data in a digital format.

The sensor control section 103 includes a microprocessor, for example, and outputs image data corresponding to respective pixel signals read from respective pixels while controlling readout of pixel data from the sensor section 102. The pixel data output from the sensor control section 103 is given to the recognition processing section 104 and the image processing section 106.

The sensor control section 103 also generates an imaging control signal for controlling imaging performed by the sensor section 102, and supplies the imaging control signal to the sensor section 102. The imaging control signal contains information indicating exposure and analog gain during imaging achieved by the sensor section 102. The imaging control signal further contains a control signal associated with an imaging operation achieved by the sensor section 102, such as a vertical synchronized signal and a horizontal synchronized signal.

The recognition processing section 104 performs a recognition process (e.g., person detection, face identification, and image classification) corresponding to pixel data for recognizing an object within an image, on the basis of pixel data received from the sensor control section 103. However, the recognition processing section 104 may perform the recognition process by using image data obtained after image processing performed by the image processing section 106. A recognition result obtained by the recognition processing section 104 is given to the output control section 107.

According to the present embodiment, the recognition processing section 104 includes a DSP (Digital Signal Processor), for example, and performs the recognition process by using a machine learning model. A model parameter obtained by model training carried out beforehand is stored in the memory 105. The recognition processing section 104 performs the recognition process by using a trained model for which the model parameter read from the memory 105 has been set. Moreover, in a case where fairness of a recognition result is difficult to guarantee for minor attribute pixel data or image data on the basis of the model parameter used by the recognition processing section 104, additional model training may be carried out by using an Adversarial Example generated from known (or original) minor attribute data.

The image processing section 106 executes processing for pixel data given from the sensor control section 103 to obtain an image suited for visual recognition by humans, and outputs image data including a set of pixel data or the like. For example, a color filter is provided for each of the pixels within the sensor section 102. In a case where each piece of pixel data has color information associated with any one of R (red), G (green), or B (blue), the image processing section 106 executes demosaic processing, white balance processing, or the like. The image processing section 106 is also capable of issuing an instruction to the sensor control section 103 to read pixel data necessary for image processing from the sensor section 102. The image processing section 106 gives image data containing the processed pixel data to the output control section 107. For example, the foregoing functions of the image processing section 106 are achieved under a program stored in a local memory (not depicted) beforehand and executed by an ISP (Image Signal Processor).

For example, the output control section 107 includes a microprocessor. The output control section 107 receives a result of recognition of an object contained in an image from the recognition processing section 104, and also receives image data as an image processing result from the image processing section 106, and then outputs one or both of these to an outside of the imaging device 100. The output control section 107 also outputs image data to the display section 108. A user is allowed to visually recognize a display image on the display section 108. The display section 108 may be either built in the imaging device 100 or externally connected to the imaging device 100.

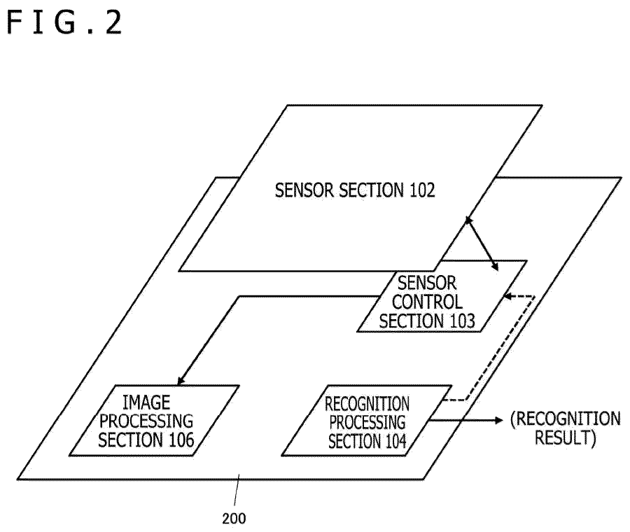

FIG. 2 depicts an implementation example of hardware of the imaging device 100. According to the example depicted in FIG. 2, the sensor section 102, the sensor control section 103, the recognition processing section 104, the memory 105, the image processing section 106, and the output control section 107 are mounted on one chip 200. However, the memory 105 and the output control section 107 are not depicted in FIG. 2 to avoid a complicated illustration in the figure.

According to the configuration example depicted in FIG. 2, a recognition result obtained by the recognition processing section 104 is output to an outside of the chip 200 via the output control section 107. In addition, the recognition processing section 104 is capable of acquiring pixel data or image data used for recognition from the sensor control section 103 via an interface provided inside the chip 200.

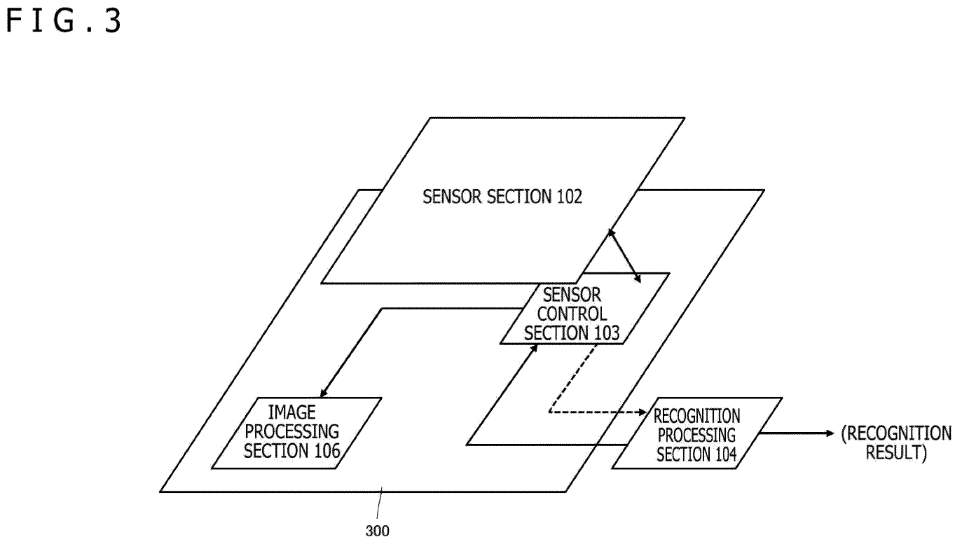

FIG. 3 depicts another implementation example of hardware of the imaging device 100. According to the example depicted in FIG. 3, the sensor section 102, the sensor control section 103, the image processing section 106, and the output control section 107 are mounted on one chip 300. However, the recognition processing section 104 and the memory 105 are disposed outside the chip 300. Note that the memory 105 and the output control section 107 are not depicted in FIG. 3, as with the above example, to avoid a complicated illustration in the figure.

According to the configuration example depicted in FIG. 3, the recognition processing section 104 acquires pixel data or image data used for recognition from the output control section 107 via a communication interface between the chips. Moreover, the recognition processing section 104 directly outputs a recognition result to the outside. Needless to say, the recognition result obtained by the recognition processing section 104 may be returned to the output control section 107 within the chip 300 via the communication interface between the chips and then output to the outside of the chip 300 from the output control section 107.

In the configuration example depicted in FIG. 2, both the recognition processing section 104 and the sensor control section 103 are mounted on the identical chip 200. Accordingly, high-speed communication between the recognition processing section 104 and the sensor control section 103 is achievable via the interface within the chip 200. Meanwhile, in the configuration example depicted in FIG. 3, the recognition processing section 104 is disposed outside the chip 300. Accordingly, replacement of the recognition processing section 104 is facilitated. However, communication between the recognition processing section 104 and the sensor control section 103 needs to be achieved via the interface between the chips. In this case, communication speed decreases.

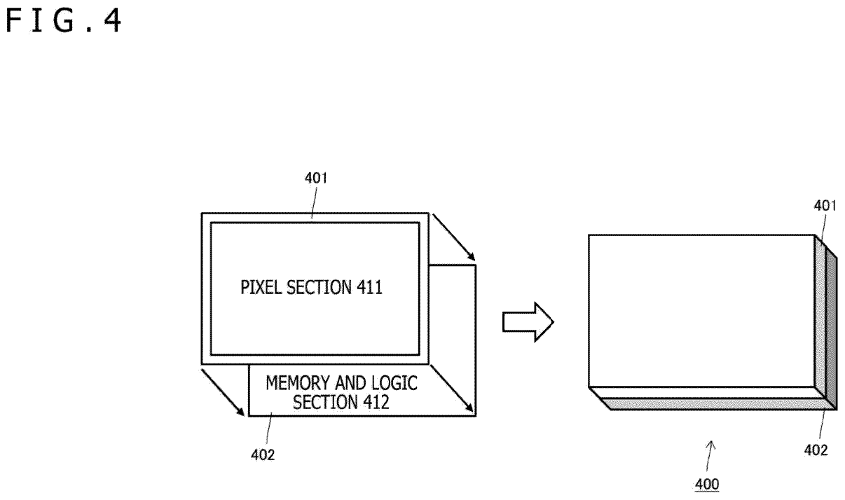

FIG. 4 depicts an example of a stacked-type image sensor 400 having a double-layer structure produced by stacking two layers of the semiconductor chips 200 (or 300) of the imaging device 100. In the structure depicted in the figure, a pixel section 411 is formed on a first layer semiconductor chip 401, and a memory and logic section 412 is formed on a second layer semiconductor chip 402.

The pixel section 411 includes at least the pixel array of the sensor section 102. Moreover, for example, the memory and logic section 412 includes the sensor control section 103, the recognition processing section 104, the memory 105, the image processing section 106, the output control section 107, and an interface for communication between the imaging device 100 and the outside. The memory and logic section 412 further includes a part or all of the driving circuit for driving the pixel array of the sensor section 102. Moreover, while not depicted in FIG. 4, the memory and logic section 412 may further include a memory used by the image processing section 106 for image data processing, for example.

As depicted in a right part of FIG. 4, the first layer semiconductor chip 401 and the second layer semiconductor chip 402 are affixed to each other with electric contact therebetween to constitute the imaging device 100 as one solid-state imaging element.

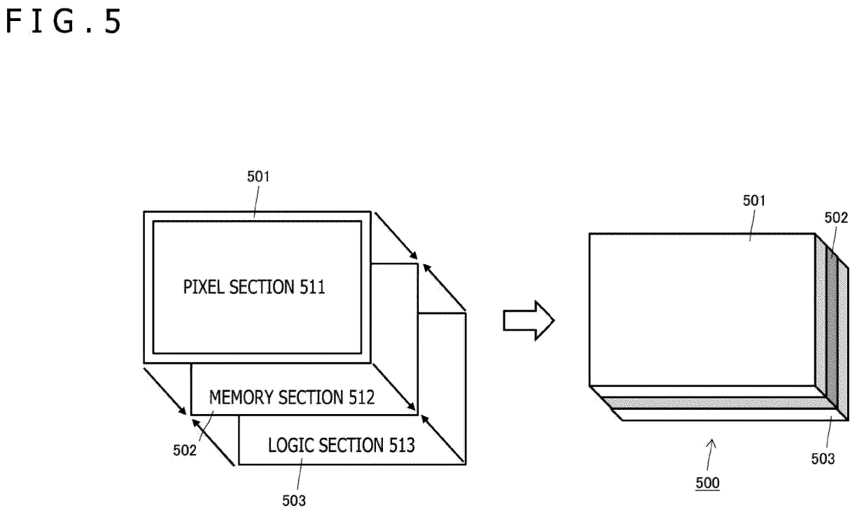

FIG. 5 depicts an example of a stacked-type image sensor 500 having a triple-layer structure produced by stacking three layers of the semiconductor chips 200 (or 300) of the imaging device 100. In the structure depicted in the figure, a pixel section 511 is formed on a first layer semiconductor chip 501, a memory section 512 is formed on a second layer semiconductor chip 502, and a logic section 513 is formed on a third layer semiconductor chip 503.

The pixel section 511 includes at least the pixel array of the sensor section 102. Moreover, for example, the logic section 513 includes the sensor control section 103, the recognition processing section 104, the image processing section 106, the output control section 107, and an interface for communication between the imaging device 100 and the outside. The logic section 513 further includes a part or all of the driving circuit for driving the pixel array of the sensor section 102. Further, the memory section 512 may further include a memory used by the image processing section 106 for image data processing, for example, in addition to the memory 105.

As depicted in a right part of FIG. 5, the first layer semiconductor chip 501, the second layer semiconductor chip 502, and the third layer semiconductor chip 503 are affixed to each other with electric contact therebetween to constitute the imaging device 100 as one solid-state imaging element.

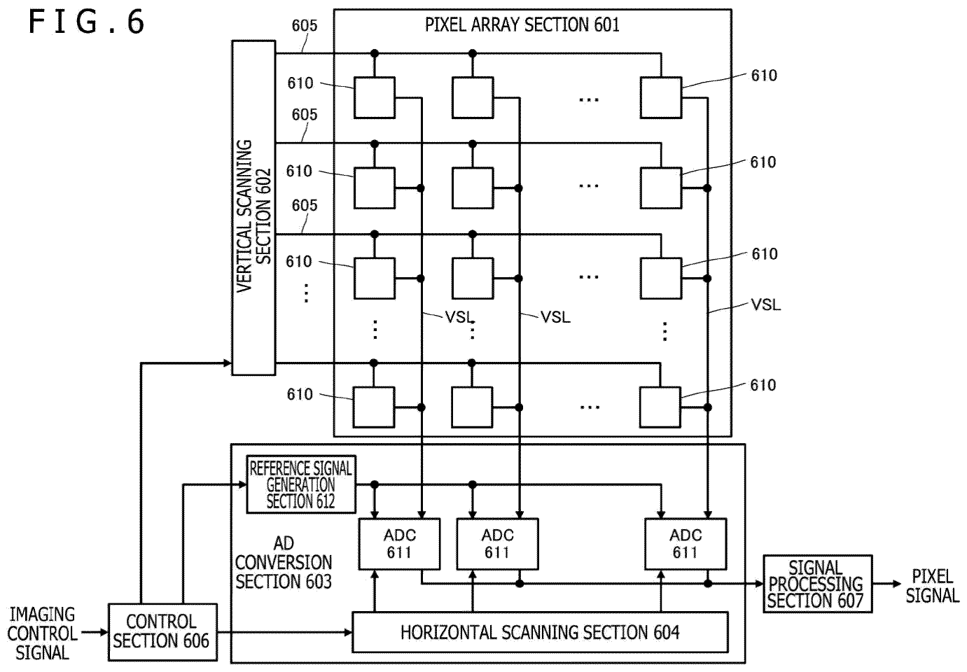

FIG. 6 depicts a configuration example of the sensor section 102. The sensor section 102 depicted in the figure includes a pixel array section 601, a vertical scanning section 602, an AD (Analog to Digital) conversion section 603, a horizontal scanning section 604, pixel signal lines 605, vertical signal lines VSL, a control section 606, and a signal processing section 607. Note that the control section 606 and the signal processing section 607 in FIG. 6 may be included in the sensor control section 103 in FIG. 1, for example.

The pixel array section 601 includes multiple pixel circuits 610 each of which includes a photoelectric conversion element that achieves photoelectric conversion of received light and a circuit that reads charge from the photoelectric conversion element. The multiple pixel circuits 610 are arranged in a matrix array in a horizontal direction (row direction) and a vertical direction (column direction). The pixel circuits 610 arranged in the row direction constitute a line. For example, in a case where an image of one frame includes 1920 pixels×1080 lines, the pixel array section 601 forms the image of one frame according to pixel signals read from 1080 lines each including the 1920 pixel circuits 610.

In the pixel array section 601, one pixel signal line 605 is connected to each row of the pixel circuits 610, and one vertical signal line VSL is connected to each column of the pixel circuits 610. An end of each of the pixel signals 605 on the side not connected to the pixel array section 601 is connected to the vertical scanning section 602. The vertical scanning section 602 transfers a control signal, such as a driving pulse generated during readout of a pixel signal from a pixel, to the pixel array section 601 via the pixel signal line 605 under control by the control section 606. An end of each of the vertical signal lines VSL on the side not connected to the pixel array section 601 is connected to the AD conversion section 603. A pixel signal read from a pixel is transferred to the AD conversion section 603 via the vertical scanning line VSL.

Readout of a pixel signal from each of the pixel circuits 610 is achieved by transferring charge accumulated on the photoelectric conversion element through exposure to a floating diffusion layer (Floating Diffusion: FD), and converting the transferred charge into voltage in the floating diffusion layer. The voltage obtained by conversion from the charge in the floating diffusion layer is output to the vertical signal line VSL via an amplifier (not depicted in FIG. 6).

The AD conversion section 603 includes AD converters 611 provided for the vertical signal lines VSL one for each, a reference signal generation section 612, and the horizontal scanning section 604. Each of the AD converters 611 is a column AD converter which performs AD conversion processing for each column of the pixel array section 601, and is configured to perform an AD conversion process for a pixel signal supplied from the pixel circuit 610 via the vertical signal line VSL to generate two digital values to be applied to correlative double sampling (CDS) processing for noise reduction, and output the generated digital values to the signal processing section 607.

The reference signal generation section 612 generates, as a reference signal, a ramp signal to be used by each of the column AD converters 611 to convert a pixel signal into two digital values on the basis of a control signal received from the control section 606, and supplies the generated ramp signal to the respective column AD converters 611. The ramp signal is a signal which has a voltage level decreasing with time in a manner of a fixed slope, or a signal which has a voltage level decreasing in a stepped manner.

With supply of the ramp signal, a counter starts counting according to a clock signal in each of the AD converters 611, and stops counting at a timing when voltage of the ramp signal crosses voltage of a pixel signal supplied from the vertical signal line VSL, on the basis of comparison between the voltage of the pixel signal and the voltage of the ramp signal. Thereafter, a value corresponding to a count value at that time is output to convert the pixel signal, which is an analog signal, into a digital value.

The signal processing section 607 performs CDS processing on the basis of the two digital values generated by each of the AD converters 611 to generate a pixel signal (pixel data) in a form of a digital signal, and outputs the generated pixel signal to an outside of the sensor control section 103.

The horizontal scanning section 604 performs a selection operation for selecting the respective AD converters 611 in a predetermined order under control by the control section 606, to sequentially output the digital value temporarily retained by each of the AD converters 611 to the signal processing section 607. For example, the horizontal scanning section 604 includes a shift register, an address decoder, or the like.

The control section 606 generates driving signals for controlling driving of the vertical scanning section 602, the AD conversion section 603, the reference signal generation section 612, the horizontal scanning section 604, and others, on the basis of an imaging control signal supplied from the sensor control section 103, and outputs the generated driving signals to the respective sections. For example, the control section 606 generates a control signal for supply from the vertical scanning section 602 to the respective pixel circuits 610 via the pixel signal lines 605, on the basis of a vertical synchronized signal and a horizontal synchronized signal contained in the imaging control signal, and supplies the generated control signal to the vertical scanning section 602. Moreover, the control section 606 gives information indicating analog gain and contained in the imaging control signal to the AD conversion section 603. In the AD conversion section 603, gain of a pixel signal input to each of the AD converters 611 via the vertical signal lines VSL is controlled on the basis of this information indicating the analog gain.

The vertical scanning section 602 supplies various signals including a driving pulse applied to the pixel signal line 605 in the pixel row selected in the pixel array section 601, to the respective pixel circuits 610 for each line on the basis of a control signal supplied from the control section 606, and causes each of the pixel circuits 610 to output a pixel signal to the vertical signal line VSL. For example, the vertical scanning section 602 includes a shift register, an address decoder, or the like. Moreover, the vertical scanning section 602 controls exposure of the respective pixel circuits 610 on the basis of information indicating exposure and supplied from the control section 606.

The sensor section 102 configured as depicted in FIG. 6 is a column-AD-type image sensor where the respective AD converters 611 are arranged for each column.

For example, a rolling shutter system and a global shutter system are available as an imaging system adopted for imaging by the pixel array section 601. The global shutter system simultaneously exposes all pixels of the pixel array section 601 to collectively read pixel signals. On the other hand, the rolling shutter system sequentially exposes pixels for each line from the upper side to the lower side of the pixel array section 601 to read pixel signals.

### C. OUTLINE OF DNN

Described in Paragraph C herein will be an outline of a recognition process using a DNN (Deep Neural Network) applicable to the present disclosure. It is assumed in the present disclosure that a recognition process for image data (hereinafter simply referred to as an “image recognition process”) is performed using a CNN (Convolutional Neural Network) and an RNN (Recurrent Neural Network) included in the DNN.

### C-1. Outline of CNN

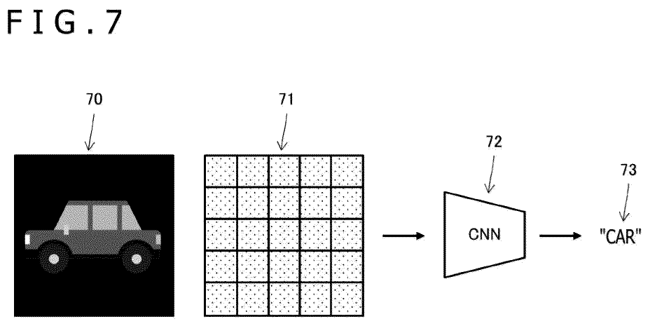

An outline of a CNN will be initially described. The image recognition process using a CNN is generally performed on the basis of image information associated with an image including pixels arrayed in matrix, for example. FIG. 7 schematically depicts a mechanism of the image recognition process using a CNN. A process using a CNN 72 trained in a predetermined manner is applied to pixel information 71 associated with a whole of an image 70 containing an illustration of a car corresponding to a recognition target object. As a result, a “car” class is recognized as a recognition result 73.

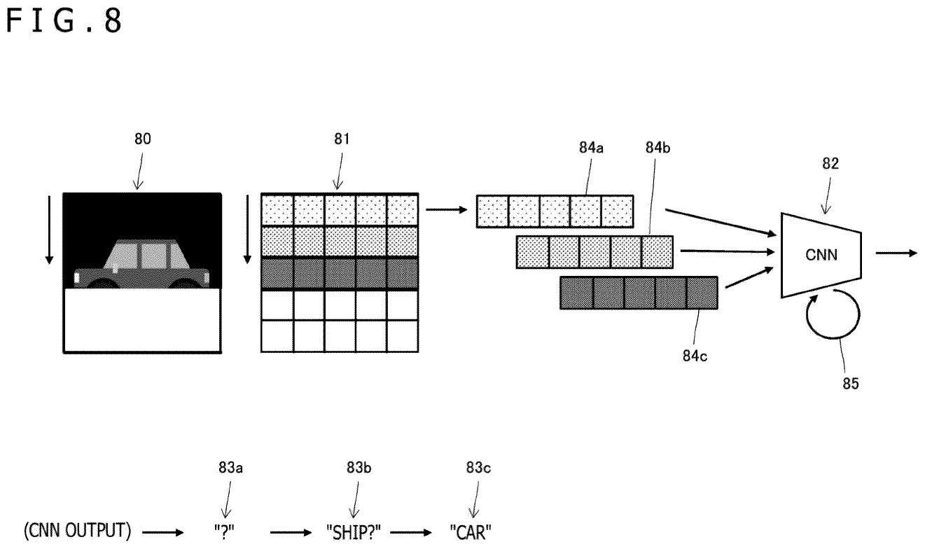

Alternatively, a process using a CNN may be performed on the basis of images acquired one for each line to obtain a recognition result from a part of an image corresponding to a recognition target. FIG. 8 schematically depicts a mechanism of an image recognition process which obtains a recognition result from a part of an image corresponding to a recognition target. An image 80 in FIG. 8 contains a “car” that corresponds to an object of a recognition target and is partially acquired for each line. A process using a CNN 82 trained in a predetermined manner is sequentially applied to respective items of pixel information 84a, 84b, and 84c that are acquired one for each line and constitute pixel information 81 associated with the image 80, for example. Note that the “line” herein refers to one line including a set of a predetermined number of pixel lines in some cases, rather than one pixel line.

For example, suppose that a recognition result 83a obtained by the recognition process performed using the CNN 82 for the pixel information 84a on the first line is not a valid recognition result. The valid recognition result herein refers to a recognition result indicating that a score representing reliability of the recognition result is a predetermined level or higher, for example. The CNN 82 achieves an update 85 of an internal state on the basis of the recognition result 83a. Subsequently, the recognition process is performed for the pixel information 84b on the second line by using the CNN 82 having achieved the update 85 of the internal state on the basis of the previous recognition result 83a. According to the example depicted in FIG. 8, a recognition result 83b indicating that the object of the recognition target is either a “car” or a “ship” is obtained by the recognition process. The update 85 of the internal information associated with the CNN 82 is further achieved on the basis of the recognition result 53b. Thereafter, the recognition process is performed for the pixel information 84c on the third line by using the CNN 82 having achieved the update 85 of the internal state on the basis of the previous recognition result 83b. As a result, the “car” is selected from the “car” and the “ship,” and designated as the object of the recognition target.

According to the recognition process depicted in FIG. 8, the internal state of the CNN 82 is updated on the basis of the result of the previous recognition process, and the CNN 82 whose internal state has been updated is applied to achieve the recognition process on the basis of pixel information associated with the line adjacent to the line for which the previous recognition process has been performed. In other words, the recognition process depicted in FIG. 8 is executed while updating the internal state of the CNN for each line of the image on the basis of the previous recognition result. Accordingly, the recognition process depicted in FIG. 8 is a process recursively executed for each line, and thus is considered to have a structure corresponding to an RNN.

### C-2. Outline of CNN

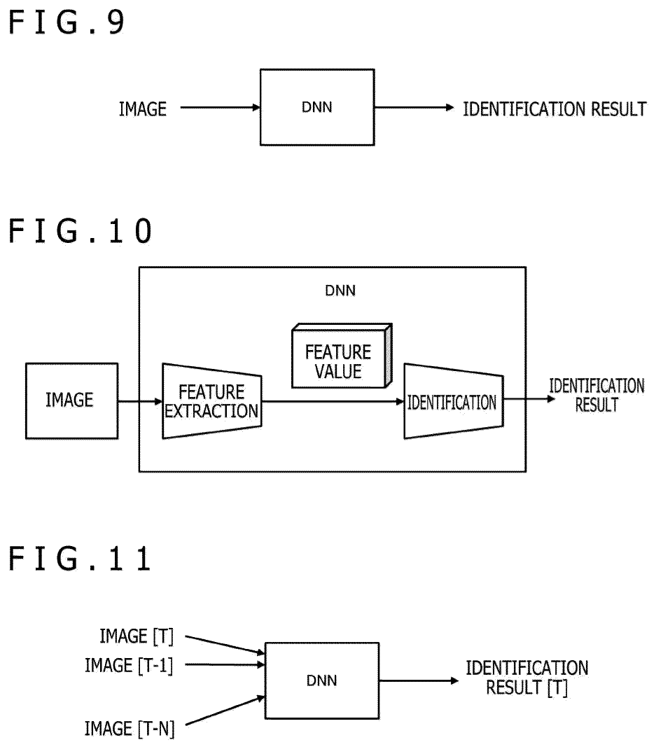

An outline of an RNN will be subsequently described. FIG. 9 schematically depicts an example of an identification process (recognition process) performed using a DNN in a case where time-series information is not used. In this case, in response to input of one image to the DNN, the DNN performs an identification process for the input image and outputs an identification result.

FIG. 10 depicts more details of the identification process depicted in FIG. 9. As depicted in FIG. 10, the DNN executes a feature extraction process and an identification process. Initially, the DNN extracts a feature value from the input image by the feature extraction process and then executes the identification process for the extracted feature value to obtain an identification result.

Meanwhile, FIG. 11 schematically depicts a first example of an identification process using a DNN in a case where time-series information is used. According to the example depicted in FIG. 11, an identification process is performed using a DNN on the basis of a fixed number of items of previous information in time series. Specifically, an image [T] at a time T, an image [T−1] at a time T−1 before the time T, an image [T−2] at a time T−2 before the time T−1, and up to an image [T−N] at a time T−N are input to the DNN. The DNN executes the identification process for the respective input images [T], [T−1], [T−2], and up to [T−N] and obtains an identification result [T] at the time T.

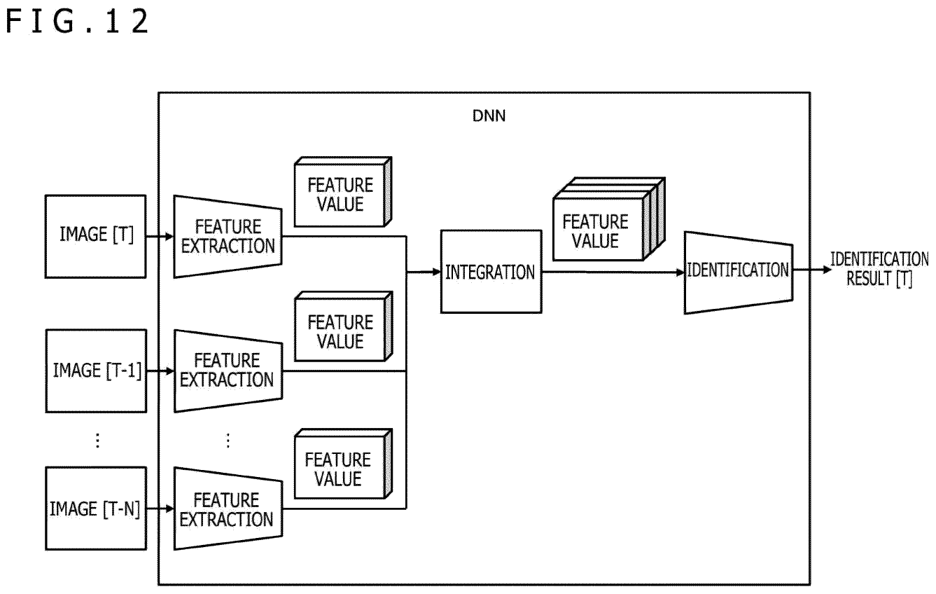

FIG. 12 depicts more details of the process depicted in FIG. 11. As depicted in FIG. 12, the DNN executes the feature extraction process depicted in FIG. 10 for each of the input images [T], [T−1], [T−2], and up to [T−N] with one-to-one correspondence to extract feature values corresponding to the respective images [T], [T−1], [T−2], and up to [T−N]. The DNN integrates the respective feature values obtained on the basis of the images [T], [T−1], [T−2], and up to [T−N]. Thereafter, the DNN executes the identification process for the integrated feature value to obtain the identification result [T] at the time T. According to the method depicted in FIGS. 11 and 12, a plurality of configurations for extracting feature values is required. Moreover, a number of configurations corresponding to the number of available previous images are required to extract feature values from these images. In this case, a structure scale of the DNN may increase.

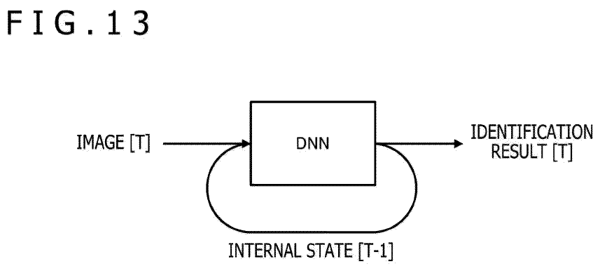

FIG. 13 schematically depicts a second example of the identification process performed by a DNN in a case where time-series information is applied. According to the example depicted in FIG. 13, an image [T] at a time T is input to the DNN whose internal state has been updated to a state at a time T−1, and an identification result [T] at the time T is obtained.

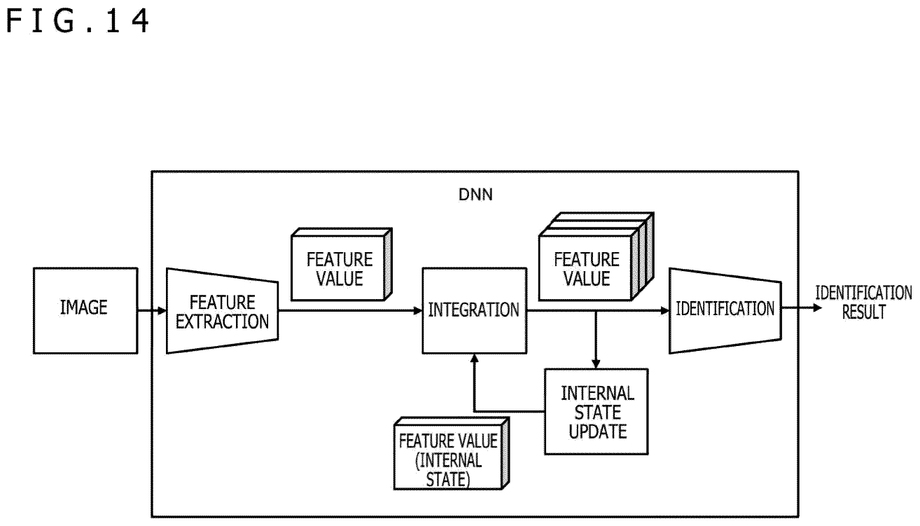

FIG. 14 depicts more details of the process depicted in FIG. 13. As depicted in FIG. 14, the DNN executes the feature extraction process described above with reference to FIG. 10 for the input image [T] at the time T to extract a feature value corresponding to the image [T]. The internal state of the DNN is updated on the basis of an image before the time T, and a feature value associated with the updated internal state is stored in the DNN. The feature value that is associated with the internal information and is stored as above and the feature value of the image [T] are integrated, and the identification process is executed for the integrated feature value. The identification process depicted in FIGS. 13 and 14 is a recursive process executed using a DNN whose internal state has been updated on the basis of an identification result immediately before, for example. The DNN performing a recursive process as described above corresponds to an RNN. Generally, the identification process using an RNN is employed for recognition of moving images or the like. For example, identification accuracy can be raised by sequentially updating the internal state of a DNN on the basis of frame images updated in time series.

For example, an RNN is applied to the imaging device 100 adopting the rolling shutter system. The rolling shutter system reads pixel signals in a line sequential order. Accordingly, pixel signals read for each line are applied to an RNN as information in time series. In this manner, the identification process based on a plurality of lines is executable by using a smaller-scale configuration than in the case using a CNN (see FIG. 12). Needless to say, an RNN is also applicable to the imaging device 100 adopting the global shutter system. In this case, adjoining lines are considered as information in time series, for example.

### C-3. Specific Configuration of CNN

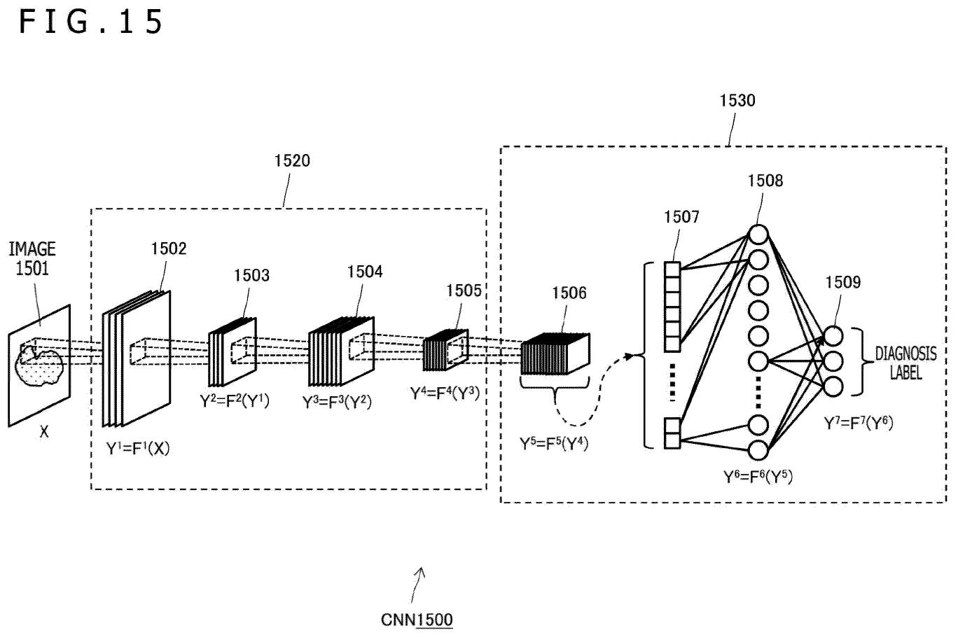

FIG. 15 depicts a configuration example of a DNN using a multilayer convolutional neural network (CNN). Generally, a CNN includes a feature value extraction section for extracting a feature value of an input image, and an image classification section for inferring an output label (identification result) corresponding to the input image on the basis of the extracted feature value. The feature value extraction section as the former section includes a “convolution layer” which performs convolution of an input image by using a method associated with a connection limit and weight sharing between neurons to extract edges and features, and a “pooling layer” which deletes information associated with positions not important for image classification to give robustness to features extracted by the convolution layer.

A reference number 1501 in FIG. 15 denotes an image as input data to the CNN. Reference numbers 1502, 1504, and 1506 each denote an output from the convolution layer. Reference numbers 1503 and 1505 each denote an output from the pooling layer. A reference number 1507 denotes a one-dimensional arrangement state of the output 1506 from the convolution layer, a reference number 1508 denotes a fully connected layer, and a reference number 1509 denotes an output layer as an inference result of classification.

A range surrounded by a rectangle denoted by a reference number 1520 in a CNN 1500 depicted in FIG. 15 corresponds to the feature value extraction section (e.g., corresponding to “feature extraction” in FIG. 10) and performs a process for acquiring an image feature value of an input image. In addition, a range surrounded by a rectangle denoted by a reference number 1530 corresponds to the image classification section (e.g., corresponding to “identification” in FIG. 10) and specifies an output label on the basis of the image feature value.

In addition, it is assumed that an output value from an l-th layer in stages of an inference process (in an order of processes in respective layers) is expressed as Y^{l}, and that a process performed in the l-th layer is expressed as Y^{l}=F^{l}(Y^{l-1}). It is further assumed that a first layer is Y^{l}=F^{l}(X) and that a final layer is Y=F⁷(Y⁶).

### C-4. Outline of Determination Basis of DNN

For example, a basis for determination (e.g., identification or recognition of an image) in the DNN can be calculated by using an algorithm such as Grad-CAM (Gradient-weighted Class Activation Mapping) (e.g., see NPL 3), LIME (LOCAL Interpretable model-agnostic Explanations) (e.g., see NPL 4), SHAP (SHapley Additive exPlanations) as a successor form of LIME, and TCAV (Testing with Concept Activation Vectors) (e.g., see NPL 5).

### Grad-CAM:

Grad-CAM is an algorithm which estimates a place contributing to classification in input image data by using a method reversely tracing a gradient from a label corresponding to an identification result of classification in an output layer (calculating contributions of respective feature maps until classification and achieving back propagation with weights of the contributions), and allows visualization of the place contributing to classification in a manner of a heat map. Alternatively, a portion having a large effect in an original input image may be displayed in a form of a heat map by obtaining a degree of effect of position information associated with pixels of input image data on a final determination output while retaining the position information until a final convolution layer.

Described will be a method performed by the CNN 1500 depicted in FIG. 15 for calculating a determination basis by using a Grad-Cam algorithm (a method for creating a heat map) in a case where class c is output from the image classification section 1530 by image recognition performed for an input image.

Assuming that a gradient y_{c} of the class c is activation Aₖ in a feature map, a weight of importance of a neuron is given as expressed in the following equation (1).

$$\begin{matrix}[ Math . 1 ] & \\ {α}_{k}^{c} = \frac{1}{Z} {\sum }_{i} {\sum }_{j} \frac{\partial {y}^{c}}{\partial {A}_{ij}^{k}} & ( 1 )\end{matrix}$$

As expressed in the following equation (2), Grad-Cam is calculated via an activation function ReLU by multiplying a feedforward output from a final convolution layer by a weight for each channel.

[Math. 2]

L_{Grad-CAM}^{c}=ReLU(Σₖαₖ^{c}A^{k}) (2)

In a case where the Grad-Cam algorithm is applied to the DNN that performs the image recognition process for each line of an image input as depicted in FIGS. 8 to 14, a determination basis can be calculated for the image input for each line. For example, which portion in an image [T] at a time T corresponds to a basis of image classification can be displayed in a form of a heat map.

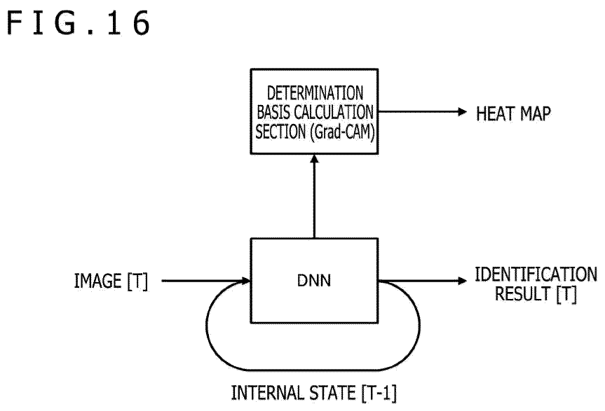

FIG. 16 schematically depicts a configuration example which calculates a determination basis of the DNN that performs an identification process for time-series information, on the basis of the Grad-CAM algorithm. According to the example depicted in FIG. 16, the image [T] at the time T is input to the DNN whose internal state has been updated to a state at a time T−1, and an identification result [T] at the time T is obtained. In addition, a determination basis calculation section calculates a basis portion of the identification result [T] at the time T within the image [T] on the basis of the Grad-Cam algorithm and outputs a heat map.

### LIME:

When an output result from a neural network is reversed or considerably changed in response to a change of a specific input data item (feature value), this item is estimated as an “item having high importance in determination” in LIME. For example, for presenting a reason (basis) for inference of the DNN, a different model (basis model) having a local similarity is generated. When an identification result is subsequently output from the DNN, basis information is created using the basis model. In this manner, a basis image can be formed.

### TCAV:

TCAV is an algorithm which calculates importance of Concept for prediction of a trained model (a concept easily recognizable for humans). For example, a plurality of items of input information created by duplicating input information or adding modifications is input to a model corresponding to a target for which basis information is to be created (explanation target model). A plurality of items of output information corresponding to the respective items of input information is output from the explanation target model. Thereafter, a basis model is trained using combinations (pairs) of the plurality of items of input information and the plurality of items of corresponding output information as learning data to create a basis model having a local similarity for target input information by using a different interpretable model. When an identification result is subsequently output from the DNN, basis information associated with the identification result is created using the basis model. In this manner, a basis image is similarly formed.

### D. OUTLINE OF PRESENT DISCLOSURE

Generally, a conventional image recognition function requires image processing for image data of one to several frames. In this case, a determination basis for image recognition can be presented only once for every one to several frames of image data. Accordingly, real-time presentation is difficult to achieve. In a case where an image recognition technology is applied to automated driving or the like, there is a limitation to speed-up of presentation of a determination basis to a driver.

Meanwhile, the present disclosure proposes an imaging device which performs a high-speed image recognition process for a captured image and achieves real-time presentation of a determination basis for image recognition. The imaging device according to the present disclosure includes an imaging section that has a pixel region where a plurality of pixels is arrayed, a readout control section that controls readout of pixel signals from the pixels included in the pixel region, a readout unit control section that controls readout units each of which is a part of the pixel region and is set as a readout unit to be read by the reading control section, a recognition section that has learned learning data for each of the readout units, and a determination basis calculation section that calculates a determination basis of a recognition process performed by the recognition section. The recognition section performs the recognition process for the pixel signals for each of the readout units, while the determination basis calculation section calculates a determination basis for a result of the recognition process performed for each of the readout units.

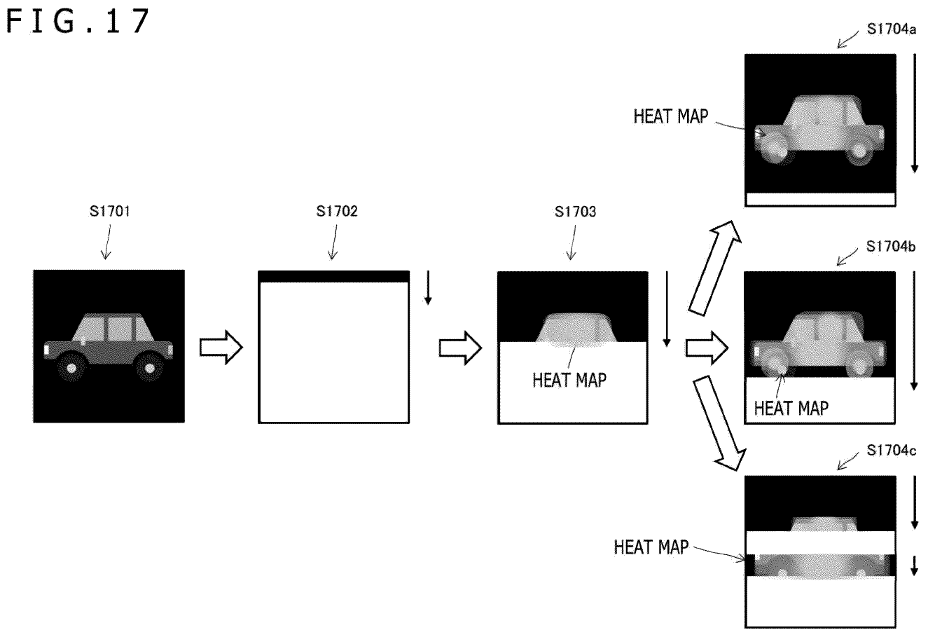

The image recognition process and the determination basis calculation process performed for each of the readout units according to the present disclosure will be described with reference to FIG. 17. Note that an image of a car is designated as a target image herein. Moreover, the memory 105 stores beforehand a program or a model parameter of a machine learning model so trained as to identify each of (achieve classification of) multiple types of objects, such as a car, on the basis of predetermined learning data. In addition, it is assumed that the recognition processing section 104 is capable of performing an identification process for an object contained in a captured image, by reading the program or the model parameter from the memory 105 and executing the read program or model parameter. The imaging device 100 adopts the rolling shutter system for imaging, but is capable of similarly achieving the image recognition process and the determination basis calculation process performed for each of the readout units even in a case where the global shutter system is adopted for imaging. It is further assumed that the recognition processing section 104 has a function of calculating a determination basis for a recognition result as well as an image recognition processing function.

Initially, the imaging device 100 starts capturing of a target image corresponding to a recognition target (step S1701).

At the start of imaging, the imaging device 1 sequentially reads a frame from an upper end to a lower end of the frame for each line (step S1702).

When readout of lines is completed up to a certain position, the recognition processing section 104 identifies a subject as an object “car” or an object “ship” on the basis of an image formed by the read lines (step S1703). For example, each of the object “car” and the object “ship” contains a common feature portion in an upper half part. Accordingly, the recognized object can be identified as either the “car” or the “ship” at a time when this feature portion is recognized on the basis of the lines sequentially read from the upper side. At this time, the determination basis calculation section (e.g., see FIG. 16) calculates a basis on which the DNN has identified the object as either the “car” or the “ship,” and displays a portion corresponding to this basis on a heat map.

Note herein that the whole of the object as the recognition target appears by completion of readout up to a lower end line or a line near the lower end in the frame as illustrated in step S1704a. Thereafter, the object identified as either the “car” or the “ship” in step S1702 is confirmed as the “car.” At this time, the determination basis calculation section calculates a basis on which the DNN has identified the object as the “car,” and displays a portion corresponding to this basis on the heat map.

Moreover, after continuation of subsequent line readout from the line position read in step S1703, the recognized object can be identified as the “car” even before readout from the lower end of the “car,” as illustrated in step S1704b. For example, a lower half of the “car” and a lower half of the “ship” have features different from each other. By continuing readout up to a line where this feature difference becomes apparent, the object recognized in step S1703 can be identified as either the “car” or the “ship.” According to the example illustrated in FIG. 17, the object is confirmed as the “car” in step S1704b. At this time, the determination basis calculation section calculates the fact that the basis on which the DNN has identified the object as the “car” corresponds to the lower half of the “car,” and displays the lower half part of the “car” on the heat map.

Moreover, as illustrated in step S1704c, it is also possible to skip from the line position in step S1703 to such a line position where the object identified in step S1703 is likely to be recognized as the “car” or the “ship,” and continue reading from this position. By reading the destination line of the skip, the object identified in step S1703 can be confirmed as either the “car” or the “ship.”

Specifically, when a candidate of an identification result meeting a predetermined condition is obtained by continuation of readout and the recognition process for each line, a skip to such a line position where the recognition result meeting the predetermined condition is acquirable is made to continue line readout from this position. Alternatively, when an identification result presenting a candidate of a determination basis meeting a predetermined condition is obtained by continuation of readout and the recognition process for each line, a skip to such a line position where the determination basis meeting the predetermined condition is presentable is made to continue line readout from this position.

Note that the line position corresponding to the destination of the skip may be determined by using a machine learning model trained beforehand on the basis of predetermined learning data. Needless to say, a line position located a fixed number of lines (or the number of lines determined beforehand) ahead of the current line position may be determined as the line position corresponding to the destination of the skip. At this time, the determination basis calculation section calculates a basis on which the DNN has identified the object as the “car,” according to the line position corresponding to the destination of the skip, and displays a portion corresponding to this basis on the heat map.

In the case where the confirmation of the object is completed in step S1704b or step S1704c, the recognition processing section 104 further calculates a determination basis on the basis of a Grad-CAM algorithm or the like. Thereafter, the imaging device 100 is allowed to end the recognition process. In this manner, speed-up and power saving are achievable by reduction of a processing volume of the recognition process performed by the imaging device 100. Moreover, real-time presentation of a determination basis is realizable.

Note that the learning data is data retaining a plurality of combinations of an input signal and an output signal of each readout unit. For example, for a task of the object identification described above, a data set combining an input signal for each readout unit (e.g., line data, sub-sampled data) with an object class (human body, vehicle, or non-object) or object coordinates (x, y, h, w) may be applied to learning data. Moreover, an output signal may be generated only from an input signal by using self-supervised learning.

The recognition processing section 104 included in the imaging device 100 reads and executes a program or a model parameter stored in the memory 105 as a machine learning model trained beforehand on the basis of the learning data as described above to function as a recognizer using a DNN, and further present a determination basis of the recognizer.

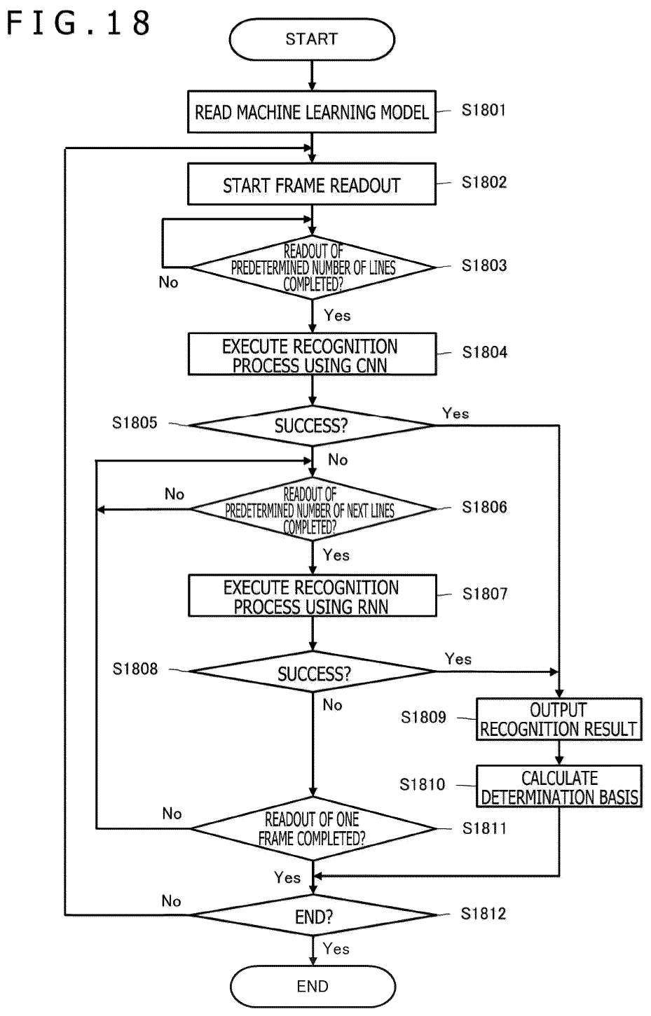

FIG. 18 illustrates processing procedures, in a form of a flowchart, for executing respective processes of image recognition and determination basis calculation performed by the recognition processing section 104.

Initially, a DSP constituting the recognition processing section 104 reads a program or a model parameter of a machine learning model from the memory 105 and executes the program or the model parameter (step S1801). In this manner, this DSP is allowed to function as a recognizer using a trained machine learning model and also calculate a determination basis for image recognition.

Subsequently, the recognition processing section 104 instructs the sensor control section 103 to start frame readout from the sensor section 102 (step S1802). For example, this frame readout sequentially reads image data of one frame for each predetermined readout unit (e.g., line unit).

The recognition processing section 104 checks whether or not readout of image data of a predetermined number of lines in one frame has been completed (step S1803). Thereafter, when it is determined that readout of the image data of the predetermined number of lines in one frame has been completed (Yes in step S1803), the recognition processing section 104 executes a recognition process for the read image data of the predetermined number of lines by using a trained CNN (step S1804). Specifically, the recognition processing section 104 executes a recognition process using a machine learning model while designating the image data of the predetermined number of lines as a unit region.

For example, the recognition process for image data by using a CNN executes a recognition or detection process such as face detection, face authentication, visual line detection, facial expression recognition, face direction detection, object detection, object recognition, movement (mobile object) detection, pet detection, scene recognition, state detection, and avoidance target recognition. Face detection is a process for detecting a face of a person contained in image data. Face authentication, which is a type of biometric authentication, is a process for authenticating whether or not a face of a person contained in image data coincides with a face of a person registered beforehand. Visual line detection is a process for detecting a visual line direction of a person contained in image data. Facial expression recognition is a process for recognizing a facial expression of a person contained in image data. Face direction detection is a process for detecting an up-down direction of a face of a person contained in image data. Object detection is a process for detecting an object contained in image data. Object recognition is a process for recognizing what an object contained in image data is. Movement (mobile object) detection is a process for detecting a mobile object contained in image data. Pet detection is a process for detecting a pet such as a dog and a cat contained in image data. Scene recognition is a process for recognizing a scene (e.g., sea and mountain) currently captured. State detection is a process for detecting a state of a subject such as a person (e.g., whether the current state is a normal state or an abnormal state) contained in image data. Avoidance target recognition is a process for recognizing an avoidance target object present ahead in a self-traveling direction in a case of self-movement. The recognition process executed by the recognition processing section 104 is not limited to the examples listed above.

Thereafter, the recognition processing section 104 determines whether or not the recognition process using the CNN in step S1804 has succeeded (step S1805). The success in the recognition process herein refers to a state where a certain recognition result has been obtained, such as a case where reliability has reached a predetermined level or higher, in the examples of the image recognition process presented above. On the other hand, a failure in the recognition process refers to a state where a sufficient result of detection or recognition or sufficient authentication has not been obtained, such as a case where reliability does not reach a predetermined level, in the examples of the image recognition process presented above.

In a case of determination that the recognition process using the CNN has succeeded (Yes in step S1805), the recognition processing section 104 shifts the process to step S1809. On the other hand, in a case of determination that the recognition process using the CNN has failed (No in step S1805), the recognition processing section 104 shifts the process to step S1806.

In step S1806, the recognition processing section 104 waits until completion of readout of image data of a predetermined number of subsequent lines by the sensor control section 103 (No in step S1806). Thereafter, when the image data (unit region) of the predetermined number of subsequent lines is read (Yes in step S1806), the recognition processing section 104 executes a recognition process using an RNN for the read image data of the predetermined number of lines (step S1807). The recognition process using an RNN also uses a result of a machine learning process using a CNN or an RNN previously executed for image data of an identical frame, for example (e.g., see FIGS. 13 and 14).

Thereafter, the recognition processing section 104 determines whether or not the recognition process using the RNN in step S1807 has succeeded (step S1808). The success in the recognition process herein refers to a state where a certain recognition result has been obtained, such as a case where reliability has reached a predetermined level or higher, in the examples of the image recognition process presented above. On the other hand, a failure in the recognition process refers to a state where a sufficient result of detection or recognition or sufficient authentication has not been obtained, such as a case where reliability does not reach a predetermined level, in the examples of the image recognition process presented above.

In a case of determination that the recognition process using the RNN has succeeded (Yes in step S1808), the recognition processing section 104 shifts the process to step S1809.

In step S1809, the recognition processing section 104 supplies a valid recognition result indicating a success in step S1804 or step S1807 to the output control section 107, for example.

Subsequently, the determination basis calculation section (see FIG. 16) included in the recognition processing section 104 calculates a determination basis (step S1810) and supplies the calculated determination basis to the output control section 107, for example. In a case where the determination basis calculation section uses a Grad-CAM algorithm, for example, a place contributing to classification in an original input image can be specified and visualized in a manner of a heat map by reversely tracing a gradient from a label corresponding to an identification result of classification in an output layer of the CNN or RNN having succeeded in recognition (calculating contributions of respective feature maps until classification and achieving back propagation with weights of the contributions).

The output control section 107 outputs the recognition result output from the recognition processing section 104 in step S1809 and the determination basis calculated in step S1810 to the display section 108 to display the recognition result and the determination basis on a screen. For example, an original input image and an image recognition result are displayed on the screen of the display section 108, and further a heat map indicating the result of the basis calculation is superimposed and displayed on the original input image. Alternatively, the output control section 107 may store the recognition result output from the recognition processing section 104 in step S1809 and the determination basis calculated in step S1810 in the memory 105 in association with the original input image.

Further, in a case of determination that the recognition process using the RNN has failed (No in step S1808), the recognition processing section 104 shifts the process to step S1811. In step S1811, the recognition processing section 104 checks whether or not readout of image data of one frame has been completed.

In a case of determination that readout of image data of one frame has not been completed (No in step S1811), the process is returned to step S1806, and processing similar to the above processing is repeatedly executed for image data of a predetermined number of subsequent lines.

On the other hand, in a case of determination that readout of image data of one frame has been completed (Yes in step S1811), the recognition processing section 104 determines whether or not to end a series of processes illustrated in FIG. 18, for example (step S1812).

The determination of whether or not to end the series of processes in step S1812 herein may be made on the basis of whether or not an ending instruction has been input from the outside of the imaging device 100, or on the basis of whether or not a series of processes for image data of a predetermined number of frames determined beforehand has been completed, for example.

Alternatively, a condition for ending the series of processes may be set to such a state where a determination basis (at a satisfactory level for the user) has successfully been presented in conjunction with a state where a desired object has been recognized from a frame at the time of recognition of the desired object from the frame (or at the time of recognition that the desired object is not recognizable from the frame).

In a case of determination that the process illustrated in FIG. 18 is not yet to be ended (No in step S1812), the recognition processing section 104 returns the process to step S1802, and then reads a subsequent frame and repeatedly executes processing similar to the above processing for this frame. On the other hand, in a case of determination that the process illustrated in FIG. 18 is to be ended (Yes in step S1812), the recognition processing section 104 ends the whole of the present process.

Note that a subsequent recognition process may be skipped in a case of a failure in a recognition process immediately before the current process in a situation where recognition processes such as face detection, face authentication, visual line detection, facial expression recognition, face direction detection, object detection, object recognition, movement (mobile object) detection, scene recognition, and state detection are continuously carried out. For example, in a situation where face authentication is to be executed subsequently to face detection, the subsequent face authentication may be skipped in a case of a failure in the face detection.

Subsequently described will be a specific operation performed by the recognition processing section 104 in a case of an example where face detection is executed using a DNN.

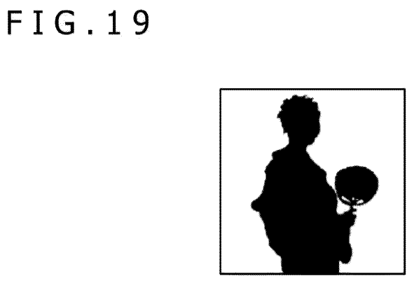

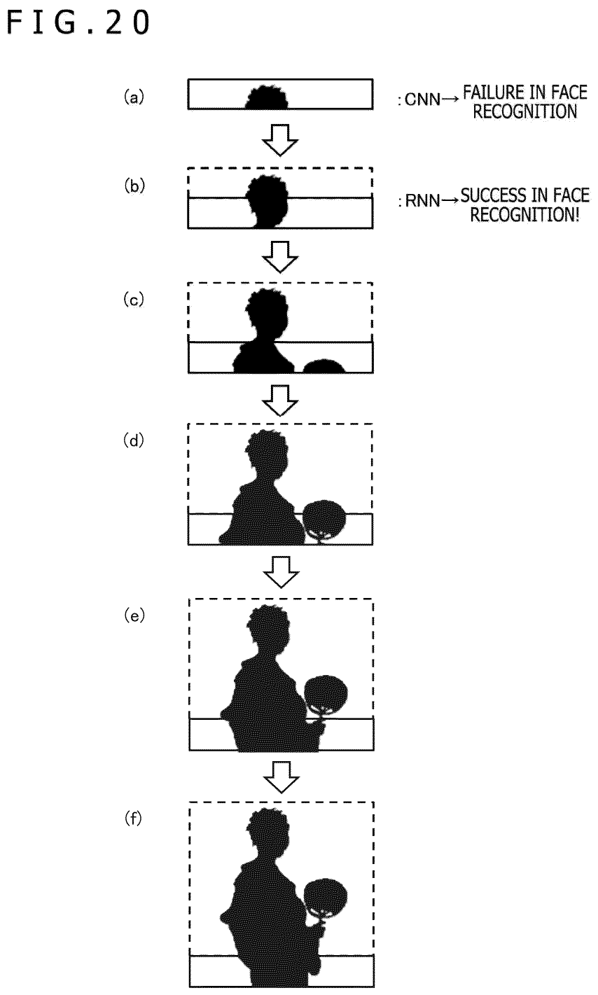

FIG. 19 depicts an example of image data of one frame. FIG. 20 depicts a flow of a recognition process executed by the recognition processing section 104 included in the imaging device 100 for the image data depicted in FIG. 19.

In a case of execution of face detection by machine learning for the image data depicted in FIG. 19, image data of a predetermined number of lines is initially input to the recognition processing section 104 as illustrated in (a) of FIG. 20 (corresponding to step S1803 in FIG. 18). The recognition processing section 104 executes a machine learning process using a CNN for the input image data of the predetermined number of lines to achieve face detection (corresponding to step S1804 in FIG. 18). However, image data of the entire face is not yet input in the stage in (a) of FIG. 20. Accordingly, the recognition processing section 104 fails in face detection (corresponding to No in step S1805 in FIG. 18).

Subsequently, image data of a predetermined number of subsequent lines is input to the recognition processing section 104 as illustrated in (b) of FIG. 20 (corresponding to step S1806 in FIG. 18). The recognition processing section 104 executes a face recognition process using an RNN for the input new image data of the predetermined number of lines while using a result of the face recognition process using the CNN for the image data of the predetermined number of lines input in (a) of FIG. 20 (corresponding to step S1807 in FIG. 18).

In the stage in (b) of FIG. 20, image data of the entire face has been input together with the pixel data of the predetermined number of lines input in the stage in (a) of FIG. 20. Accordingly, the recognition processing section 104 succeeds in face detection in the stage in (b) of FIG. 20 (corresponding to Yes in step S1808 in FIG. 18). As a result, a result of face recognition is output without readout of following image data (image data in (c) to (f) of FIG. 20) in the present operation (corresponding to S1809 in FIG. 18).

In this manner, readout of image data and execution of the recognition process after the time of the success in face recognition are allowed to be omitted by executing the machine learning process using a DNN for image data for each set of the predetermined number of lines. Accordingly, the detection and the recognition process can be completed in a short period of time, and therefore, reduction of a processing period of time and reduction of power consumption are achievable.

Moreover, for example, in a case of calculation of a determination basis with use of a Grad-CAM algorithm, a place contributing to classification in pixel data of the partial lines input in the stage in (b) of FIG. 20 can be specified and visualized in a manner of a heat map by reversely tracing a gradient from a label corresponding to an identification result of classification in an output layer of a neural network model having succeeded in recognition (calculating contributions of respective feature maps until classification and achieving back propagation with weights of the contributions). In other words, real-time presentation of a determination basis is achievable together with speed-up of the recognition process.

Note that the predetermined number of lines is determined according to a size of a filter required by the algorithm of the learning model. A minimum number of the predetermined number of lines is one line.

Moreover, the image data read by the sensor control section 103 from the sensor section 102 may be image data thinned out at least in either the column direction or the row direction. In this case, image data of a 2(N−1)th line (N: 1 or larger integer) is read in a case where image data is read from every other line in the column direction, for example.

Further, in a case where the filter required by the algorithm of the learning model is not a filter for a line unit but a rectangular region of a pixel unit, such as 1×1 pixel and 5×5 pixels, for example, image data of a rectangular region corresponding to the shape or size of the filter, rather than image data of the predetermined number of lines, may be input to the recognition processing section 104 as image data of a unit region for which the recognition processing section 104 executes the machine learning process.

In addition, while a DNN including a CNN and an RNN has been presented above as an example of the machine learning model that performs the recognition process, the machine learning model is not limited to this example. Machine learning models having other structures are also available. Besides, while the Grad-Cam algorithm has chiefly been presented in the example of calculation of a determination basis of the DNN, calculation of the determination basis is not limited to this example.

Calculation of a determination basis of the machine learning model may be achieved by using other algorithms.

### E. EMBODIMENTS OF PRESENT DISCLOSURE

### E-1. Embodiment (1)

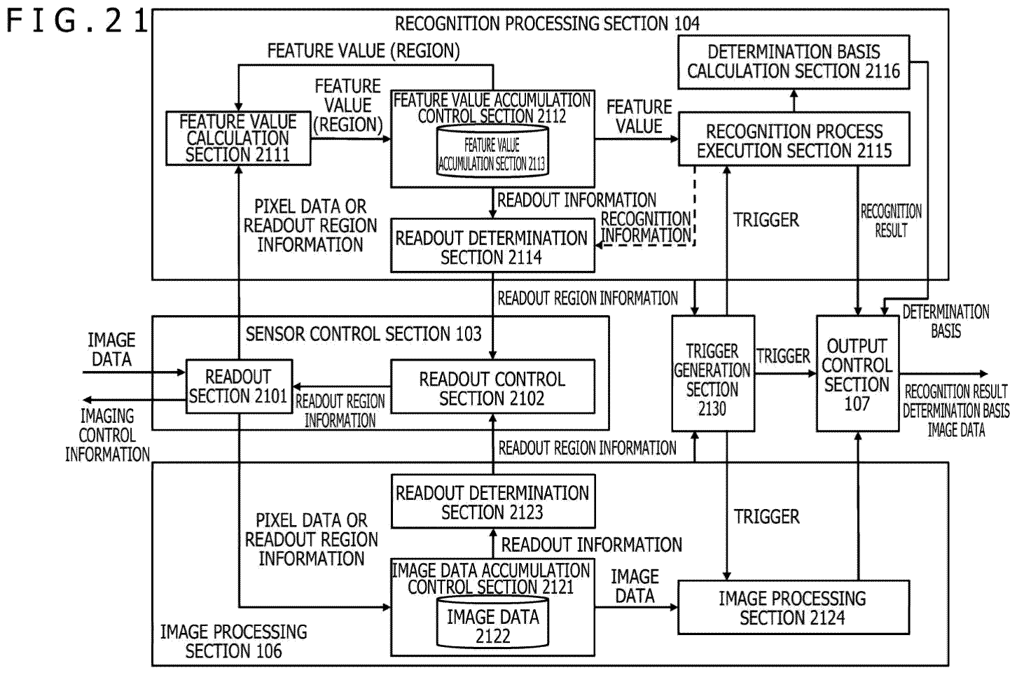

FIG. 21 depicts a detailed functional configuration example chiefly around the sensor control section 103, the recognition processing section 104, and the image processing section 106 of the imaging device 100 depicted in FIG. 1.

The sensor control section 103 includes a readout section 2101 and a readout control section 2102. The recognition processing section 104 includes a feature value calculation section 2111, a feature value accumulation control section 2112, a readout determination section 2114, a recognition process execution section 2115, and a determination basis calculation section 2116. The feature value accumulation control section 2112 includes a feature value accumulation section 2113. Meanwhile, the image processing section 106 includes an image data accumulation control section 2121, a readout determination section 2123, and an image processing section 2124. The image data accumulation control section 2121 includes an image data accumulation section 2122.

The readout control section 2102 included in the sensor control section 103 receives readout region information indicating a readout region to be read by the recognition processing section 104, from the readout determination section 2114 included in the recognition processing section 104. For example, the readout region information indicates a line number or line numbers of one or a plurality of lines. Alternatively, the readout region information may be information designating various patterns of the readout region, such as information indicating pixel positions in one line, and a combination of information indicating one or more line numbers and information indicating a pixel position or pixel positions of one or more pixels in a line. Note that the readout region is equivalent to the readout unit. However, the readout region may be different from the readout unit.

Similarly, the readout control section 2102 receives readout region information indicating a readout region to be read by the image processing section 106, from the readout determination section 2123 included in the image processing section 106.

The readout control section 2102 gives the readout section 2101 the readout region information that is given from the readout determination sections 2114 and 2123 described above and indicates a readout region of an input image to be actually read. For example, in a case where the readout region information received from the readout determination section 2114 and the readout region information received from the readout determination section 2123 conflict with each other, the readout control section 2102 arbitrates between these in such a manner as to cover both of the readout regions or define a common region of both of the readout regions, for example, to adjust the readout region information given to the readout section 2101.

The readout control section 2102 is further allowed to receive imaging control information (e.g., exposure and analog gain) from the readout determination section 2114 or the readout determination section 2123. The readout control section 2102 gives the received imaging control information to the readout section 2101.

The readout section 2101 reads pixel data from the sensor section 102 according to the readout region information given from the readout control section 2102. For example, the readout section 2101 obtains a line number indicating a line to be read and pixel position information indicating a position of a pixel to be read in the corresponding line, on the basis of the readout region information, and gives the obtained line number and pixel position information to the sensor section 102. The readout section 2101 gives respective pixel data acquired from the sensor section 102 to the recognition processing section 104 and the image processing section 106 together with the readout region information.

Moreover, the readout section 2101 performs imaging control, such as exposure and analog gain (AG), for the sensor section 102 on the basis of the imaging control information received from the readout control section 2102. The readout section 2101 is further capable of generating a vertical synchronized signal and a horizontal synchronized signal and supplying the generated signals to the sensor section 102.

The readout determination section 2114 included in the recognition processing section 104 receives readout information indicating a readout region to be read next, from the feature value accumulation control section 2112. The readout determination section 2114 generates readout region information on the basis of the received readout information and gives this generated information to the readout control section 2102.

The readout determination section 2114 is herein allowed to use, for a readout region indicated by the readout region information, information including a predetermined readout unit and readout position information added for readout of pixel data of this readout unit, for example. The readout unit is a set of one or more pixels and corresponds to a processing unit handled by the recognition processing section 104 and the image processing section 106. For example, if the readout unit is a line, a line number [L#x] indicating a position of this line is added as the readout position information. Alternatively, if the readout unit is a rectangular region containing a plurality of pixels, information indicating a position of this rectangular region in the pixel array section 601, such as information indicating a position of a pixel at an upper left corner, is added as the readout position information. The readout determination section 2114 designates beforehand the readout unit to be applied. Alternatively, the readout determination section 2114 can also determine the readout unit according to an instruction issued from the outside of the readout determination section 2114, for example. Accordingly, the readout determination section 2114 functions as a readout unit control section which controls the readout unit.

Note that the readout determination section 2114 may determine the readout region to be read next, on the basis of recognition information given from the recognition process execution section 2115 described below, and generate readout region information indicating the determined readout region.

Similarly, the readout determination section 2123 included in the image processing section 106 receives readout information indicating a readout region to be read next, from the image data accumulation control section 2121, for example. The readout determination section 2123 generates readout region information on the basis of the received readout information and gives the generated readout region information to the readout control section 2102.

On the basis of the pixel data and the readout region information given from the readout section 2101, the feature value calculation section 2111 included in the recognition processing section 104 calculates a feature value of a region indicated by the readout region information. The feature value calculation section 2111 gives the calculated feature value to the feature value accumulation control section 2112.

The feature value calculation section 2111 herein may calculate the feature value on the basis of a previous feature value given from the feature value accumulation control section 2112 in addition to the pixel data given from the readout section 2101. Moreover, the feature value calculation section 2111 may acquire information for setting exposure and analog gain from the readout section 2101, for example, and calculate the feature value by using this acquired information as well.

The feature value accumulation control section 2112 included in the recognition processing section 104 accumulates the feature value given from the feature value calculation section 2111 in the feature value accumulation section 2113. Moreover, when the feature value is given from the feature value calculation section 2111, the feature value accumulation control section 2112 generates readout information indicating a readout region to be read next and gives the generated readout information to the readout determination section 2114.

The feature value accumulation control section 2112 herein is capable of integrating a feature value already accumulated and a newly given feature value and accumulating the integrated feature values. Moreover, the feature value accumulation control section 2112 is capable of deleting an unnecessary feature value from feature values accumulated in the feature value accumulation section 2113. For example, the unnecessary feature value is a feature value associated with a previous frame, or a feature value calculated and already accumulated on the basis of a frame image in a scene different from a scene of a frame image for which a new feature value is calculated. Further, the feature value accumulation control section 2112 is also capable of deleting and initializing all feature values accumulated in the feature value accumulation section 2113 as necessary.

In addition, the feature value accumulation control section 2112 generates a feature value to be used by the recognition process execution section 2115 for the recognition process, on the basis of the feature value given from the feature value calculation section 2111 and the feature value accumulated in the feature value accumulation section 2113. The feature value accumulation control section 2112 gives the generated feature value to the recognition process execution section 2115.

The recognition process execution section 2115 executes the recognition process on the basis of the feature value given from the feature value accumulation control section 2112. The recognition process execution section 2115 achieves object detection, face detection, or the like by executing the recognition process. The recognition process execution section 2115 gives a recognition result obtained by the recognition process to the output control section 107. The recognition process execution section 2115 is also capable of giving recognition information containing the recognition result generated by the recognition process to the readout determination section 2114. Note that the recognition process execution section 2115 is capable of receiving a feature value from the feature value accumulation control section 2112 and executing the recognition process on the basis of a trigger generated by a trigger generation section 2130, for example.

The determination basis calculation section 2116 calculates a basis for image recognition, such as object detection and face detection, achieved by the recognition process execution section 2115. In a case where each of the feature value calculation section 2111 and the recognition process execution section 2115 includes a neural network model, the determination basis calculation section 2116 can estimate a place contributing to a recognition result in an original image by reversely tracing a gradient from a label corresponding to an identification result of classification in an output layer with use of a Grad-Cam algorithm, for example (calculating contributions of respective feature maps until classification and achieving back propagation with weights of the contributions). Thereafter, the determination basis calculation section 2116 gives the calculated determination basis to the output control section 107.

The image data accumulation control section 2121 included in the image processing section 106 receives pixel data read from the readout region and readout region information associated with this image data from the readout section 2101. The image data accumulation control section 2121 accumulates the pixel data and the readout region information in the image data accumulation section 2122 in association with each other.

The image data accumulation control section 2121 generates image data to be used by the image processing section 2124 for image processing, on the basis of pixel data given from the readout section 2101 and image data accumulated in the image data accumulation section 2122. The image data accumulation control section 2121 gives the generated image data to the image processing section 2124. Alternatively, the image data accumulation control section 2121 may give the pixel data given from the readout section 2101 to the image processing section 2124 without change.

Moreover, the image data accumulation control section 2121 generates readout information indicating a readout region to be read next, on the basis of the readout region information given from the readout section 2101, and gives the generated readout information to the readout determination section 2123.

The image data accumulation control section 2121 herein is capable of integrating image data already accumulated and newly given pixel data by addition averaging, for example, and accumulating the integrated data. Moreover, the image data accumulation control section 2121 is capable of deleting unnecessary image data in image data accumulated in the image data accumulation section 2122. For example, unnecessary image data may include image data associated with a previous frame, and image data calculated and already accumulated on the basis of a frame image in a scene different from a scene of a frame image for which new image data is calculated. Further, the image data accumulation control section 2121 is also capable of deleting and initializing all image data accumulated in the image data accumulation section 2122 as necessary.

In addition, the image data accumulation control section 2121 is also capable of acquiring information for setting exposure and analog gain from the readout section 2101, and accumulating image data corrected by using these acquired items of information in the image data accumulation section 2122.

The image processing section 2124 performs predetermined image processing for the image data given from the image data accumulation control section 2121. For example, the image processing section 2124 is capable of performing a predetermined image quality improving process for this image data. Moreover, in a case where the given image data is image data from which data has been spatially reduced by line thinning or the like, the image processing section 2124 may fill the thinned-out portion with image information by an interpolation process. The image processing section 2124 gives the image-processed image data to the output control section 107.

Note that the image processing section 2124 is capable of receiving image data from the image data accumulation control section 2121 and executing image processing on the basis of a trigger generated by the trigger generation section 2130, for example.

The output control section 107 outputs one of or both the recognition result given from the recognition process execution section 2115 and the image data given from the image processing section 2124. Moreover, the output control section 107 may output a determination basis for recognition given from the determination basis calculation section 2116, together with the recognition result. The output control section 107 outputs one of or both the recognition result and the image data in response to a trigger generated by the trigger generation section 2130, for example.

The trigger generation section 2130 generates a trigger given to the recognition process execution section 2115, a trigger given to the image processing section 2124, and a trigger given to the output control section 107, on the basis of information that is associated with the recognition process and is given from the recognition processing section 104, and information that is associated with the image processing and is given from the image processing section 106. The trigger generation section 2130 gives the generated respective triggers to the recognition process execution section 2115, the image processing section 2124, and the output control section 107 at a predetermined timing for each.

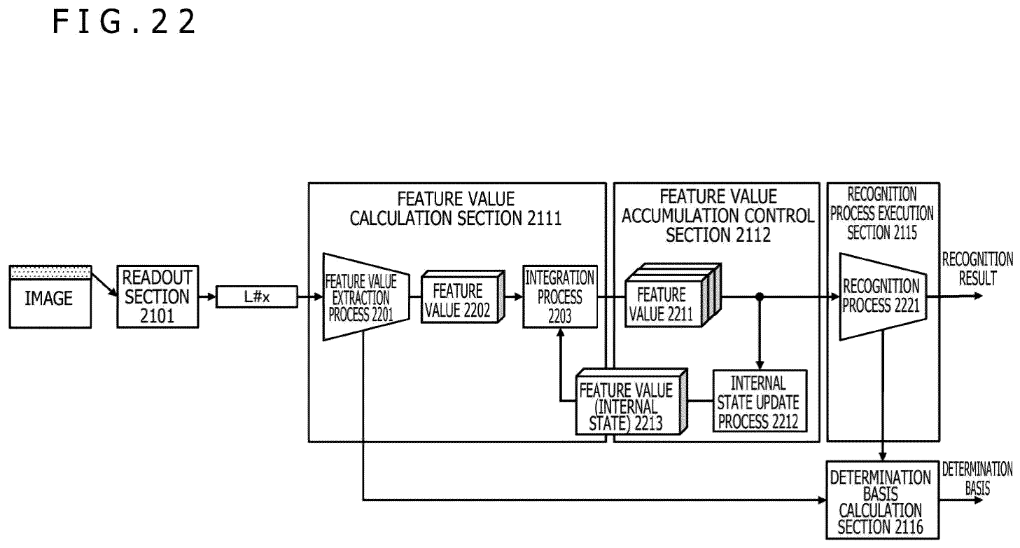

FIG. 22 depicts a processing example inside the recognition processing section 104 in more detail. Note that a line is designated as the readout region in the figure, and that the readout section 2101 is assumed to read pixel data for each line from an upper end toward a lower end of a frame of an input image (input from the sensor section 1021). Line image data (line data) of a line L#x read for each line by the readout section 2101 is input to the feature value calculation section 2111.

The feature value calculation section 2111 executes a feature value extraction process 2201 and an integration process 2203. The feature value calculation section 2111 performs the feature value extraction process 2201 for input line data to extract a feature value 2202 from the line data. The feature value extraction process 2201 herein extracts the feature value 2202 from the line data on the basis of a parameter obtained by learning beforehand. The integration process 2203 integrates the feature value 2202 extracted by the feature value extraction process 2201 with a feature value (internal state) 2213 processed by the feature value accumulation control section 2112. An integrated feature value 2211 is given to the feature value accumulation control section 2112.

The feature value accumulation control section 2112 executes an internal state update process 2212. The feature value 2211 given to the feature value accumulation control section 2112 is given to the recognition process execution section 2115 and processed by the internal state update process 2212. The internal state update process 2212 reduces the feature value 2211 on the basis of a parameter learned beforehand to update the internal state of a DNN, and generates a feature value (internal state) 2213 associated with the updated internal state. The integration process 2203 integrates the feature value (internal state) 2213 herein with the feature value 2202 of line data currently input. This process performed by the feature value accumulation control section 2112 corresponds to a process using an RNN.

The recognition process execution section 2115 executes a recognition process 2221 for the feature value 2211 given from the feature value accumulation control section 2112, on the basis of a parameter learned beforehand using predetermined learning data, for example, and outputs a recognition result.

As described above, the recognition processing section 104 according to the first embodiment executes processing on the basis of parameters learned beforehand in the feature value extraction process 2201, the integration process 2203, the internal state update process 2212, and the recognition process 2221. The parameters are learned using learning data corresponding to an assumed recognition target, for example.

Moreover, the determination basis calculation section 2116 calculates a basis for recognition achieved by the recognition process execution section 2115. In a case where each of the feature value calculation section 2111 and the recognition process execution section 2115 includes a neural network model, the determination basis calculation section 2116 can estimate a place contributing to a recognition result in an image within a range previously read, with focus on the feature value 2202 extracted from line data currently input in the feature value extraction process 2201 and the feature value 2211 integrated with the feature value (internal state) 2213 in the integration process 2203, by reversely tracing a gradient from a label corresponding to an identification result of classification in an output layer with use of a Grad-Cam algorithm, for example (calculating contributions of respective feature maps until classification and achieving back propagation with weights of the contributions). Thereafter, the determination basis calculation section 2116 gives the calculated determination basis to the output control section 107.

Note that the functions of the feature value calculation section 2111, the feature value accumulation control section 2112, the readout determination section 2114, the recognition process execution section 2115, and the determination basis calculation section 2116 described above are achieved by loading a program stored in the memory 105 or the like into the DSP included in the imaging device 100 and executing the loaded program, for example. Similarly, the functions of the image data accumulation control section 2121, the readout determination section 2123, and the image processing section 2124 described above are achieved by loading a program stored in the memory 105 or the like into the ISP included in the imaging device 100 and executing the loaded program, for example. These programs may be either stored in the memory 105 beforehand or supplied from the outside to the imaging device 100 and written to the memory 105.

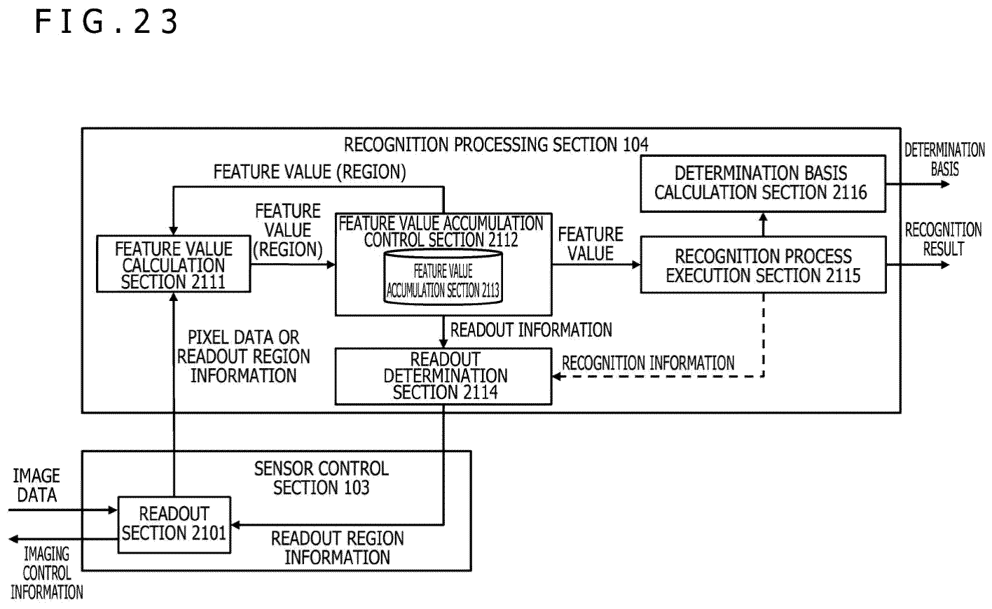

FIG. 23 depicts a functional portion chiefly associated with the recognition processing section 104 in the functional configuration depicted in FIG. 21. FIG. 23 does not depict the image processing section 106, the output control section 107, the trigger generation section 2130, and the readout control section 2101 of the sensor control section 103 in the functional configuration depicted in FIG. 21.

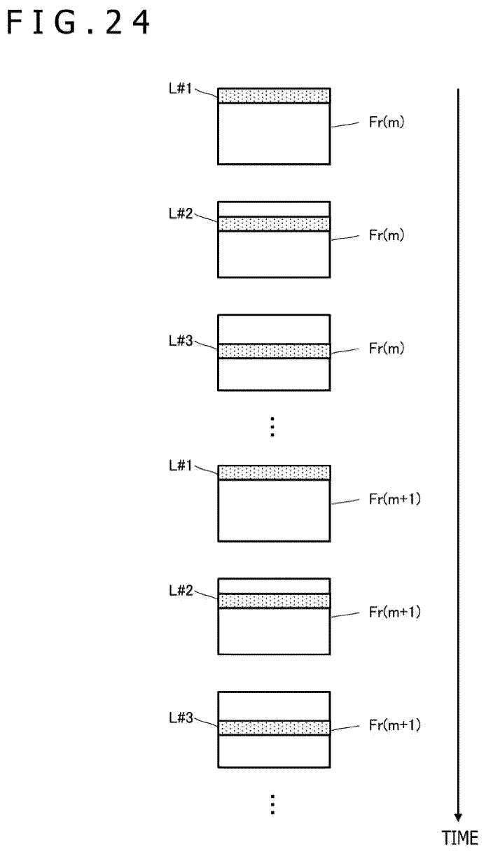

FIG. 24 graphically illustrates a frame readout process according to the present embodiment. In the present embodiment, a line is designated as a readout unit, and readout of pixel data for each line is performed for a frame Fr(x). According to the example depicted in FIG. 24, line readout is achieved in a line sequential order from au upper end line L#1 to lines L#2, L#3, and following lines in a frame Fr(m) which is an m-th frame. Thereafter, with completion of line readout from the frame Fr(m), subsequent line readout is similarly performed for each line from an upper end line L#1 in a subsequent (m+1)th frame Fr(m+1).

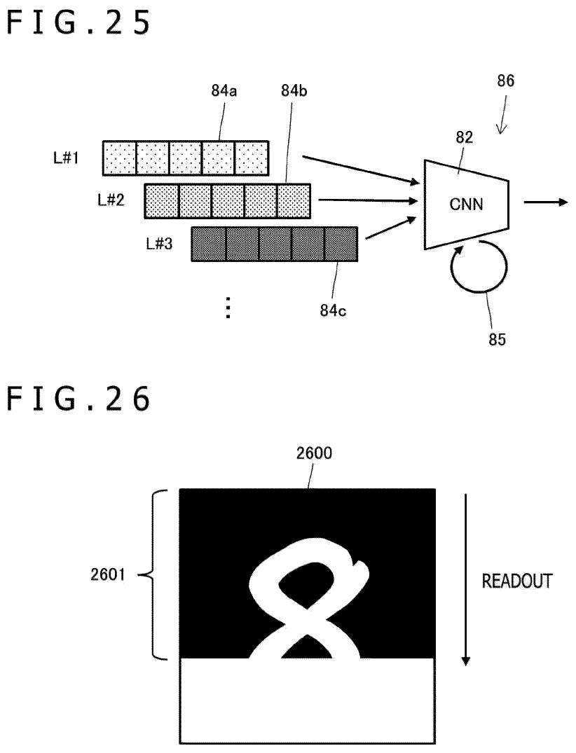

FIG. 25 schematically depicts the recognition process according to the present embodiment. As depicted in FIG. 25, the recognition process is achieved by sequentially executing processing with use of the CNN 82 and the update 85 of internal information for respective items of pixel information 84a, 84b, and 84c associated with the respective lines L#1, L#2, L#3, and others. Pixel information 84 associated with one line is only required to be input to the CNN 82. Accordingly, considerable reduction of the scale of a recognizer 86 is achievable.

Moreover, the determination basis calculation section 2116 estimates a place contributing to a recognition result in a current input line by reversely tracing a gradient from a label corresponding to an identification result of classification in an output layer of the CNN 82 with use of a Grad-Cam algorithm, for example (calculating contributions of respective feature maps until classification and achieving back propagation with weights of the contributions), and further estimates a place contributing to the recognition result in an image within a range previously read, on the basis of the updated internal information 85. The determination basis calculation section 2116 starts a calculation process for calculating a determination basis for the recognition result, before completion of the readout process for the entire frame. Accordingly, real-time presentation of the determination basis for recognition can be achieved by reduction of a time period required for obtaining a calculation result of the determination basis.

The recognizer 86 depicted in FIG. 25 executes processing for image data input for each line by using the CNN 82 to achieve the update 85 of the internal information, and therefore is considered to have a configuration as an RNN. When the recognition process for each line is performed using an RNN, a valid recognition result can be acquired without a necessity of reading all lines contained in a frame in some cases. In the case of the recognition process performed for each line, the recognition processing section 104 is allowed to end the recognition process at the time of acquisition of a valid recognition result. Moreover, the determination basis calculation section 2116 is allowed to calculate a determination basis at the time when the recognition processing section 104 acquires a valid recognition result.

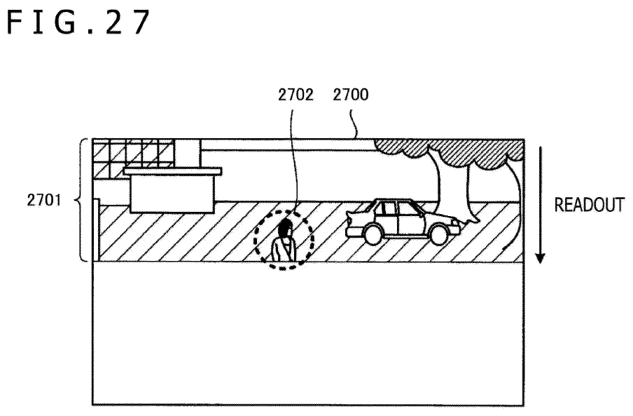

Each of FIGS. 26 and 27 depicts an example where the recognition processing section 104 that performs the recognition process for each line ends the recognition process in response to acquisition of a valid recognition result in the middle of frame readout.

FIG. 26 depicts a recognition process example performed for each line in a case where a handwritten numeral “8” is a recognition target. According to the example depicted in FIG. 26, the numeral “8” is recognized in an input frame 2600 at the time when a range 2601 corresponding to approximately three fourths in the vertical direction is read. Accordingly, the recognition processing section 104 can output a valid recognition result indicating a fact that the numeral “8” has been recognized and end the line readout and the recognition process for the frame 2600 at the time when the range 2601 is read. Moreover, the determination basis calculation section 2116 starts the calculation process for calculating a determination basis for the recognition result at the time when the numeral “8” is recognized with readout of the range 2601 corresponding to approximately three fourths in the vertical direction. Accordingly, real-time presentation of the determination basis for recognition can be achieved by reduction of a time period required for obtaining a calculation result of the determination basis.

FIG. 27 depicts a recognition process example performed for each line in a case where a human is a recognition target. According to the example depicted in FIG. 27, a human 2702 is recognized in a frame 2700 at the time when a range 2701 corresponding to approximately a half in the vertical direction is read. Accordingly, the recognition processing section 104 can output a valid recognition result indicating a fact that the human 2702 has been recognized and end the line readout and the recognition process for the frame 2700 at the time when the range 2701 is read. Moreover, the determination basis calculation section 2116 starts the calculation process for calculating a determination basis at the time when the human 2702 is recognized with readout of the range 2701 corresponding to approximately a half in the vertical direction. Accordingly, real-time presentation of the determination basis for recognition can be achieved by reduction of a time period required for obtaining a calculation result of the determination basis.

As described above, according to the present embodiment, line readout and the recognition process can be ended and the determination basis calculation process can be started in a case where a valid recognition result is obtained in the middle of line readout from a frame. Accordingly, speed-up and power saving can be achieved by reduction of a processing volume of the recognition process, and also a time period required for the recognition process and presentation of a determination basis can be reduced.

While each of FIGS. 26 and 27 depicts the example which achieves line readout from the upper end to the lower end of the frame, the method for line readout is not limited to this example. For example, line readout may be achieved from the lower end to the upper end of the frame. Generally, an object constituted by a body located far from the imaging device 100 approaches a vanishing point located in an upper part of the frame. Accordingly, the object can be recognized earlier when line readout is achieved from the upper end to the lower end of the frame. On the other hand, an object constituted by a body located in front of the imaging device 1 generally approaches a lower part of the frame away from a vanishing point. Accordingly, the object can be recognized earlier when line readout is achieved from the lower end to the upper end of the frame.

Discussed herein will be such a case where the imaging device 100 is an in-vehicle device installed so as to capture a front image, for example. An object located in the front (e.g., a vehicle or a pedestrian located in front of an own vehicle) is present in a lower part of a captured image screen. Accordingly, it is more effective to read lines from a lower end to an upper end of a frame. Moreover, in a case where an immediate stop is needed in ADAS (Advanced Driver-Assistance Systems), recognition of at least one corresponding object is only required. Accordingly, in a case where one object is recognized, re-execution of line readout from a lower end of a frame is considered to be more effective. Further, a far object on a highway or the like is given priority in some cases. In this case, it is preferable to execute line readout from an upper end to a lower end of a frame. Accordingly, in the case of the in-vehicle imaging device 100, it is only needed to switch a line readout direction or a line readout order according to a driving situation or the like.

In addition, a direction of a readout unit of a frame may be set to the column direction in the row and column directions of the pixel array section 601. For example, a set of a plurality of pixels arranged in one column in the pixel array section 601 may be designated as a readout unit. Column readout designating a column as a readout unit is achievable by adopting the global shutter system as the imaging system. According to the global shutter system, column readout and line readout are switchable for execution of readout. In a case where readout is fixed to column readout, it is possible to rotate the pixel array section 601 by 90 degrees to use the rolling shutter system, for example.

For example, concerning an object constituted by a body located on the left side of the imaging device 100, earlier recognition and real-time presentation of a determination basis are achievable by sequentially achieving readout from a left end of a frame in the manner of column readout. Similarly, concerning an object constituted by a body located on the right side of the imaging device 100, earlier recognition and real-time presentation of a determination basis are achievable by sequentially achieving readout from a right end of a frame in the manner of column readout.

According to the example using the imaging device 100 as an in-vehicle device, an object constituted by a body located on a turning side is given priority in some cases when a vehicle is rotating, for example. In such cases, it is preferable to achieve readout from an end of the turning side in a manner of column readout. The turning direction can be acquired on the basis of steering information associated with the vehicle, for example. Alternatively, for example, a sensor capable of detecting angular velocities in three directions with respect to the imaging device 1 can be provided to acquire the turning direction on the basis of a detection result obtained by this sensor.

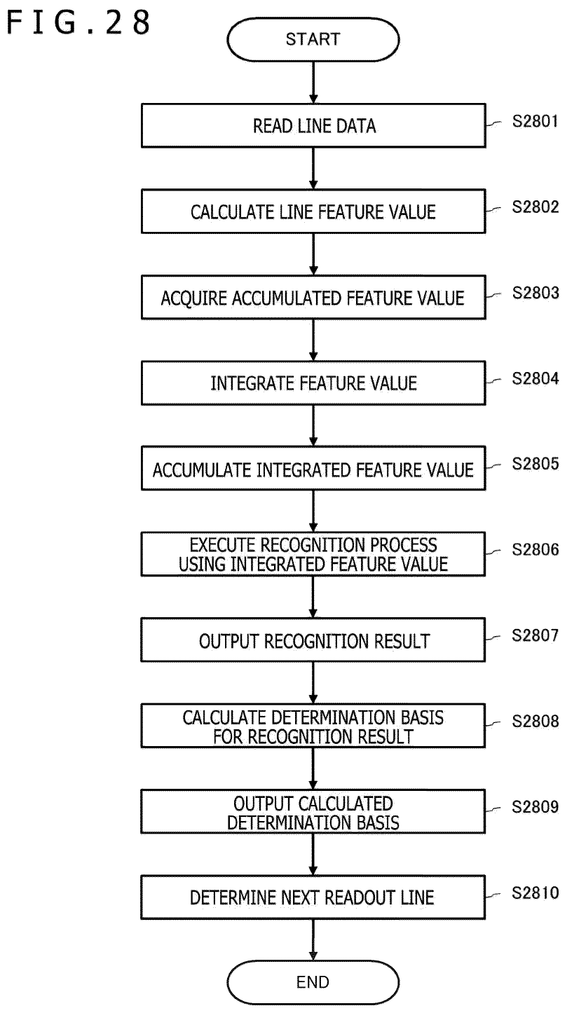

FIG. 28 illustrates procedures, in a form of a flowchart, associated with recognition and a determination basis calculation process corresponding to readout of pixel data for each readout unit (e.g., one line) from a frame according to the first embodiment. The processing procedures illustrated in the figure represent a process corresponding to readout of pixel data for each readout unit (e.g., one line) from a frame, for example. Note that described with reference to FIG. 28 will be procedures of recognition and a determination basis calculation process in a case where a line is designated as the readout unit. For example, as readout region information, a line number indicating a line to be read can be used.

Initially, the recognition processing section 104 reads line data from a line indicated by a readout line of a frame (step S2801). Specifically, the readout determination section 2114 gives a line number of a line to be read next to the sensor control section 103. On the basis of the given line number, the readout section 2101 of the sensor control section 103 reads pixel data of the line indicated by the line number from the sensor section 102 as line data. The readout section 2101 gives the line data read from the sensor section 102 to the feature value calculation section 2111. Moreover, the readout section 2101 gives readout region information (e.g., line number) indicating a region from which the pixel data has been read to the feature value calculation section 2111.

Subsequently, the feature value calculation section 2111 calculates a feature value of an image on the basis of the line data given from the readout section 2101 (step S2802). Moreover, the feature value calculation section 2111 acquires a feature value accumulated in the feature value accumulation section 2113 from the feature value accumulation control section 2112 (step S2803) and integrates the feature value calculated in step S2802 with the feature value acquired from the feature value accumulation control section 2112 in step S2803 (step S2804). The integrated feature value is given to the feature value accumulation control section 2112. The feature value accumulation control section 2112 accumulates the integrated feature value in the feature value accumulation section 2113 (step S2805).

Note that a series of processes in steps S2801 to S2804 correspond to processes for a head line of the frame. In addition, in a case where the feature value accumulation section 2113 has been initialized, for example, the processes in steps S2803 and S2804 can be skipped. Moreover, the process in step S2805 in this case is a process for accumulating the line feature value calculated on the basis of this head line, in the feature value accumulation section 2113.

The feature value accumulation control section 2112 also gives the integrated feature value given from the feature value calculation section 2111, to the recognition process execution section 2115. The recognition process execution section 2115 executes the recognition process on the basis of the integrated feature value given from the feature value accumulation control section 2112 (step S2806). The recognition process execution section 2115 outputs a recognition result obtained by the recognition process to the output control section 107 (step S2807).

The recognition process execution section 2115 also outputs the recognition result obtained by the recognition process to the determination basis calculation section 2116. The determination basis calculation section 2116 calculates a determination basis for the recognition result given from the recognition process execution section 2115 (step S2808). The determination basis calculation section 2116 estimates a place contributing to the recognition result in the line data, on the basis of the feature value of the line data calculated in step S2802, with use of a Grad-Cam algorithm, for example, or estimates a place contributing to the recognition result in an image within a range previously read, on the basis of the feature value integrated in step S2804. Thereafter, the determination basis calculation section 2116 outputs the calculated determination basis to the output control section 107 (step S2809).

Thereafter, the readout determination section 2114 included in the recognition processing section 104 determines a readout line to be read next, according to readout information given from the feature value accumulation control section 2112 (step S2810). For example, when receiving readout region information from the feature value calculation section 2111 together with the feature value, the feature value accumulation control section 2112 determines a readout line to be read next, on the basis of this readout region information, according to a readout pattern (a line unit in this example) designated beforehand, for example. The processes in step S2801 and the following steps are again executed for the readout line determined in step S2810.

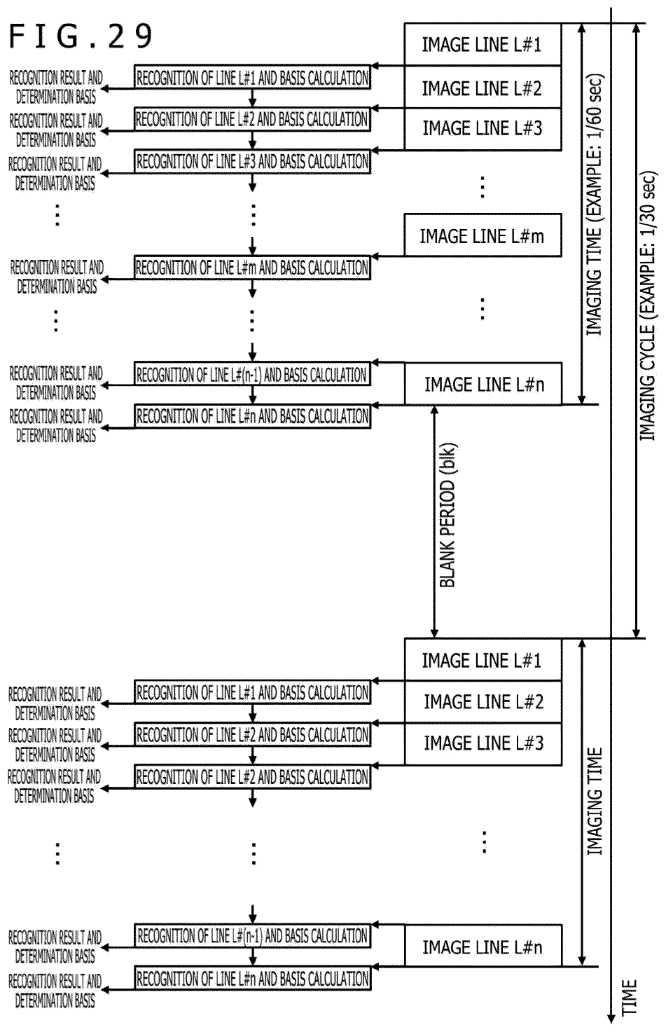

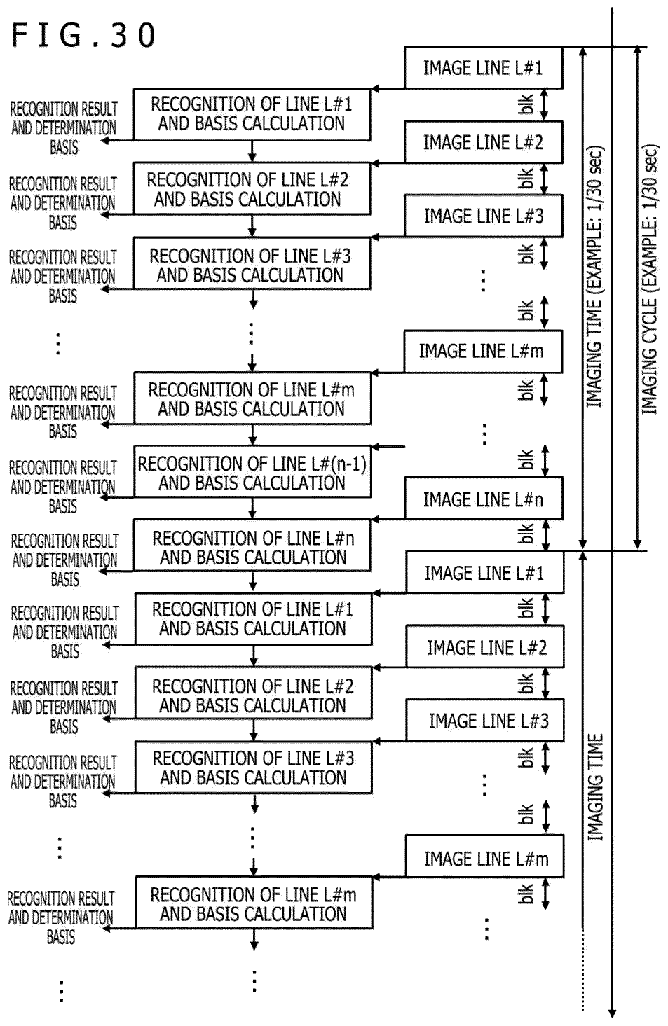

Subsequently described will be a control example of readout and the recognition process according to the first embodiment. Each of FIGS. 29 and 30 illustrates a control time chart example of readout and also the recognition process and determination basis calculation according to the first embodiment. Each of FIGS. 29 and 30 is a time chart example which provides a blank period blk in which no imaging operation is performed in one imaging cycle (one frame cycle).

FIG. 29 illustrates a time chart example which continuously allocates a half period of the imaging cycle, for example, to the blank period blk. In the figure, the imaging cycle is equivalent to a frame cycle, such as 1/30 [sec]. Frame readout from the sensor section 102 is achieved in this imaging cycle. An imaging time is a period of time required for achieving imaging of all lines included in the frame. According to the example illustrated in FIG. 29, the frame is assumed to include n lines. Imaging of the n lines including line L#1 to line L#n is completed in 1/60 [sec] which is a half period of the frame cycle 1/30 [sec]. A time period allocated to imaging of one line is 1/(60×n) [sec]. A period of 1/30 [sec] from a time when the last line L#n in the frame is imaged to a time when a head line L#1 in a next frame is imaged corresponds to the blank period blk.

For example, at the time when imaging of the line L#1 is completed, imaging of the next line L#2 is started, and also the line recognition process performed by the recognition process execution section 2115 for the line L#1 and the determination basis calculation process performed by the determination basis calculation section 2116 for this line recognition are executed. Each of the recognition process execution section 2115 and the determination basis calculation section 2116 ends the own process before the start of imaging of the next line L#2. After ending the line recognition process for the line L#1, the recognition process execution section 2115 outputs a recognition result of this recognition process, while the determination basis calculation section 2116 outputs a calculation result of the determination basis for this line recognition.

The next line L#2 is similarly handled. At the time when imaging of the line L#2 is completed, imaging of the next line L#3 is started, and also the line recognition process performed by the recognition process execution section 2115 for the line L#1 and the determination basis calculation process performed by the determination basis calculation section 2116 for this line recognition are executed. Each of the recognition process execution section 2115 and the determination basis calculation section 2116 ends the own process before the start of imaging of the next line L#3. In this manner, imaging of the lines L#1, L#2, #3, L#m, and up to L#n is sequentially executed. Thereafter, imaging of the line next to the line for which imaging has been completed is started for each of the lines L#1, L#2, L#3, L#m, and up to L#n at the time of the end of imaging. In addition, the line recognition process for the line for which imaging has been completed and the determination basis calculation process for the recognition result are executed.

As described above, a recognition result and a determination basis for this recognition result can be sequentially obtained without a necessity of input of all image data of a frame to the recognizer (recognition processing section 104), by sequentially executing the recognition process and the determination basis calculation process for the recognition result for each readout unit (line in this example). Accordingly, a delay produced until acquisition of the recognition result and the determination basis for the recognition result can be reduced. Moreover, in a case where a valid recognition result is obtained from a certain line, the recognition process can be ended at that timing. Accordingly, reduction of a time period required for the recognition process and the determination basis calculation process and power saving are achievable. Further, recognition accuracy can gradually improve by propagating and integrating information on a time axis concerning recognition results of the respective lines and the like.

Note that a different process intended to be executed within the frame cycle (e.g., image processing performed by the image processing section 106 on the basis of a recognition result) can be executed in the blank period blk within the frame cycle in the example illustrated in FIG. 29.

FIG. 30 illustrates a time chart example which provides the blank period blk for each imaging of one line. In the figure, the frame cycle (imaging cycle) is set to 1/30 [sec] as with the example illustrated in FIG. 29. However, the imaging time period is 1/30 [sec] equivalent to the imaging cycle. Moreover, in the example illustrated in FIG. 30, imaging of n lines including the lines L#1 to L#n is executed at time intervals of 1/(30×n) [sec] in one frame cycle, while the imaging time period for one line is 1/(60×n) [sec].

In this case, the blank period blk of 1/(60×n) [sec] is providable for each imaging of the respective lines L#1 to L#n. A different process intended to be executed for a captured image of the corresponding line (e.g., image processing performed by the image processing section 106 on the basis of a recognition result) can be executed in each of the blank periods blk of the respective lines L#1 to L#n. In this case, a time period until a time point immediately before an end of imaging of the line next to the target line (approximately 1/(30×n) [sec] in this example) can be allocated to this different process. According to the time chart example illustrated in FIG. 30, a processing result of this different process can be output for each line. Accordingly, the processing result of the different process is more rapidly acquirable.

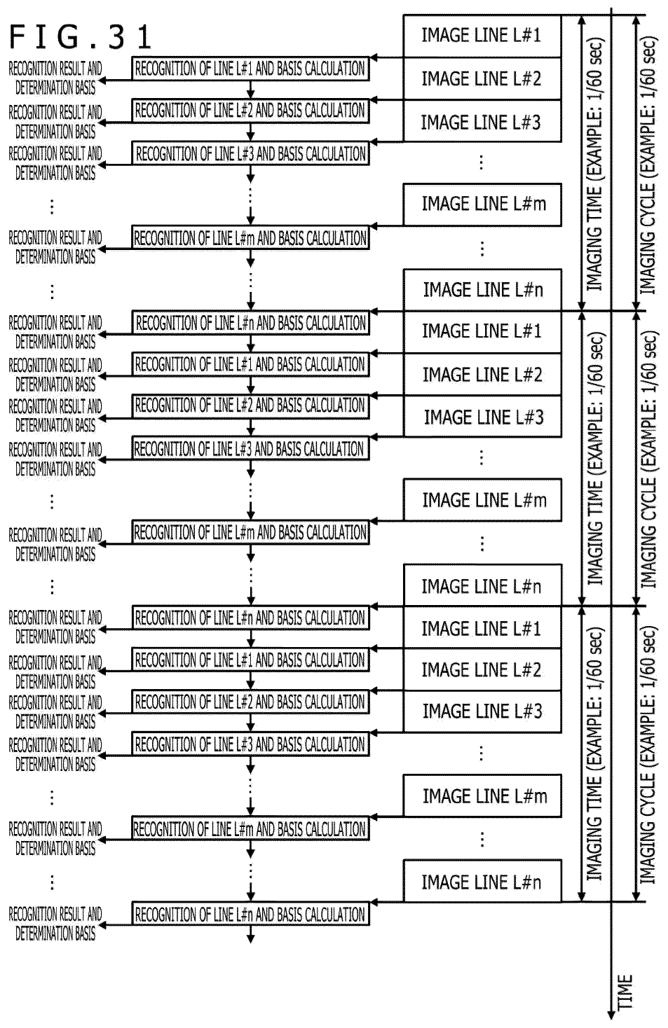

FIG. 31 illustrates another time chart example of control of readout and also the recognition process and determination basis calculation according to the first embodiment. According to the time chart examples illustrated in FIGS. 29 and 30, imaging of all the lines L#1 to L#n included in the frame is completed in a period of a half of the frame cycle, and the remaining half of the frame cycle is designated as a blank period. On the other hand, according to the time chart example illustrated in FIG. 31, no blank period is provided within the frame cycle, and imaging of all the lines L#1 to L#n included in the frame is completed in the entire period of the frame cycle.

Suppose herein that the imaging time period of one line is set to 1/(60× n) [sec] equivalent to the imaging time period in each of FIGS. 29 and 30, and that the number of lines included in the frame is n equivalent to the corresponding number in each of FIGS. 29 and 30. In this case, the frame cycle, i.e., the imaging cycle, becomes 1/60 [sec]. Accordingly, in the time chart example not providing the blank period blk as illustrated in FIG. 31, a frame rate increases in comparison with a frame rate in each of the examples of FIGS. 29 and 30 described above.

### E-2. Modifications

Described in Paragraph E-2 herein will be several modifications associated with the embodiment described in Paragraph E-1. Note that the respective modifications can be practiced basically using the recognition processing section 104 having the functional configuration depicted in FIG. 21.

### E-2-1. Modification (1)

A first modification executes the recognition process and the determination basis calculation process while designating a plurality of adjoining lines as an image data readout unit.

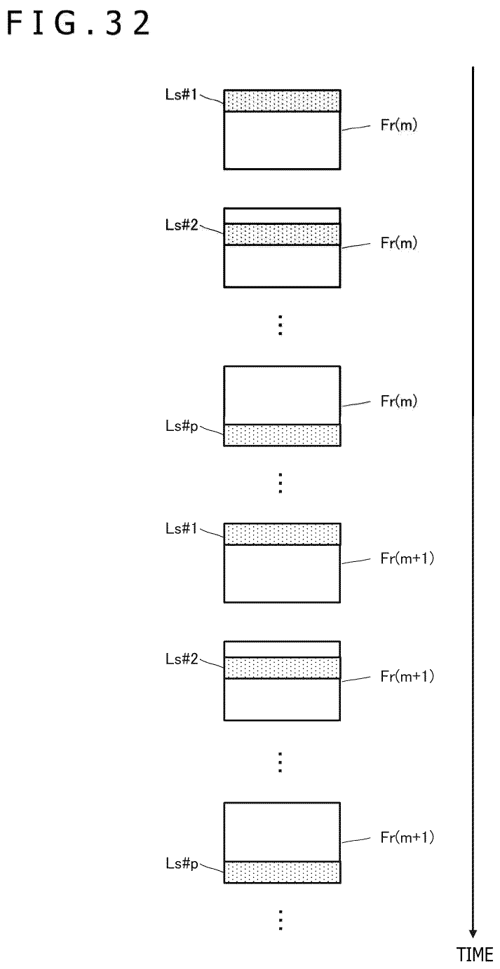

FIG. 32 graphically illustrates a frame readout process according to the first modification. As depicted in the figure, the first modification sequentially performs readout of pixel data from a line group including a plurality of adjoining lines from a frame Fr(m) while designating the line group as a readout unit. The readout determination section 2114 included in the recognition processing section 104 determines a line group Ls#x including the number of lines designated beforehand, as a readout unit, for example.

The readout determination section 2114 gives the readout control section 2102 readout region information which includes information indicating the line group Ls#x determined as a readout unit and readout position information added for readout of pixel data from this readout unit. The readout control section 2102 gives the readout region information given from the readout determination section 2114, to the readout section 2101. The readout section 2101 reads pixel data from the sensor section 102 according to the readout region information given from the readout control section 2102.

According to the modification depicted in FIG. 32, readout of the line group Ls#x in an m-th frame Fr(m) is achieved in a line sequential order from a line group Ls#1 at an upper end of the frame Fr(m) to line groups Ls#2, Ls#3, Ls#p, and others. After completion of line readout from the line group Ls#x of the frame Fr(m), readout of the line group Ls#x in a subsequent (m+1)th frame Fr(m+1) is similarly performed in a line sequential order from a line group Ls#1 at an upper end to line groups Ls#2, Ls#3, Ls#p, and others.

As described above, by designating the line group Ls#x including a plurality of lines as the readout unit and achieving readout of pixel data, pixel data of one frame can be read at higher speed than in the case of line sequential readout. Moreover, the recognition processing section 104 is allowed to use a larger volume of pixel data for one recognition process. Accordingly, recognition response speed is allowed to increase. Further, the number of times of readout from one frame decreases in comparison with readout for each line. Accordingly, distortion of a captured frame image can be reduced in a case where the rolling shutter system is adopted as the imaging system of the sensor section 102.

Note that readout of the line group Ls#x may be executed from the lower end to the upper end of the frame in the first modification depicted in FIG. 32, as with the embodiment in Paragraph E-1 described above. Moreover, readout of the line group, and also the recognition process and the determination basis calculation process can be ended in a case where a valid recognition result is obtained in the middle of readout of the line group Ls#x for the frame. Accordingly, speed-up and power saving are achievable by reduction of a processing volume of the recognition process. In addition, real-time presentation of a determination basis for recognition is achievable by reduction of a time period required for the recognition process and the determination basis calculation process.

### E-2-2. Modification (2)

A second modification will be subsequently described. The second modification designates a part of one line as a readout unit.

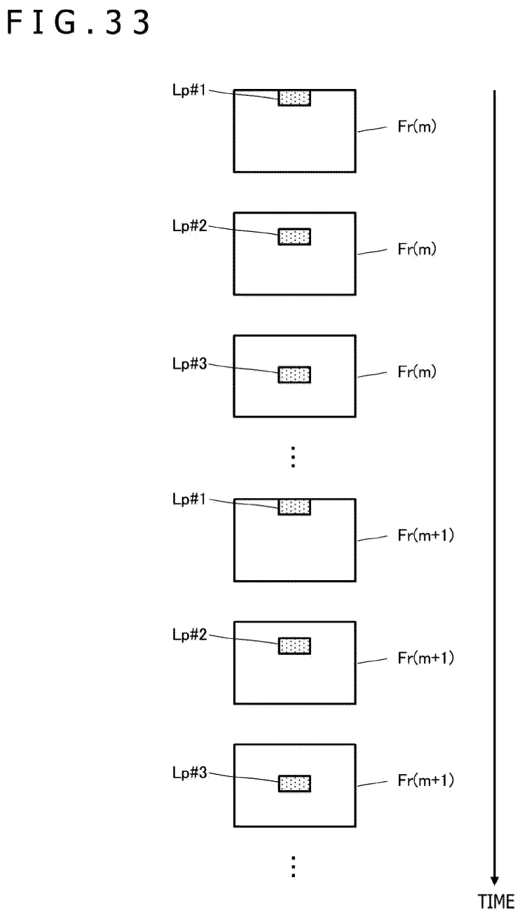

FIG. 33 graphically illustrates a frame readout process according to the second modification. In the example depicted in FIG. 33, a part of each line (referred to as a partial line) is designated as a readout unit in line readout achieved in a line sequential order, and readout of pixel data for each line is achieved from a partial line Lp#x of a corresponding line in a frame Fr(m). The readout determination section 2114 included in the recognition processing section 104 determines, as the readout unit, a smaller number of pixels, which is a plurality of sequentially adjoining pixels in pixels included in the line, than the total number of pixels included in the line, for example.

The readout determination section 2114 gives the readout control section 2102 readout region information which includes information indicating the partial line Lp#x determined as a readout unit and readout position information added for readout of pixel data from the partial line Lp#x. For example, the information indicating the readout unit herein includes a position of the partial line Lp#x within one line and the number of pixels included in the partial line Lp#x. Moreover, the readout position information is expressed by a line number of the line including the partial line Lp#x to be read. The readout control section 2102 gives the readout region information given from the readout determination section 2114, to the readout section 2101. The readout section 2101 reads pixel data from the sensor section 102 according to the readout region information given from the readout control section 2102.

According to the second modification depicted in FIG. 33, readout from the respective partial lines Lp#x is achieved in the m-th frame Fr(m) for each line from a partial line Lp#1 included in an upper end line of the frame Fr(m) to partial lines Lp#2, Lp#3, and others included in the respective lines. After completion of readout from a line group in the frame Fr(m), readout from the partial line Lp#x is similarly performed for each line from a partial line Lp#1 included in an upper end line in a subsequent (m+1)th frame Fr(m+1).

As described above, by limiting pixels to be read for line readout to pixels included in a part of a line, pixel data transfer is achievable in a narrower band than in a case of pixel data readout from an entire line. By adopting the readout method according to the modification depicted in FIG. 33, a transfer volume of pixel data decreases in comparison with the case of pixel data readout from an entire line. Accordingly, power saving is achievable.

Note that readout of the partial line may be executed from the lower end to the upper end of the frame in the second modification depicted in FIG. 33, as with the embodiment in Paragraph E-1 described above. Moreover, the readout of the partial line Lp#x, and also the recognition process and the determination basis calculation process can be ended in a case where a valid recognition result is obtained in the middle of the readout of the partial line for the frame. Accordingly, speed-up and power saving are achievable by reduction of a processing volume of the recognition process. In addition, real-time presentation of a determination basis is achievable by reduction of a time period required for the recognition process and the determination basis calculation process.

### E-2-3. Modification (3)

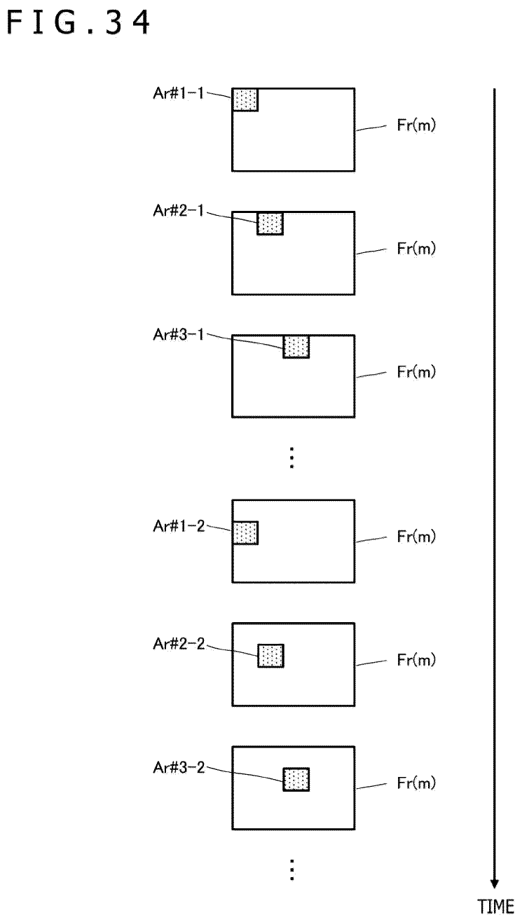

A third modification will be subsequently described. The third modification designates an area having a predetermined size within a frame as a readout unit. FIG. 34 graphically illustrates a frame readout process according to the third modification.

According to the example depicted in FIG. 34, an area Ar#x-y which has a predetermined size and includes a plurality of pixels sequentially adjoining in each of the line direction and the vertical direction within a frame is designated as a readout unit. The area Ar#x-y is sequentially read in the line direction, for example, from a frame Fr(m). In addition, sequential readout from the area Ar#x-y in the line direction is sequentially repeated in the vertical direction. The readout determination section 2114 included in the recognition processing section 104 determines as a readout unit the area Ar#x-y defined by a size (number of pixels) in the line direction and a size (number of lines) in the vertical direction, for example. While a pixel readout position in the line direction in each of lines is fixed in the example depicted in FIG. 33, a pixel readout position in the line direction shifts for each line in the example illustrated in FIG. 34.

The readout determination section 2114 gives the readout control section 2102 readout region information which includes information indicating the area Ar#x-y determined as a readout unit and readout position information added for readout of pixel data from the area Ar#x-y. The information indicating the readout unit herein includes the size (number of pixels) in the line direction described above and the size (number of lines) in the vertical direction as described above, for example. Moreover, the readout position information is expressed by a position of a predetermined pixel included in the area Ar#x-y to be read, such as a pixel position of a pixel located at an upper left corner of the area Ar#x-y. The readout control section 2102 gives the readout region information given from the readout determination section 2114, to the readout section 2101. The readout section 2101 reads pixel data from the sensor section 102 according to the readout region information given from the readout control section 2102.

According to the third modification, readout from the respective areas Ar#x-y in an m-th frame Fr(m) is achieved from an area Ar#1-1 located at an upper left corner of the frame Fr(m) to areas Ar#2-1, Ar#3-1, and others in the line direction as depicted in FIG. 34. After completion of readout up to the right end in the line direction in the frame Fr(m), the readout position in the vertical direction is shifted to again start readout of the respective areas Ar#x-y in the line direction sequentially from the left end of the frame Fr(m) in an order of areas Ar#1-2, Ar#2-2, Ar#3-2, and others.

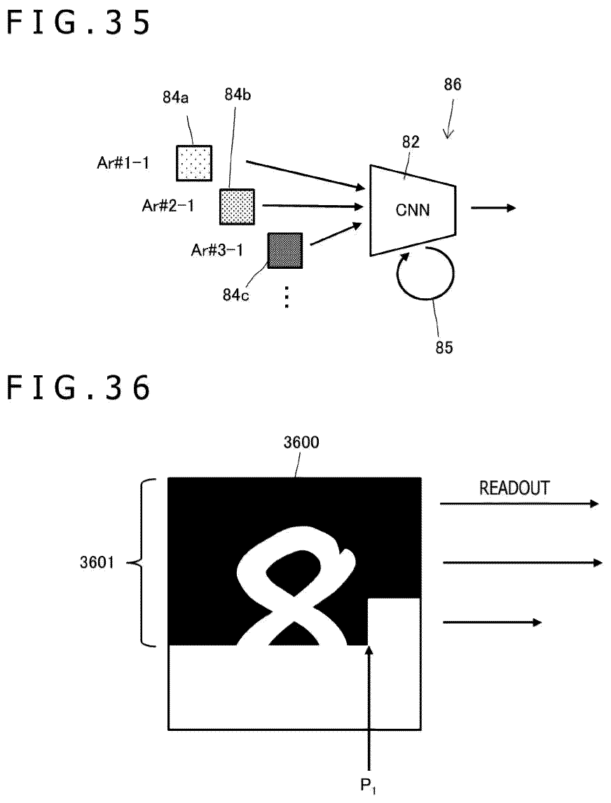

FIG. 35 is a schematic diagram schematically depicting a recognition process performed in a case where image data is read from a frame for each area having the predetermined size as depicted in FIG. 34. As depicted in FIG. 35, the recognition process is achieved by sequentially executing processing with use of the CNN 82 and the update 85 of internal information for the respective items of pixel information 84a, 84b, and 84c associated with the respective areas Ar#1-1, Ar#2-1, Ar#3-1, and others. The pixel information 84 associated with one area is only required to be input to the CNN 82. Accordingly, considerable reduction of the scale of the recognizer 86 is achievable.

Moreover, the determination basis calculation section 2116 estimates a place contributing to a recognition result in a current input area by reversely tracing a gradient from a label corresponding to an identification result of classification in an output layer of the CNN 82 with use of a Grad-Cam algorithm, for example (calculating contributions of respective feature maps until classification, and achieving back propagation with weights of the contributions), and further estimates a place contributing to the recognition result in an image within a range previously read, on the basis of the updated internal information 85. The determination basis calculation section 2116 starts a calculation process for calculating a determination basis for the recognition result, before completion of the readout process for the entire frame. Accordingly, a time period required for obtaining a calculation result of the determination basis can be reduced, and therefore, real-time presentation of the determination basis for recognition can be achieved.

The recognizer 86 depicted in FIG. 35 executes processing with use of the CNN 82 for information sequentially input, to achieve the update 85 of the internal information, and therefore is considered to have a function as an RNN. When the recognition process for each area is performed using an RNN, a valid recognition result can be acquired without a necessity of reading all areas contained in a frame in some cases. In a case of the recognition process performed for each area, the recognition processing section 104 is allowed to end the recognition process at the time of acquisition of a valid recognition result. Moreover, the determination basis calculation section 2116 is allowed to calculate a determination basis at the time when the recognition processing section 104 acquires a valid recognition result.

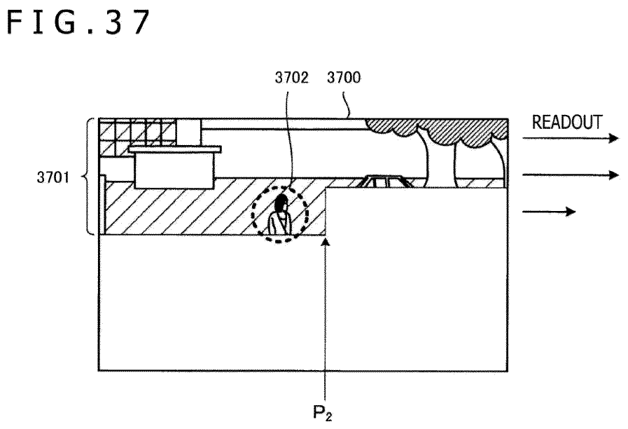

Each of FIGS. 36 and 37 depicts an example where the recognition processing section 104 ends the recognition process in the middle of frame readout in the case of the readout unit set to the area Ar#x-y.

FIG. 36 depicts an example of the recognition process performed for each area in a case where a handwritten numeral “8” is a recognition target. According to the example depicted in FIG. 36, the numeral “8” is recognized at a position P₁ at a time of readout of a range 3601 corresponding to approximately two thirds of the whole of an input frame 3600. Accordingly, at the time of readout of the range 3601, the recognition processing section 104 is allowed to output a valid recognition result indicating a fact that the numeral “8” has been recognized, and end the area readout and the recognition process for the frame 3600. Moreover, the determination basis calculation section 2116 starts the calculation process for calculating a determination basis for the recognition result at the time when the numeral “8” is recognized on the basis of readout of the range 3601 corresponding to approximately two thirds of the whole. Accordingly, a time period required for obtaining a calculation result of the determination basis can be reduced, and therefore, real-time presentation of the determination basis for recognition can be achieved.

FIG. 37 depicts an example of the recognition process performed for each area in a case where a human is a recognition target. According to the example depicted in FIG. 37, a human 3702 is recognized at a position P2 at a time of readout of a range 3701 corresponding to approximately a half in the vertical direction in a frame 3700. Accordingly, at the time of readout of the range 3701, the recognition processing section 104 is allowed to output a valid recognition result indicating a fact that the human 3702 has been recognized, and end the area readout and the recognition process for the frame 3700. Moreover, the determination basis calculation section 2116 starts the calculation process for calculating a determination basis at the time when the human 3702 is recognized on the basis of readout of the range 2701 corresponding to approximately a half in the vertical direction. Accordingly, a time period required for obtaining a calculation result of the determination basis can be reduced, and therefore, real-time presentation of the determination basis for the recognition can be achieved.

As described above, according to the third modification, the area readout and the recognition process can be ended and the calculation process of the determination basis can be started in a case where a valid recognition result is obtained in the middle of the area readout from the frame. Accordingly, speed-up and power saving can be achieved by reduction of a processing volume of the recognition process, and also a time period required for the recognition process and presentation of a determination basis can be reduced. Moreover, according to the third modification depicted in FIGS. 34 to 37, redundant readout decreases in comparison with the embodiment which performs readout for an entire width in the line direction. Accordingly, more reduction of the time period required for the recognition process is achievable.

While the third modification achieves readout of the area Ar#x-y from the left end to the right end for the line direction and from the upper end to the lower end of the frame for the vertical direction. However, the manner of readout is not limited to this example. For example, readout in the line direction may be achieved from the right end to the left end, and readout in the vertical direction may be achieved from the lower end to the upper end of the frame.

### E-2-4. Modification (4)

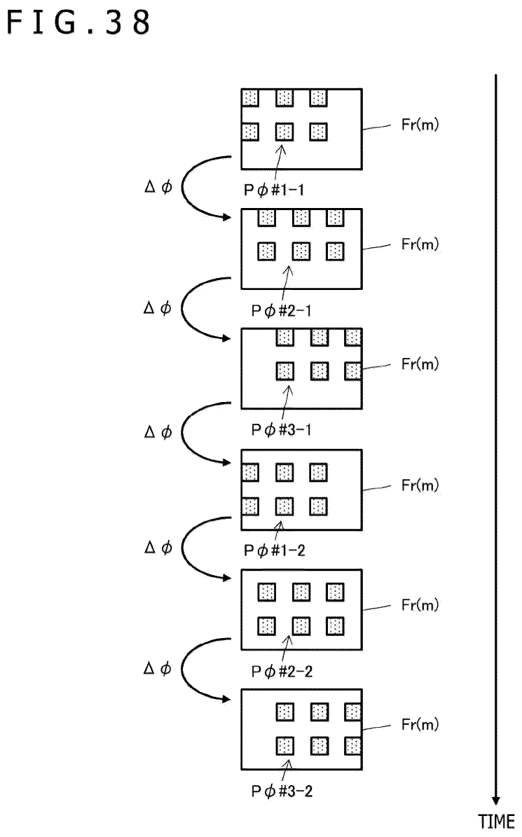

A fourth modification will be subsequently described. The fourth modification designates as a readout unit a pattern including a plurality of pixels including pixels not adjacent to each other. FIG. 38 graphically illustrates a frame readout process according to the fourth modification.

According to the example depicted in FIG. 38, a pattern Pφ#x-y including a plurality of pixels discretely and cyclically arranged in each of the line direction and the vertical direction is designated as a readout unit, for example. Specifically, the pattern Pφ#x-y includes six pixels cyclically positioned, i.e., three pixels arranged at predetermined intervals in the line direction and three pixels arranged at positions corresponding to the respective positions of the above three pixels in the line direction with an interval in the vertical direction for each. The readout determination section 2114 included in the recognition processing section 104 determines as the readout unit the plurality of pixels arrayed according to the pattern Pφ#x-y.

While the pattern Pφ#x-y described above includes the plurality of discrete pixels, the pattern forming the readout unit is not limited to this example. For example, the pattern Pφ#x-y may include a plurality of pixel groups discretely arranged, the pixel groups each including a plurality of pixels adjacent to each other. According to the example depicted in FIG. 38, the pattern Pφ#x-y includes a plurality of pixel groups discretely and cyclically arranged, the pixel groups each having four pixels including two pixels x two pixels adjacent to each other. According to the example depicted in FIG. 38, the pattern Pφ#x-y has six pixel groups in total, i.e., three pixel groups arranged in the line direction and two pixel groups arranged in the vertical direction, the pixel groups being discretely and cyclically arranged.

The readout determination section 2114 gives the readout control section 2102 readout region information which includes information indicating the pattern Pφ#x-y determined as a readout unit and readout position information added for readout from the pattern Pφ#x-y. It is possible herein that the information indicating the readout unit includes information indicating a positional relation between a predetermined pixel of pixels constituting the pattern Pφ#x-y (e.g., a pixel at an upper left corner in the pixels constituting the pattern Pφ#x-y) and each of other pixels constituting the pattern Pφ#x-y, for example. Moreover, it is possible that the readout position information is expressed by information indicating a position of a predetermined pixel included in the pattern Pφ#x-y to be read (information indicating a position within a line, and a line number). The readout control section 2102 gives the readout region information given from the readout determination section 2114, to the readout section 2101. The readout section 2101 reads pixel data from the sensor section 10 according to the readout region information given from the readout control section 2102.

According to the example depicted in FIG. 38, readout of the respective patterns Pφ#x-y is achieved in an m-th frame Fr(m) from a pattern Pφ#1-1 where a pixel at an upper left corner is located at an upper left corner of the frame Fr(m), for example, to patterns Pφ#2-1, Pφ#3-1, and others while sequentially shifting the position in the line direction one pixel by one pixel, for example. For example, when the right end of the pattern Pφ#x-y reaches the right end of the frame Fr(m), readout of the respective patterns Pφ#x-y is similarly achieved from the left end of the frame Fr(m) for patterns Pφ#1-2, Pφ#2-2, Pφ#3-2, and others after a shift of the position in the vertical direction by one pixel (by one line).

Pixels in each of the patterns Pφ#x-y are cyclically arranged. Accordingly, the action of shifting the patterns Pφ#x-y one pixel by one pixel is considered as an action for shifting a phase of the patterns Pφ#x-y. Specifically, the fourth modification achieves readout of each of the patterns Pφ#x-y while shifting the patterns Pφ#x-y by a phase Δφ for each in the line direction. The shift of the patterns Pφ#x-y in the vertical direction is achieved by shifting a phase Δφ′ in the vertical direction relative to the position of an initial pattern Pφ#1-y in the line direction, for example.

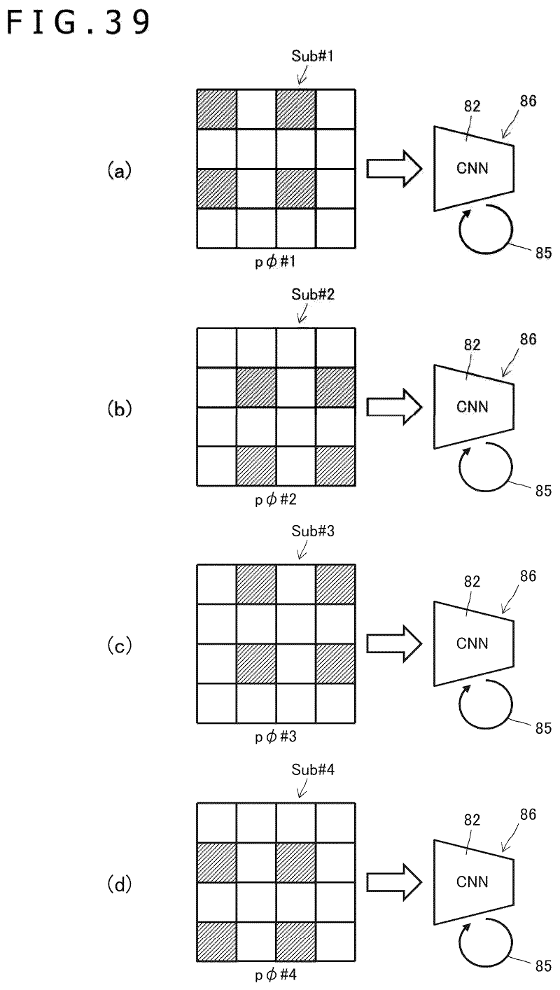

FIG. 39 schematically depicts a recognition process applicable to the fourth modification. FIG. 39 depicts an example where a pattern Pφ#z includes four pixels located separately by one pixel from each other in each of the horizontal direction (line direction) and the vertical direction. As depicted in (a) to (d) of FIG. 39, all of 16 pixels included in an area of 4 pixels×4 pixels can be read without duplication, by using patterns Pφ#1, Pφ#2, Pφ#3, and Pφ#4 each including four pixels and shifted by a phase of one pixel in each of the horizontal direction and the vertical direction. The respective sets of the four pixels read according to the patterns Pφ#1, Pφ#2, Pφ#3, and Pφ#4 constitute sub-samples Sub#1, Sub#2, Sub#3, and Sub#4, respectively, extracted without duplication from the 16 pixels contained in a sample region of 4 pixels×4 pixels.

According to the example depicted in (a) to (d) of FIG. 39, the recognition process is achieved by executing a process using the CNN 82 and the update 85 of internal information for each of the sub-samples Sub#1, Sub#2, Sub#3, and Sub#4. In this case, four pieces of pixel data are only required to be input to the CNN 82 for one recognition process. Accordingly, considerable reduction of the scale of the recognizer 86 is achievable.

Moreover, the determination basis calculation section 2116 estimates a place contributing to a recognition result in a current input pattern, by reversely tracing a gradient from a label corresponding to an identification result of classification in an output layer of the CNN 82 with use of a Grad-Cam algorithm, for example (calculating contributions of respective feature maps until classification and achieving back propagation with weights of the contributions), and further estimates a place contributing to the recognition result in an image within a range previously read, on the basis of the updated internal information 85. The determination basis calculation section 2116 starts a calculation process for calculating a determination basis for the recognition result, before completion of the readout process for the entire frame. Accordingly, real-time presentation of the determination basis for recognition is achievable by reduction of a time period required for obtaining a calculation result of the determination basis.

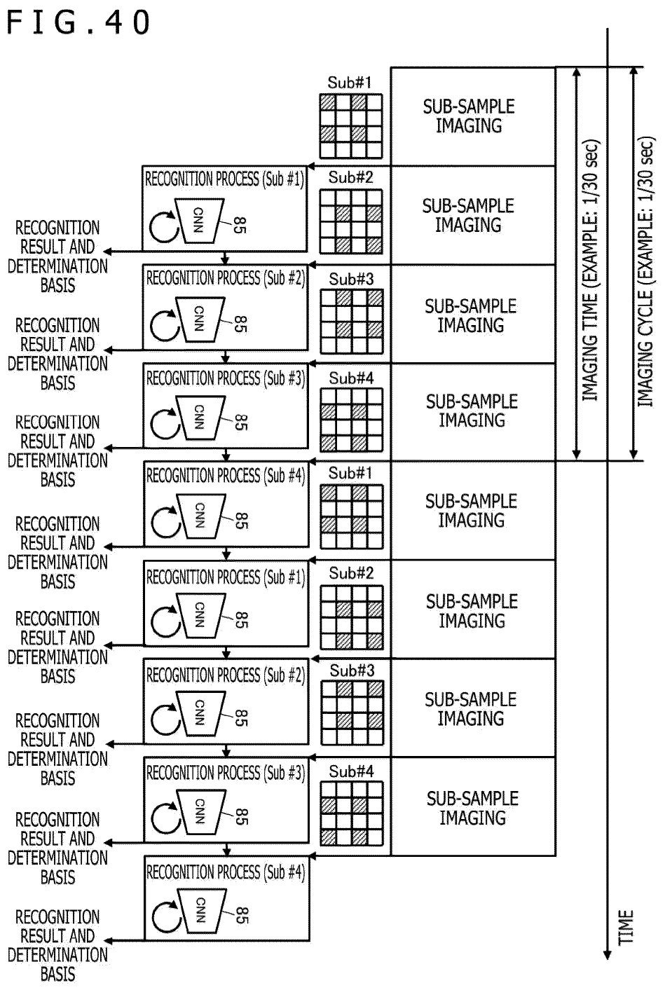

FIG. 40 illustrates a control time chart example of readout and also the recognition process and determination basis calculation according to the fourth modification. In the figure, an imaging cycle is equivalent to a frame cycle, and set to 1/30 [sec] in the example depicted in FIG. 40. Frame readout from the sensor section 102 is achieved in this frame cycle. An imaging time is a period of time required for achieving imaging of all the sub-samples Sub#1 to Sub#4 included in a frame and is set to 1/30 [sec] equivalent to the imaging cycle in the example depicted in FIG. 40. Note that imaging of one sub-sample Sub#x will be referred to as sub-sample imaging.

The fourth modification divides the imaging time into four periods, and executes sub-sample imaging of the respective sub-samples Sub#1, Sub#2, Sub#3, and Sub#4 in the corresponding periods. Specifically, the sensor control section 103 executes sub-sample imaging using the sub-sample Sub#1 for an entire frame in a first period included in first to fourth periods as divisions of the imaging time. For example, the sensor control section 103 extracts the sub-sample Sub#1 while shifting the sample region including 4 pixels×4 pixels in the line direction without duplication. The sensor control section 103 repeatedly executes the action of extracting the sub-sample Sub#1 in the vertical direction while shifting the sample region in the line direction.

After completion of extraction of the sub-samples Sub#1 of one frame, the recognition processing section 104 inputs the extracted sub-samples Sub#1 of one frame to the recognizer 86 for each of the sub-samples Sub#1 and executes the recognition process, for example. The recognition processing section 104 outputs a recognition result after completion of the recognition process for one frame. Alternatively, the recognition processing section 104 may output a recognition result in a case where a valid recognition result is obtained in the middle of the recognition process for one frame, and end the recognition process for the corresponding sub-samples Sub#1. Moreover, the determination basis calculation section 2116 executes a determination basis calculation process for recognition of the corresponding sub-samples Sub#1.

Thereafter, sub-sample imaging using the sub-samples Sub#2, Sub#3, and Sub#4 for the entire frame is similarly executed for the second, third, and fourth periods, respectively. Subsequently, the recognition processing section 104 outputs a recognition result in a case where a valid recognition result is obtained in the middle of the recognition process for one frame, and the determination basis calculation section 2116 executes determination basis calculation for recognition of the sub-samples by the recognition processing section 104.

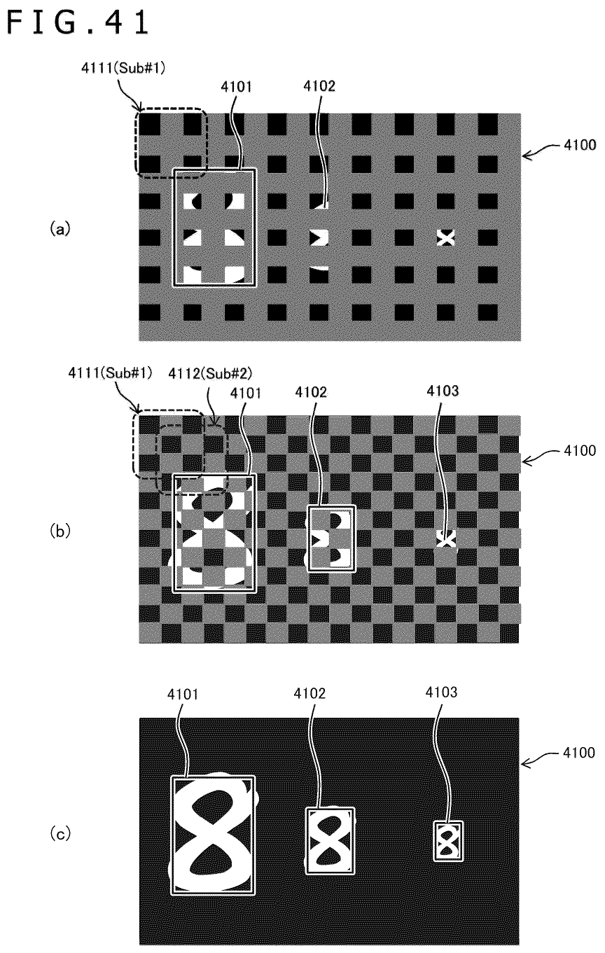

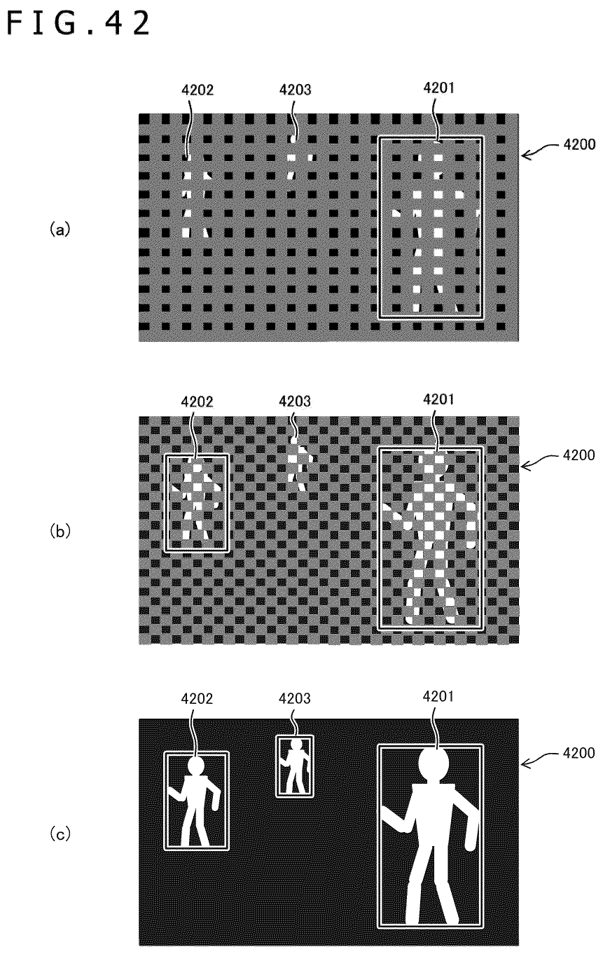

A frame readout process of the fourth modification in a case where the readout unit is the sample region will be specifically described with reference to FIGS. 41 and 42.

FIG. 41 depicts an example of a recognition process performed for each sample region unit in a case where a handwritten numeral “8” is a recognition target. Specifically, FIG. 41 depicts an example of a recognition process in a case where three numerals “8” having different sizes are contained in one frame. Each of the frames 4100 depicted in (a), (b), and (c) of FIG. 41 includes three objects 4101, 4102, and 4103 having different sizes and each expressing the numeral “8.” In addition, it is assumed that the object 4101 is the largest and the object 4103 is the smallest in the three objects 4101, 4102, and 4103 included in each of the frames 4100.

In (a) of FIG. 41, the sub-samples Sub#1 are extracted from sample regions each indicated by a reference number 4111. By extracting the sub-samples Sub#1 from the respective sample regions 4110 included in the frame 4100, every other pixel is read in a grid shape from the frame 4100 in each of the horizontal and vertical directions as depicted in (a) of FIG. 41. According to the example depicted in (a) of FIG. 41, the recognizer 86 is capable of recognizing only the largest object 4101 in the objects 4101, 4102, and 4103 on the basis of pixel data of the pixels read in this grid shape. Moreover, a recognition determination basis for the largest object 4101 can be presented.

After completion of extraction of the sub samples Sub#1 from the frame 4100, the sub-samples Sub#2 each indicated by a reference number 4112 are extracted. Each of the sub-samples Sub#2 includes pixels shifted from the sub-sample Sub#1 by one pixel in each of the horizontal and vertical directions within the sample region. The recognizer 86 has a structure corresponding to an RNN, and the internal state of the recognizer 86 has been updated on the basis of the recognition result of the sub-samples Sub#1. Accordingly, a recognition result corresponding to extraction of the sub-samples Sub#2 is affected by the recognition process for the sub-samples Sub#1. The recognition process corresponding to extraction of the sub-samples Sub#2 is considered as a process performed on the basis of pixel data of pixels read in a checkered pattern as depicted in (b) of FIG. 41. Accordingly, a state after further extraction of the sub-samples Sub#2 depicted in (b) of FIG. 41 has more improved resolution based on the pixel data in comparison with a case where the recognition process is performed in the state of extraction of only the sub-samples Sub#1 depicted in (a) of FIG. 41. Accordingly, the recognition process can be more accurately performed. According to the example depicted in (b) of FIG. 41, the recognizer 86 is capable of further recognizing the second largest object 4102. Moreover, a recognition determination basis for the second largest object 4102 can be presented.

A state in (c) of FIG. 41 depicts a state where extraction of all the sub-samples Sub#1 to Sub#4 is completed in the frame 4100. In the state depicted in (c) of FIG. 41, all the pixels included in the frame 4100 are read out, and the smallest object 4103 is recognized in addition to the objects 4101 and 4102 recognized by extraction of the sub-samples Sub#1 and Sub#2. Moreover, a recognition determination basis for all the objects 4101, 4102, and 4103 can be presented.

FIG. 42 depicts an example of a recognition process performed for each sample region unit in a case where a human is a recognition target, and illustrates a case where one frame contains images of three persons having different sizes depending on different distances of the respective persons from the imaging device 100. Each of frames 4200 depicted in (a), (b), and (c) of FIG. 42 includes three objects 4201, 4202, and 4203 that are constituted by images of persons having different sizes depending on distances of the persons from the imaging device 100. In addition, it is assumed that, in the three objects 4201, 4202, and 4203 included in each of the frames 4200, the object 4201 constituted by the image of the person located at the shortest distance from the imaging device 100 is the largest, and that the object 4203 constituted by the image of the person located at the longest distance from the imaging device 100 is the smallest.

In (a) of FIG. 42, the sub-samples Sub#1 are extracted as with the example depicted in (a) of FIG. 41, and the recognition process is executed by the recognizer 86. In this manner, the largest object 4201 in the objects 4201, 4202, and 4203 can be recognized. Moreover, a recognition determination basis for the largest object 4201 can be presented.

In (b) of FIG. 42, the sub-samples #2 are extracted as with the example depicted in (b) of FIG. 41. Each of the sub-samples #2 includes pixels shifted from the sub-sample Sub#1 by one pixel in each of the horizontal and vertical directions within the sample region. The recognizer 86 has a structure corresponding to an RNN, and the internal state of the recognizer 86 has been updated on the basis of the recognition result of the sub-samples Sub#1. Accordingly, a recognition result corresponding to extraction of the sub-samples Sub#2 is affected by the recognition process for the sub-samples Sub#1. As a result, resolution based on the pixel data improves in comparison with a case where the recognition process is performed in the state of extraction of only the sub-samples Sub#1 depicted in (a) of FIG. 42. Accordingly, the recognition process can be more accurately performed. According to the example depicted in (b) of FIG. 42, the recognizer 86 is capable of further recognizing the second largest object 4202. Moreover, a recognition determination basis for the second largest object 4202 can be presented.

Further, (c) of FIG. 42 depicts a state where extraction of all the sub-samples Sub#1 to Sub#4 is completed as with the case depicted in (c) of FIG. 41. In the state depicted in (c) of FIG. 42, all the pixels included in the frame 4200 are read out, and the smallest object 4203 is recognized in addition to the objects 4201 and 4202 recognized by extraction of the sub-samples Sub#1 and Sub#2. By repeating extraction of the sub-samples and the recognition process for the sub-samples Sub#1, Sub#2, and others in the manner described above, humans located farther are sequentially recognizable. Moreover, a recognition determination basis for all the objects 4201, 4202, and 4203 can be presented.

According to the respective examples depicted in FIGS. 41 and 42, frame readout and also the recognition process and the determination basis calculation process can be controlled according to a time period allocatable to the recognition process. For example, in a case where the time period allocatable to the recognition process is short, it is possible that the frame readout and the recognition process are ended at the time of completion of extraction of the sub-samples Sub#1 in the frame 4100 and recognition of the object 4101, and that a determination basis for a recognition result until that time is calculated and presented. On the other hand, in a case where the time period allocatable to the recognition process is long, it is possible that execution of the frame readout and the recognition process are continued until completion of extraction of all the sub-samples Sub#1 to Sub#4.

Alternatively, the recognition processing section 104 may control frame readout and also the recognition process and the determination basis calculation process according to reliability (score) of a recognition result. For example, if a score of a recognition result based on extraction for the sub-samples Sub#2 and the recognition process is a predetermined value or higher in (b) of FIG. 42, the recognition processing section 104 may prohibit execution of extraction of the subsequent sub-samples Sub#3 while ending the recognition process and executing the determination basis calculation process for the recognition result at that time.

As described above, the recognition process is allowed to end when a predetermined recognition result is obtained in the fourth modification. Accordingly, speed-up and power saving can be achieved by reduction of a processing volume of the recognition processing section 104, and also a time period required for the recognition process and presentation of a determination basis can be shortened.

Moreover, in the fourth modification, recognition response speed for a large-sized object within a frame is allowed to increase. Accordingly, a frame rate can be raised. Further, a time period required until presentation of a recognition result determination basis can be reduced according to the increase in the recognition response speed.

### E-2-5. Modification (5)

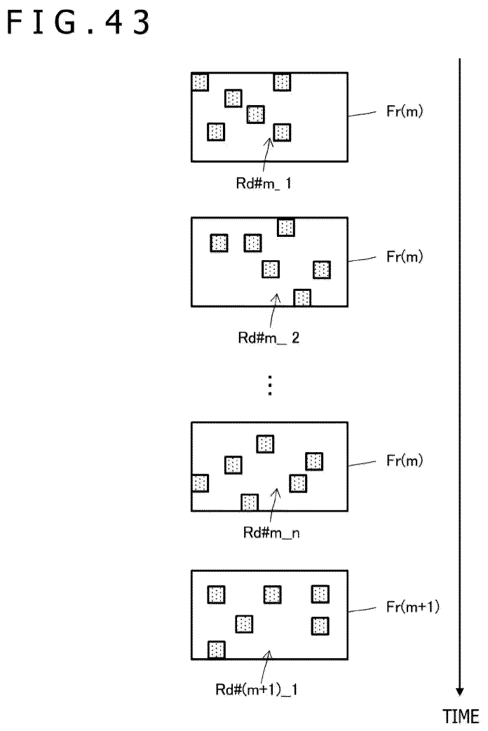

A fifth modification will be subsequently described. The fifth modification designates as a readout unit a pattern including a plurality of pixels including not adjoining pixels and randomly arranged. FIG. 43 graphically illustrates a frame readout process according to the fifth modification.

According to the example depicted in FIG. 43, a pattern Rd#m_x including a plurality of pixels discretely and non-cyclically arranged within a frame Fr(m) is designated as a readout unit, for example. In other words, the entire frame is a target of the readout unit according to the fifth modification.

According to the fifth modification, one frame cycle is divided into a plurality of periods with reference to FIG. 40 referred to above, and a pattern is switched for each period. In the example depicted in FIG. 43, the recognition processing section 104 reads pixels according to a pattern Rd#m_1 including a plurality of pixels discretely and non-cyclically arranged within an m-th frame Fr(m) and executes the recognition process in an initial period of the divisions of the frame cycle of the frame Fr(m). For example, in a case where the total number of pixels included in the frame Fr(m) and the number of divisions of the frame cycle are assumed to be s and D, respectively, the recognition processing section 104 selects (s/D) pixels discretely and non-cyclically arranged within the frame Fr(m) to constitute the pattern Rd#m_1. Moreover, the determination basis calculation section 2116 calculates a determination basis for a recognition result at that time.

In a subsequent period of the divisions of the corresponding frame cycle, the recognition processing section 104 reads pixels according to a pattern Rd#m_2 selecting pixels different from the pixels of the pattern Rd#m_1 in the frame Fr(m) and executes the recognition process. Moreover, the determination basis calculation section 2116 calculates a determination basis for a recognition result until that time.

In a subsequent (m+1)th frame Fr(m+1), the recognition processing section 104 similarly reads pixels according to a pattern Rd#(m+1)_1 including a plurality of pixels discretely and non-cyclically arranged within the frame Fr(m+1) and executes the recognition process in an initial period of the divisions of the frame cycle of the frame Fr(m+1). Moreover, the determination basis calculation section 2116 calculates a determination basis for a recognition result until that time.

The recognition processing section 104 further reads pixels according to a pattern Rd#(m+1)_2 selecting pixels different from the pixels of the pattern Rd#(m+1)_1 and executes the recognition process in a further subsequent period. Moreover, the determination basis calculation section 2116 calculates a determination basis for a recognition result until that time.

The readout determination section 2114 included in the recognition processing section 104 selects a predetermined number of pixels from all pixels included in a frame Fr(m) on the basis of a pseudorandom number to determine the pattern Rd#m_1 as the readout unit in an initial period of the divisions of the frame cycle of the frame Fr(m), for example. The readout determination section 2114 selects a predetermined number of pixels from all pixels that are included in the frame Fr(m) and are other than the pixels selected for the pattern Rd#m_1, on the basis of a pseudorandom number to determine the pattern Rd#m_2 as the readout unit in a subsequent period, for example. Alternatively, the recognition processing section 104 may select a predetermined number of pixels again from all the pixels included in the frame Fr(m) on the basis of a pseudorandom number to determine the pattern Rd#m_2 as the readout unit.

The readout determination section 2114 gives the readout control section 2102 readout region information which includes information indicating the pattern Rd#m_x determined as the readout unit and readout position information added for readout of pixel data from the pattern Rd#m_x. The readout control section 2102 gives the readout region information given from the readout determination section 2114, to the readout section 2101. The readout section 2101 reads pixel data from the sensor section 102 according to the readout region information given from the readout control section 2102.

For example, it is possible herein that the information indicating the readout unit includes position information associated with respective pixels included in the corresponding pattern Rd#m_1 and located within the frame Fr(m) (e.g., information indicating a line number and pixel positions within the line). Moreover, the target of the readout unit in this case is the entire frame Fr(m). Accordingly, the readout position information need not be used. Information indicating a position of a predetermined pixel within the frame Fr(m) is available as the readout position information.

As described above, the fifth modification performs the frame readout process by using the pattern Rd#m_x including a plurality of pixels discretely and non-cyclically arranged, in all the pixels in the frame Fr(m). Accordingly, a sampling artifact can be reduced in comparison with a case using a cyclic pattern. For example, according to the frame readout process of the fifth modification, erroneous detection or non-detection for a time-cyclic pattern (e.g., flicker) in the recognition process can be reduced. Moreover, according to this frame readout process, erroneous detection or non-detection for a spatial cyclic pattern (e.g., fence, network structure) in the recognition process can also be reduced.

In addition, according to this frame readout process, pixel data available for the recognition process increases with time. In this case, recognition response speed for a large-sized object within the frame Fr(m) is allowed to increase, for example. Accordingly, a frame rate can be raised. Further, a time period required until presentation of a determination basis for a recognition result can be reduced according to the increase in the recognition response speed.

While the recognition processing section 104 generates the respective patterns Rd#m_x for each time in the example described above, a pattern generation method is not limited to this example. For example, the respective patterns Rd#m_x may be generated beforehand and stored in a memory or the like, and the readout determination section 2114 may read the stored respective patterns Rd#m_x from the memory and use the read patterns Rd#m_x.

### E-2-6. Modification (6)

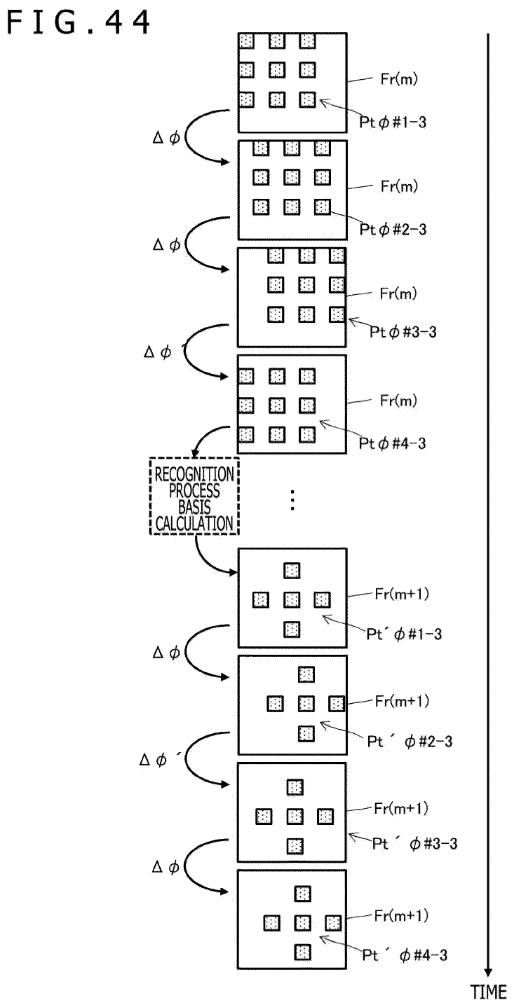

A sixth modification will be subsequently described. The sixth modification changes a configuration of a readout unit according to a result of the recognition process. FIG. 44 graphically illustrates a frame readout process according to the sixth modification. Described herein will be an example of a readout unit based on the patterns each including a plurality of pixels including not adjoining pixels, as explained with reference to FIG. 38.

In FIG. 44, as with the pattern Pφ#x-y depicted in FIG. 38, the readout determination section 2114 generates a pattern Pt#x-y including a plurality of pixels discretely and cyclically arranged in each of the line direction and the vertical direction in an m-th frame Fr(m), and designates the generated pattern Pt#x-y as an initial readout unit. The readout determination section 2114 gives the readout control section 2102 readout region information which includes information indicating the pattern Pt#x-y determined as a readout unit and readout position information added for readout from the pattern Pt#x-y. The readout control section 2102 gives the readout region information given from the readout determination section 2114, to the readout section 2101. The readout section 2101 reads pixel data from the sensor section 10 according to the readout region information given from the readout control section 2102.

As depicted in FIG. 44, the recognition processing section 104 achieves readout and also the recognition process and determination basis calculation for patterns Pt#1-1, Pt#2-1, and Pt#3-1 in the frame Fr(m) while shifting the position by a phase Δφ in the horizontal direction from the left end. When the right end of the pattern Pt#x-y reaches the right end of the frame Fr(m), the recognition processing section 104 shifts the position by a phase Δφ′ in the vertical direction, and again achieves readout and also the recognition process and recognition error determination for patterns Pt#1-2 and others from the right end of the frame Fr(m) while shifting the position by the phase Act) in the horizontal direction.

The recognition processing section 104 generates a new pattern Pt′#x-y according to a recognition result obtained for the frame Fr(m). For example, suppose that the recognition processing section 104 has recognized a target object (e.g., human) in a central portion of the frame Fr(m) in the recognition process for the frame Fr(m). The readout determination section 2114 included in the recognition processing section 104 generates as a new readout unit the pattern Pt′#x-y for intensively reading pixels located in the central portion of the frame Fr(m), according to this recognition result.

The readout determination section 2114 can generate a pattern Pt′#x-1 by using a smaller number of pixels than the number of pixels of the pattern Pt#x-y. Moreover, the readout determination section 2114 can more densely arrange the pixels of the pattern Pt′#x-y than the pixel arrangement of the pattern Pt#x-y.

The readout determination section 2114 gives the readout control section 2102 readout region information which includes information indicating the pattern Pt′#x-y determined as a readout unit and readout position information added for readout from the pattern Pt′#x-y. The readout determination section 2114 herein applies the corresponding pattern Pt′#x-y to a subsequent frame Fr(m+1). The readout control section 2102 gives the readout region information given from the readout determination section 2114, to the readout section 2101. The readout section 2101 reads pixel data from the sensor section 102 according to the readout region information given from the readout control section 2102.

According to the example depicted in FIG. 44, the recognition processing section 104 initially achieves readout and also the recognition process and the determination basis calculation process for the frame Fr(m+1) according to a pattern Pt′#1-1 for the central portion of the frame Fr(m+1), subsequently shifts the position by the phase Act), for example, in the horizontal direction, and achieves readout and also the recognition process and the determination basis calculation process based on a pattern Pt′#2-1. Moreover, the recognition processing section 104 shifts the position by the phase Δφ′ in the vertical direction from the position of the pattern Pt′#1-1, and further reads patterns Pt′#1-2 and Pt′#2-2 while shifting the position by the phase Δφ in the horizontal direction.

In the manner described above, the sixth modification generates the pattern Pt′#x-y used for readout of pixels in the subsequent frame Fr(m+1), according to a recognition result obtained in the frame Fr(m) on the basis of the pattern Pt#x-y as the initial pattern. Accordingly, the recognition process can be more accurately performed. Moreover, the recognition process using the new pattern Pt′#x-y generated according to the result of the recognition process is executed while focusing on a portion where an object is recognized. Accordingly, reduction of a processing volume of the recognition processing section 104, power saving, improvement of a frame rate, and others are achievable. Further, real-time presentation of a determination basis calculated for the recognition result is realizable.

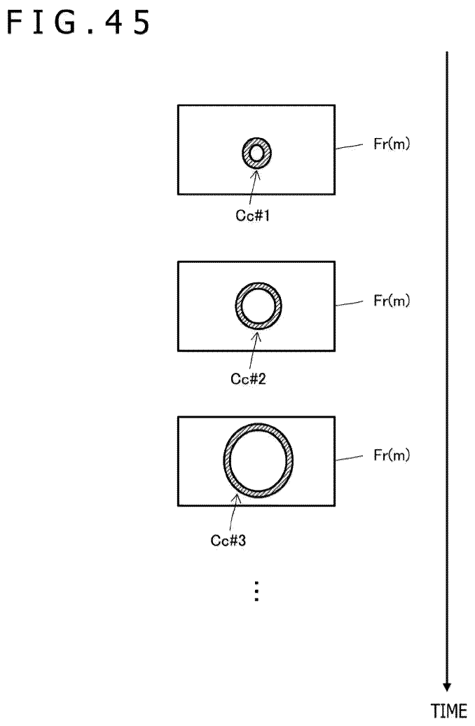

Another example of the sixth modification will be described herein. FIG. 45 graphically illustrates a frame readout process according to another example of the sixth modification. A pattern Cc#x in FIG. 45 is a readout unit that has an annular shape and changes a radius of the annular shape with an elapse of time.

According to the example depicted in FIG. 45, frame readout is achieved by a pattern Cc#1 having a small radius in an initial period of divisions of a frame cycle of a frame Fr(m). Frame readout is achieved by a pattern Cc#2 having a larger radius than the pattern Cc#1 in a subsequent period. Frame readout is achieved by a pattern Cc#3 having a larger radius than the pattern Cc#2 in a further subsequent period.

For example, as depicted in FIG. 44 referred to above, the recognition processing section 104 achieves readout and also the recognition process and the determination basis calculation process in the frame Fr(m) in an order of the patterns Pt#1-1, Pt#2-1, and Pt#3-1 while shifting the position by the phase Δφ in the horizontal direction from the left end. Thereafter, when the right end of the pattern Pt#x-y reaches the right end of the frame Fr(m), the recognition processing section 104 again shifts the position by the phase Δφ′ in the vertical direction, and achieves readout and also the recognition process and the determination basis calculation process in an order of patterns Pt#1-2 and others from the right end of the frame Fr(m) while shifting the position by the phase Δφ in the horizontal direction.

The recognition processing section 104 herein generates the new pattern Cc#1 having an annular shape, according to a recognition result or a determination basis obtained for the frame Fr(m). For example, suppose that the recognition processing section 104 has recognized a target object (e.g., human) in a central portion of the frame Fr(m) and calculated a determination basis for this recognition in the recognition process for the frame Fr(m). The readout determination section 2114 included in the recognition processing section 104 generates patterns Cc#1, Cc#2, and others depicted in FIG. 45 according to the recognition result or the determination basis, and achieves readout and also the recognition process and the determination basis calculation process on the basis of the generated patterns Cc#1, Cc#2, and others.

While the radius of the pattern Cc#m is increased with an elapse of time in FIG. 45, the method for generating the readout pattern having the annular shape is not limited to this example. The radius of the pattern Cc#m may be decreased with an elapse of time.

As a further example of the sixth modification, density of pixels in the pattern to be read may be changed. Moreover, while the size is changed from the center of the annular shape toward the outer circumference or from the outer circumference toward the center in the pattern Cc#m depicted in FIG. 45, the method for generating the readout pattern having an annular shape is not limited to this example.

### E-2-7. Modification (7)

A seventh modification will be subsequently described. According to the embodiment of the present disclosure and the first to fourth modifications, the line, the area, and the pattern from which pixels are read are shifted in an order of coordinates within a frame (e.g., a line number, an order of pixels within a line). According to the seventh modification, however, the line, the area, and the pattern from which pixels are read are set such that pixels within a frame can be more uniformly read in a short time.

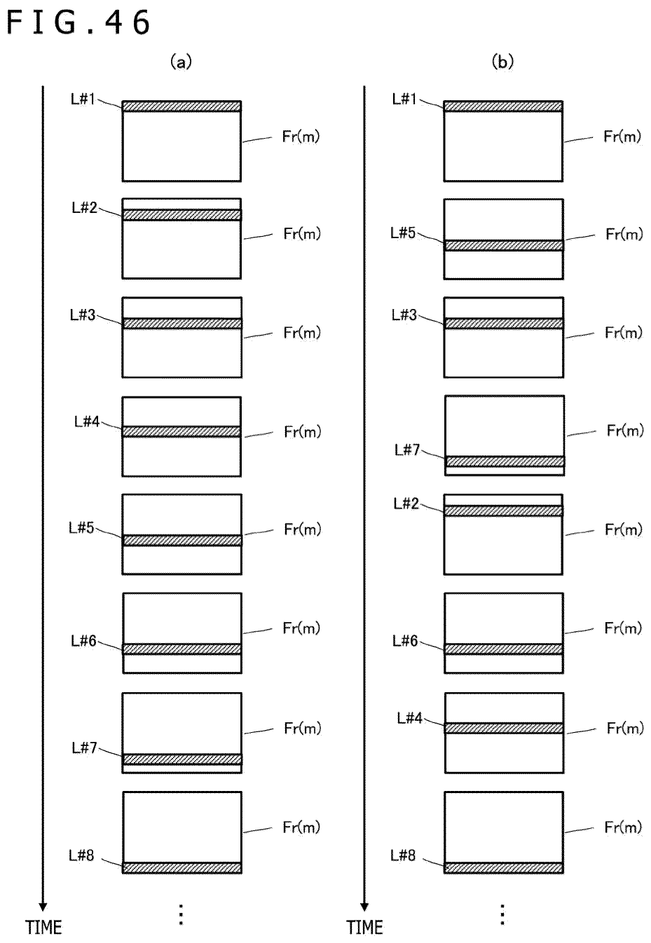

FIG. 46 graphically illustrates a first example of the frame readout process according to the seventh modification. Note that a frame Fr(m) in FIG. 46 is assumed to include eight lines of L#1, L#2, L#3, L#4, L#5, L#6, L#7, and L#8 for convenience of explanation.

A readout process depicted in (a) of FIG. 46 achieves readout of pixel data for each line in an order of the lines L#1, L#2, and up to L#8 for the frame Fr(m) while designating a line as a readout unit in correspondence with the readout process depicted in FIG. 24. According to the example depicted in (a) of FIG. 46, a long delay is produced from a start of readout from the frame Fr(m) until acquisition of pixel data from a lower part of the frame Fr(m).

On the other hand, (b) of FIG. 46 depicts an example of the readout process according to the first example of the seventh modification. As with (a) of FIG. 46 referred to above, a line is designated as a readout unit in the example depicted in (b) of FIG. 46. In this case, two lines located at a distance of a half of the number of lines of the frame Fr(m) from each other are paired for each of lines having odd line numbers and lines having even line numbers in the frame Fr(m). In addition, the pairs of the odd line numbers in the respective pairs are sequentially read out, and then the pairs of the even line numbers are sequentially read out.

Specifically, in the example depicted in (b) of FIG. 46, for example, the lines L#1, L#3, L#5, and L#7 each having the odd line number in the respective lines L#x included in the frame Fr(m) are read in a switched order, i.e., in an order of the lines L#1, L#5, L#3, and L#7, in a first half of the frame cycle. Moreover, the lines L#2, L#4, L#6, and L#8 each having the even line number in the respective lines L#x included in the frame Fr(m) are similarly read in a switched order, i.e., in an order of the lines L#2, L#6, L#4, and L#8, in a second half of the frame cycle. Such a manner of control of the reading order of the respective lines L#x is achievable by sequential setting of the readout position information with use of the readout determination section 2114.

By determining the readout order of the respective lines in the frame as depicted in (b) of FIG. 46, the delay from the start of readout from the frame Fr(m) until acquisition of the pixel data from the lower part of the frame Fr(m) can be reduced in comparison with the example depicted in (a) of FIG. 46. Moreover, in the seventh modification, recognition response speed for a large-sized object within a frame is allowed to increase. Accordingly, a frame rate can be raised. Further, a time period required until presentation of a determination basis for a recognition result can be reduced according to the increase in the recognition response speed.

Note that the readout order of the respective lines L#x depicted in (b) of FIG. 46 is presented by way of example. The readout region can be defined in such a manner as to facilitate recognition of an assumed object. For example, the readout determination section 2114 is capable of defining a region given priority of execution of the recognition process within the frame, on the basis of external information received from the outside of the imaging device 100, and determining the readout position information such that readout from this readout region can be preferentially executed. Moreover, the readout determination section 2114 is also capable of defining a region given priority of execution of the recognition process within the frame, according to a scene to be imaged in the frame.

Further, as with the embodiment of the present disclosure described above, readout of the lines and the recognition process can be ended in a case where a valid recognition result is obtained in the middle of the readout of the respective lines for the frame in the first example of the seventh modification. In this manner, speed-up and power saving can be achieved by reduction of a processing volume of the recognition process. In addition, a time period required for the recognition process and a time period required for presenting a determination basis can be shortened.

Subsequently, a second example of the seventh modification will be described. While one line is designated as a readout unit in the first example of the seventh modification described above, the readout unit is not limited to this example. According to the second example of the seventh modification, two lines not adjacent to each other are designated as a readout unit.

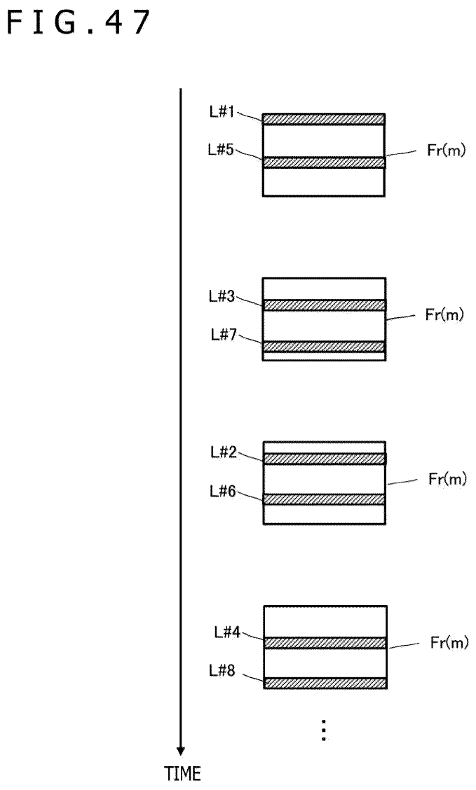

FIG. 47 graphically illustrates a frame readout process according to the second example of the seventh modification. According to the example depicted in FIG. 47, two lines located at a distance of a half of the number of lines from each other are paired for each of lines having odd line numbers and lines having even line numbers in the frame Fr(m) as explained with reference to (b) of FIG. 46, and are designated as a readout unit. Specifically, each of a pair of lines L#1 and L#5, a pair of lines L#3 and L#7, a pair of lines L#2 and L#6, and a pair of lines L#4 and L#8 is designated as a readout unit. In addition, the pairs of the odd line numbers in the respective pairs are sequentially read out, and then the pairs of the even line numbers are sequentially read out.

According to the second example of the seventh modification, the readout unit has two lines. Accordingly, a time period required for the recognition process and a time period required for presenting a determination basis can be reduced in comparison with the seventh modification described above.

Subsequently, a third example of the seventh modification will be subsequently described. The third example defines a readout region from which a readout unit is read in such a manner as to achieve more uniform readout of pixels within a frame in a short time, in a case where the readout unit of the third modification (see FIG. 34) of the embodiment of the present disclosure is set to an area having a predetermined size within a frame.

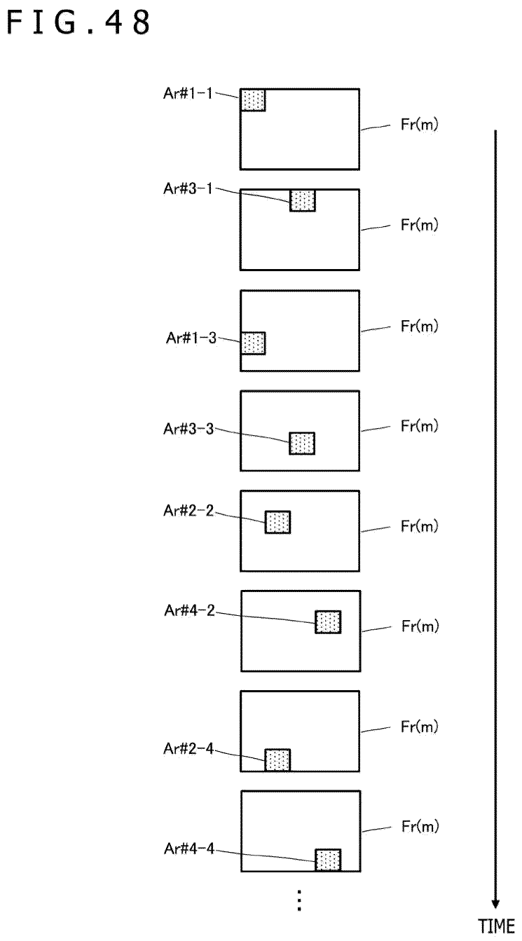

FIG. 48 graphically illustrates a frame readout process according to the third example of the seventh modification. According to the example depicted in FIG. 48, positions of the respective areas Ar#x-y depicted in FIG. 34 are discretely designated in a frame Fr(m) to achieve readout for the frame Fr(m). For example, after completion of readout and also the recognition process and the determination basis calculation process from an area Ar#1-1 located at an upper left corner of the frame Fr(m), readout and also the recognition process and the determination basis calculation process are achieved for an area Ar#3-1 that includes the same line as the line of the area Ar#1-1 in the frame Fr(m) and is located at a central portion of the frame Fr(m) in the line direction. Subsequently, readout and also the recognition process and the determination basis calculation process are achieved for an area Ar#1-3 located at an upper left corner of a region of a lower half of the frame Fr(m), and then readout and also the recognition process and the determination basis calculation process are achieved for an area Ar#3-3 that includes the same line as the line of the area Ar#1-3 in the frame Fr(m) and is located at a central portion of the frame Fr(m) in the line direction. Readout and also the recognition process and the determination basis calculation process are similarly achieved for areas Ar#2-2 and Ar#4-2, and areas Ar#2-4 and Ar#4-4.

By determining the readout order in this manner, a delay of readout of the frame Fr(m) from the start of readout from the left end of the frame Fr(m) until acquisition of pixel data from the lower part and the right end of the frame Fr(m) can be reduced in comparison with the example depicted in FIG. 34. Moreover, in the third example, recognition response speed for a large-sized object within a frame is allowed to increase. Accordingly, a frame rate can be raised. Further, a time period required until presentation of a determination basis for a recognition result can be reduced according to the increase in the recognition response speed.

Further, as with the embodiment of the present disclosure described above, readout and also the recognition process and the determination basis calculation process from the respective areas Ar#x-y can be ended in a case where a valid recognition result is obtained in the middle of the readout of the areas Ar#x-y for the frame in the third example. In this manner, speed-up and power saving can be achieved by reduction of a processing volume of the recognition process. In addition, a time period required for the recognition process and a time period required for presenting a determination basis can be shortened.

Subsequently, a fourth example of the seventh modification will be subsequently described. The fourth example defines a readout region from which a readout unit is read in such a manner as to achieve more uniform readout of pixels within a frame in a short time, in an example where the readout unit of the fourth modification (see FIG. 38) of the embodiment of the present disclosure is set to a pattern including a plurality of pixels discretely and cyclically arranged in each of the line direction and the vertical direction.

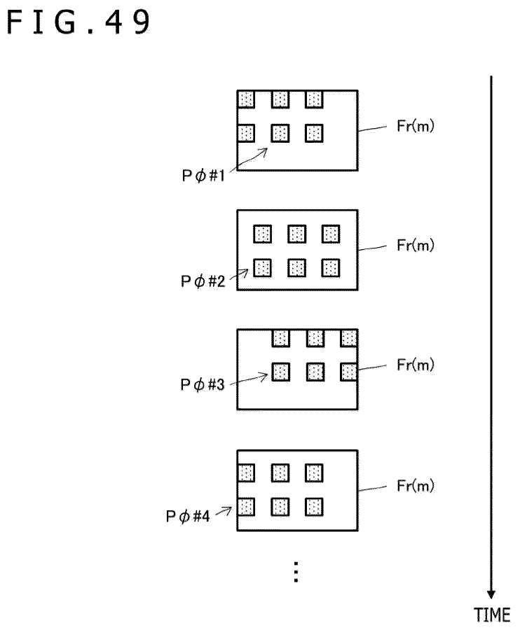

FIG. 49 graphically illustrates a frame readout process according to the fourth example of the seventh modification of the second embodiment. According to the example depicted in FIG. 49, a pattern Pp z has a configuration equivalent to the configuration of the pattern Pφ#x-y depicted in FIG. 38, and a position of the pattern Pφ#z is discretely designated in a frame Fr(m) to achieve readout of the frame Fr(m).

For example, the recognition processing section 104 achieves readout and also the recognition process and the determination basis calculation process for a pattern Pφ#1 located at an upper left corner of the frame Fr(m) while designating this upper left corner as a start position. Subsequently, readout and also the recognition process and the determination basis calculation process are achieved for a pattern Pφ#2 located at a position shifted by a half distance of each interval of pixels in the pattern Pφ#1 in each of the line direction and the vertical direction. Thereafter, readout and also the recognition process and the determination basis calculation process are achieved for a pattern Pφ#3 located at a position shifted by a half distance of each interval in the line direction from the position of the pattern Pφ#1, and then readout and also the recognition process and the determination basis calculation process are achieved for a pattern Pφ#4 located at a position shifted by a half distance of each interval in the vertical direction from the position of the pattern Pφ#1. The readout, the recognition process, and the determination basis calculation process of the patterns Pφ#1 to Pφ#4 described above are repeatedly executed while shifting the position of the pattern Pφ#1 one pixel by one pixel in the line direction, for example, and further repeatedly executed while shifting the pattern Pφ#1 one pixel by one pixel in the vertical direction.

By determining the readout order in this manner, a delay of readout of the frame Fr(m) from the start of readout from the left end of the frame Fr(m) until acquisition of pixel data from the lower part and the right end of the frame Fr(m) can be reduced in comparison with the example depicted in FIG. 38. Moreover, in the fourth example, recognition response speed for a large-sized object within a frame is allowed to increase. Accordingly, a frame rate can be raised. Further, a time period required until presentation of a determination basis for a recognition result can be reduced according to the increase in the recognition response speed.

Further, as with the embodiment of the present disclosure described above, readout and the recognition process for the respective patterns Pφ#z can be ended and the determination basis calculation process can be started in a case where a valid recognition result is obtained in the middle of the readout of the patterns Pφ#z for the frame in the fourth example. Accordingly, speed-up and power saving can be achieved by reduction of a processing volume of the recognition process, and also a time period required for the recognition process and presentation of a determination basis can be reduced.

### E-2-8. Modification (8)

An eighth modification will be subsequently described. The eighth modification of the embodiment of the present disclosure determines a readout region to be read next, on the basis of a feature value generated by the feature value accumulation control section 2112.

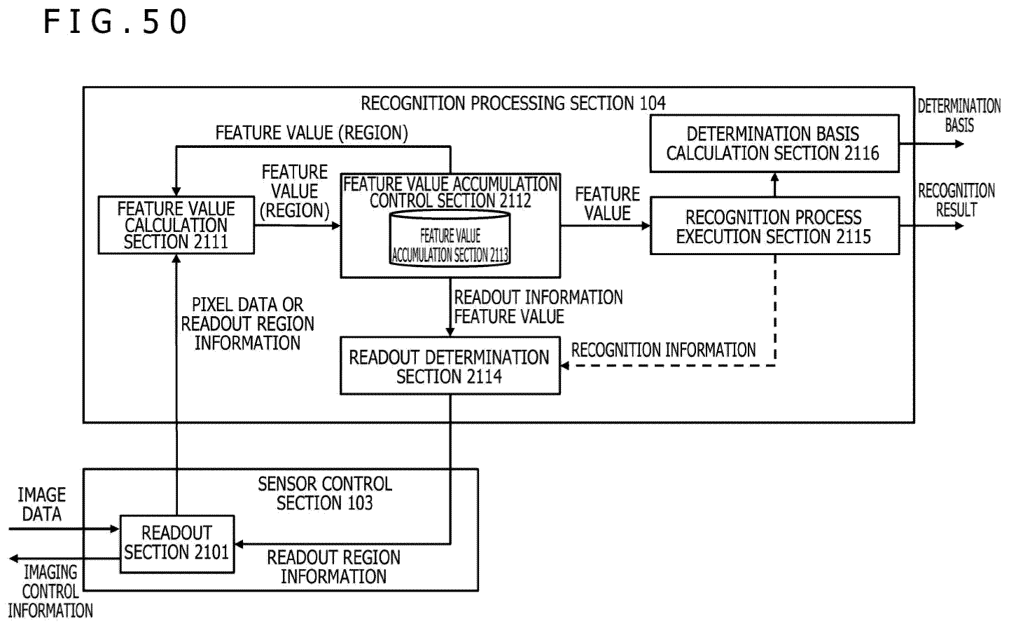

FIG. 50 depicts a functional configuration example of the recognition processing section 104 according to the eighth modification. The feature value accumulation control section 2112 integrates a feature value given from the feature value calculation section 2111 and a feature value accumulated in the feature value accumulation section 2113 and gives the integrated feature value to the readout determination section 2114 together with readout information. The readout determination section 2114 generates readout region information on the basis of the feature value and the readout information given from the feature value accumulation control section 2112. The readout determination section 2114 gives the generated readout region information to the readout section 2101 included in the sensor control section 103.

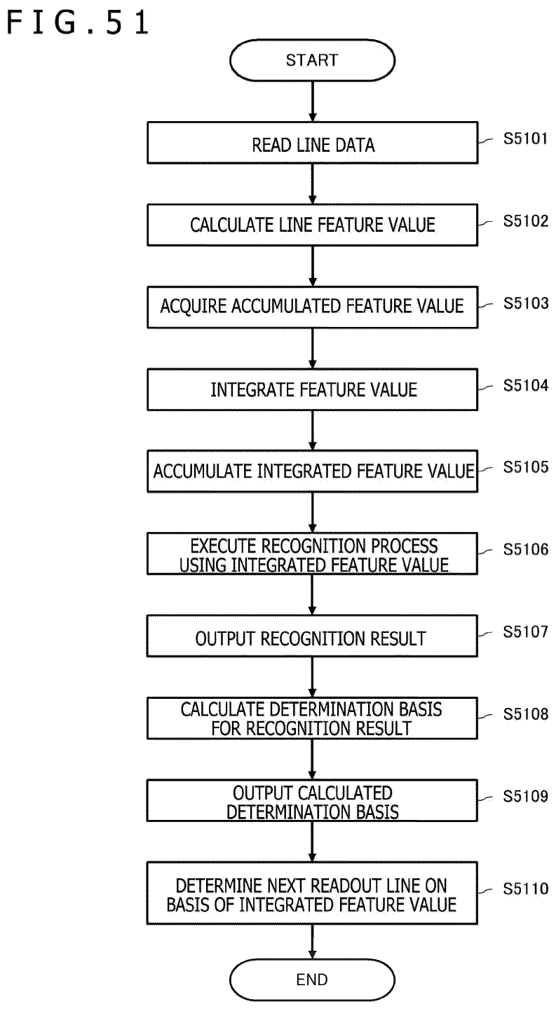

FIG. 51 illustrates procedures, in a form of a flowchart, associated with recognition and a determination basis calculation process corresponding to readout of pixel data of a readout unit on the basis of a feature value of an image according to the eighth modification. The processing procedures depicted in the figure represent a process corresponding to readout of pixel data for each readout unit (e.g., one line) from a frame, for example. Note that described with reference to FIG. 51 will be procedures of recognition and a determination basis calculation process in a case where a line is designated as the readout unit. For example, readout region information can be expressed by a line number indicating a line to be read.

Initially, the recognition processing section 104 reads line data from a line indicated by a readout line of a frame (step S5101). Specifically, the readout determination section 2114 gives a line number of a line to be read next, to the sensor control section 103. On the basis of the given line number, the readout section 2101 of the sensor control section 103 reads pixel data of the line indicated by the line number from the sensor section 102 as line data. The readout section 2101 gives the line data read from the sensor section 102, to the feature value calculation section 2111. Moreover, the readout section 2101 gives readout region information (e.g., line number) indicating a region from which the pixel data has been read, to the feature value calculation section 2111.

Subsequently, the feature value calculation section 2111 calculates a feature value of an image on the basis of the line data given from the readout section 2101 (step S5102). Moreover, the feature value calculation section 2111 acquires a feature value accumulated in the feature value accumulation section 2113 from the feature value accumulation control section 2112 (step S5103) and integrates the feature value calculated in step S5102 with the feature value acquired from the feature value accumulation control section 2112 in step S5103 (step S5104). The integrated feature value is given to the feature value accumulation control section 2112. The feature value accumulation control section 2112 accumulates the integrated feature value in the feature value accumulation section 2113 (step S5105).

Note that a series of processes in steps S5101 to S5104 are processes corresponding to a head line of the frame. In addition, in a case where the feature value accumulation section 2113 has been initialized, for example, the processes in steps S5103 and S5104 can be skipped. Moreover, the process in step S5105 in this case is a process for accumulating the line feature value calculated on the basis of this head line in the feature value accumulation section 2113.

The feature value accumulation control section 2112 also gives the feature value given from the feature value calculation section 2111, to the recognition process execution section 2115. The recognition process execution section 2115 executes a recognition process on the basis of the integrated feature value given from the feature value accumulation control section 2112 (step S5106). The recognition process execution section 2115 outputs a recognition result obtained by the recognition process to the output control section 107 (step S5107).

The recognition process execution section 2115 also gives the recognition result obtained by the recognition process to the determination basis calculation section 2116. The determination basis calculation section 2116 calculates a determination basis for the recognition result given from the recognition process execution section 2115 (step S5108). The determination basis calculation section 2116 estimates a place contributing to the recognition result in the line data on the basis of the feature value of the line data calculated in step S5102, with use of a Grad-Cam algorithm, for example, or estimates a place contributing to the recognition result in an image within a range previously read, on the basis of the feature value integrated in step S5104. Thereafter, the determination basis calculation section 2116 outputs the calculated determination basis to the output control section 107 (step S5109).

Thereafter, the readout determination section 2114 included in the recognition processing section 104 determines a readout line to be read next, according to the integrated feature value and the readout information given from the feature value accumulation control section 2112 (step S5110). For example, when receiving the integrated feature value and the readout region information from the feature value calculation section 2111, the feature value accumulation control section 2112 determines a readout line to be read next, according to a readout pattern corresponding to the integrated feature value (a line unit in this example). The processes in step S5101 and the following steps are again executed for the readout line determined in step S5110.

### (First Process)

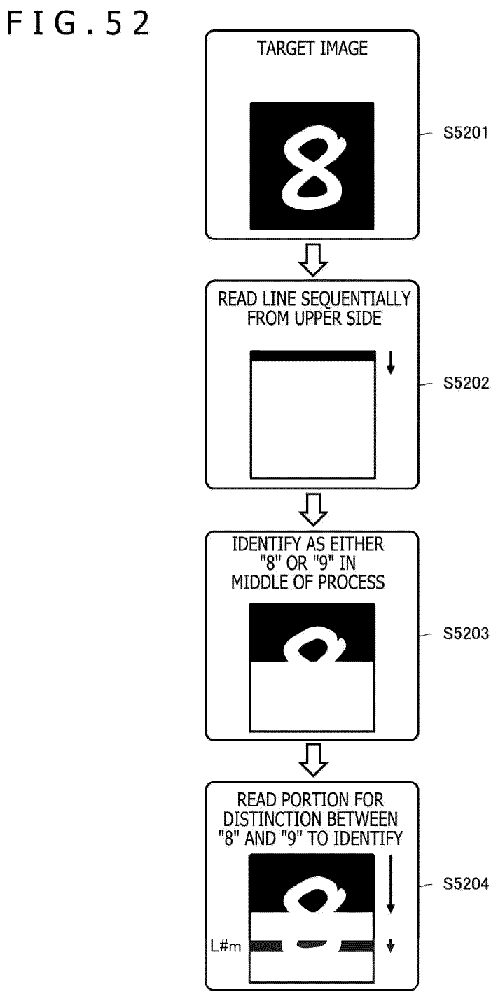

Subsequently, a first process of the eighth modification will be described with reference to FIG. 52. FIG. 52 graphically illustrates a first processing procedure according to the eighth modification. It is assumed herein that a line is designated as a readout unit, and that the rolling shutter system is adopted for imaging. It is further assumed that a learning model trained on the basis of predetermined learning data so as to perform an image recognition process such as identification of a numeral is stored as a program in the memory 105 beforehand, and that the recognition processing section 104 reads the program from the memory 105 and executes the program to identify a numeral.

Initially, the imaging device 100 starts capturing of a target image (handwritten numeral “8”) corresponding to a recognition target (step S5201).

At the start of imaging, the sensor control section 103 sequentially reads a frame for each line unit from an upper end to a lower end of the frame according to readout region information given from the recognition processing section 104 (step S5202).

When readout of lines is completed up to a certain position, the recognition processing section 104 identifies a numeral “8” or “9” on the basis of an image corresponding to the read lines (step S5203). The readout determination section 2114 included in the recognition processing section 104 generates, on the basis of an integrated feature value given from the feature value accumulation control section 2112, readout region information designating a line L#m predicted as a line on the basis of which the object identified in step S5203 is identifiable as the numeral “8” or “9,” and gives the generated readout region information to the readout section 2101. Subsequently, the recognition processing section 104 executes the recognition process and the determination basis calculation process on the basis of pixel data read by the readout section 2101 from the corresponding line L#m (step S5204).

In a case where the object is confirmed in step S5204, the recognition processing section 104 further calculates a determination basis on the basis of a Grad-CAM algorithm or the like, and thereafter is allowed to end the recognition process. In this manner, speed-up and power saving are achievable by reduction of a processing volume of the recognition process performed by the imaging device 100. Moreover, real-time presentation of a determination basis is realizable.

### (Second Process)

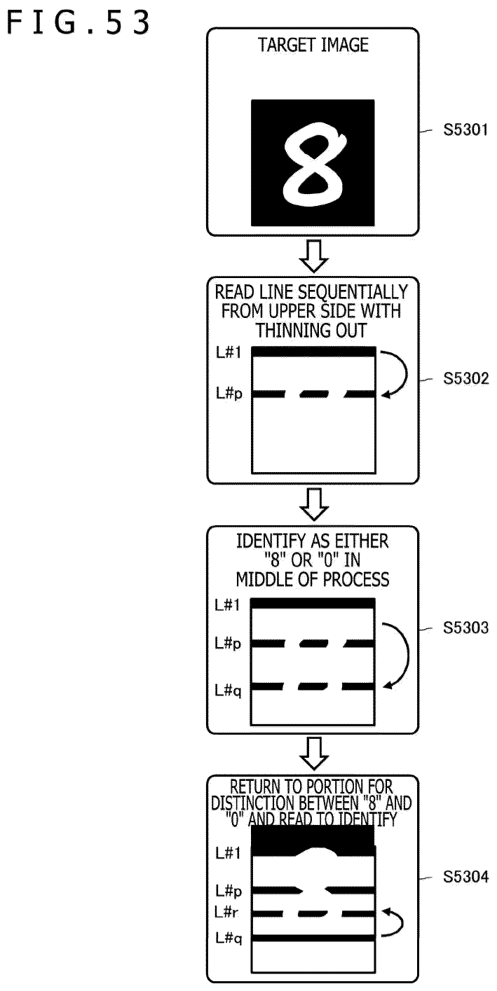

Subsequently, a second process of the eighth modification will be described. FIG. 53 graphically illustrates the second process according to the eighth modification. As with the first process, it is assumed that a program of a learning model trained so as to perform identification of a numeral is stored in the memory 105 beforehand, and that the recognition processing section 104 reads the program from the memory 105 and executes the program to enable identification of a numeral. The second process depicted in FIG. 53 designates a handwritten numeral “8” as a target image as with the foregoing process depicted in FIG. 52. However, readout from a frame for each line is executed while thinning out lines according to a feature value of an image.

Initially, the imaging device 100 starts capturing of a target image (handwritten numeral “8”) corresponding to a recognition target (step S5301).

At the start of imaging, the sensor control section 103 reads a frame for each line unit from an upper end to a lower end of the frame while thinning out lines according to readout region information given from the recognition processing section 104 (step S5302). According to the example depicted in FIG. 53, the sensor control section 103 initially reads a line L#1 located at the upper end of the frame according to the readout region information and then reads a line L#p with thinning out by a predetermined number of lines. The recognition processing section 104 executes the recognition process and the determination basis calculation process for each readout for respective pieces of line data of the lines L#1 and L#p.

Thereafter, it is assumed that a numeral “8” or “0” are recognized as a result of readout for each line performed with thinning out, and the recognition process executed by the recognition processing section 104 for line data read from a line L#q (step S5303).

The readout determination section 2114 herein generates, on the basis of an integrated feature value given from the feature value accumulation control section 2112, readout region information for designating a line L#r predicted as a line on the basis of which the object identified in step S5303 is identifiable as the numeral “8” or “0,” and gives the generated readout region information to the readout section 2101. The position of the line L#r at this time may be either on the upper end side or the lower end side of the frame with respect to the line L#q.

The recognition processing section 104 executes the recognition process and the determination basis calculation process on the basis of pixel data read by the readout section 2101 from the corresponding line L#r (step S5304).

The second process presented in FIG. 53 by way of example achieves line readout from a frame while thinning out lines according to a feature value of an input image. Accordingly, further time reduction and power saving of the recognition process are achievable, and also real-time presentation of a determination basis is realizable.

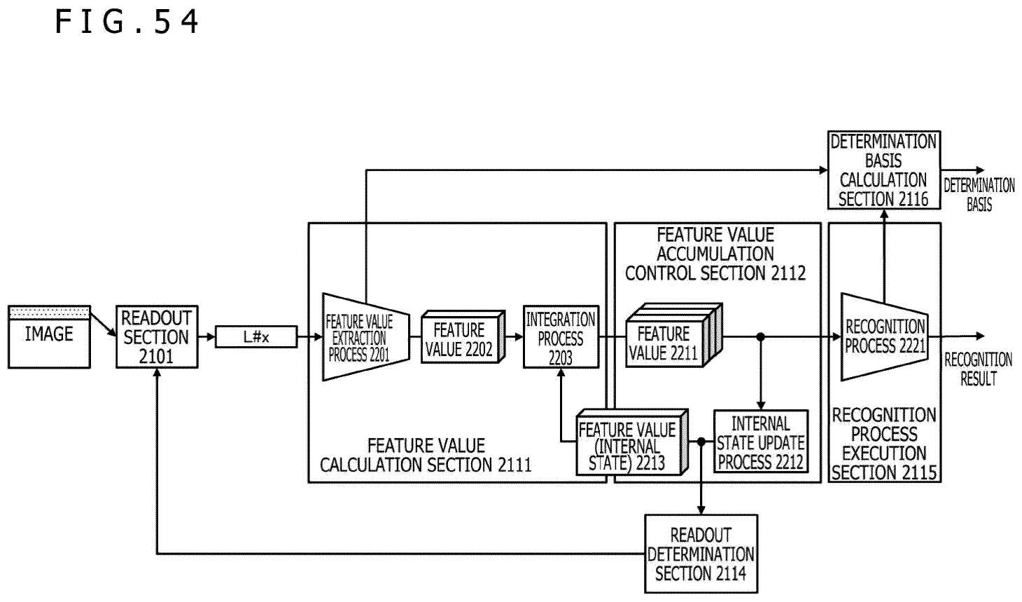

FIG. 54 depicts more details of a processing example performed by the recognition processing section 104 according to the eighth modification. This figure includes the readout determination section 2114 in addition to the configuration depicted in FIG. 22 referred to above. The feature value 2213 associated with an internal state and updated by the internal state update process 2212 is input to the readout determination section 2114.

The readout determination section 2114 generates readout region information indicating a readout region to be read next (e.g., line number), on the basis of the input feature value 2213 associated with the internal state, and outputs the generated readout region information to the readout section 2101. The readout determination section 2114 executes a program of a learning model trained beforehand, to determine a next readout region. The learning model is trained using learning data based on assumed readout patterns or an assumed recognition target, for example.

While the imaging device 100 according to the embodiment of the present disclosure and the first to eighth modifications of the embodiment described above performs the recognition process with use of the recognition processing section 104 for each readout of a readout unit, the present disclosure is not limited to these examples. For example, the recognition process to be performed may be switched between the recognition process for each readout unit and an ordinary recognition process (a recognition process based on pixel data of pixels read from an entire frame by readout from the entire frame). Specifically, the ordinary recognition process executed on the basis of the pixels in the entire frame is capable of obtaining a more accurate recognition result, while the recognition process performed for each readout unit is capable of achieving a high-speed and power-saving recognition process and real-time presentation of a determination basis.

For example, high recognition accuracy may be secured by starting the ordinary recognition process at regular time intervals while performing the recognition process for each readout unit. Moreover, stability of recognition may be enhanced by starting the ordinary recognition process at a time of occurrence of a predetermined event, such as at a time of emergency, while performing the recognition process for each readout unit.

Note that switching from the recognition process for each readout unit to the ordinary recognition process may cause such a problem that the ordinary recognition process lowers immediate reportability achievable by the recognition process for each readout unit. Accordingly, the ordinary recognition process may switch a mode of an operation clock of a device (a processor that executes the recognition process (the program of the learning model trained)) to a higher-speed mode.

Moreover, the recognition process performed for each readout unit causes a problem of low reliability. Accordingly, when reliability of the recognition process for each readout unit lowers, or when a determination basis presented for a recognition result is not understandable, the recognition process for each readout unit may be switched to the ordinary recognition process. Thereafter, the recognition process may be returned to the recognition process for each readout unit when high reliability of the recognition process is recovered.

### F. SECOND EMBODIMENT

A second embodiment of the present disclosure will be subsequently described. The second embodiment adaptively sets parameters, such as a readout unit, a readout order within a frame for each readout unit, and a readout region, at the time of frame readout.

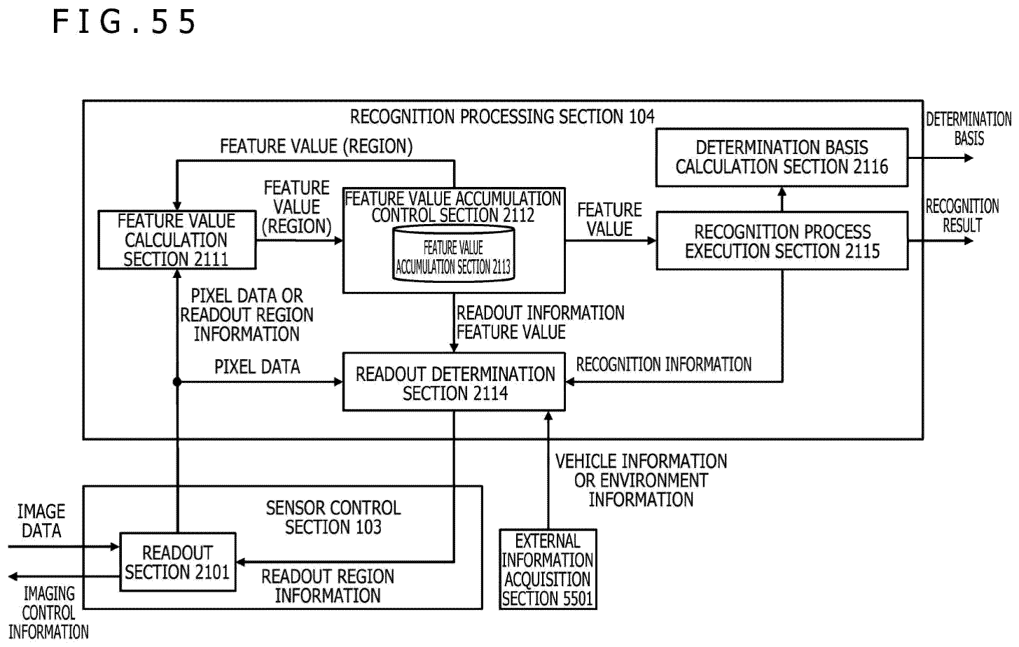

FIG. 55 depicts a functional configuration example of the recognition processing section 104 according to the second embodiment. The recognition processing section 104 in the figure additionally includes an external information acquisition section 5501. Moreover, the readout determination section 2114 receives pixel data from the readout section 2101, and recognition information from the recognition process execution section 2115.

The external information acquisition section 5501 acquires external information created outside the imaging device 100 and gives the acquired external information to the readout determination section 2114. For example, the external information acquisition section 5501 includes an interface which transmits and receives signals in a predetermined format. In a case where the imaging device 100 is an in-vehicle device, for example, the external information may include vehicle information and ambient environment information. For example, the vehicle information is steering information or speed information. In addition, for example, the environment information is information associated with surrounding brightness. In the following description, it is assumed that the imaging device 100 is used as an in-vehicle device and that the external information is vehicle information acquired from a vehicle carrying the imaging device 100 unless specified otherwise.

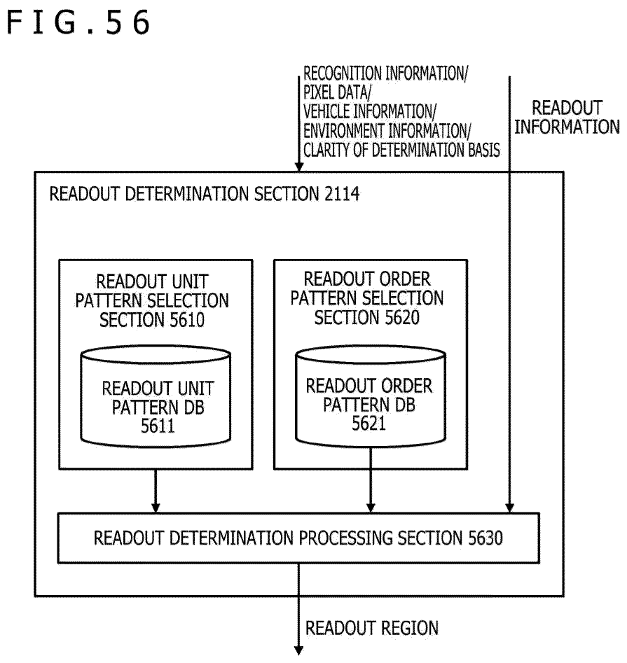

FIG. 56 depicts a detailed functional configuration example of the readout determination section 2114 according to the second embodiment. The readout determination section 2114 in this figure includes a readout unit pattern selection section 5610, a readout order pattern selection section 5620, and a readout determination processing section 5630. The readout unit pattern selection section 5610 includes a readout unit pattern DB (database) 5611 where a plurality of different readout patterns is stored beforehand. Meanwhile, the readout order pattern selection section 5620 includes a readout order pattern DB 5621 where a plurality of different readout order patterns is stored beforehand.

The readout determination section 2114 sets priority for each of the respective readout unit patterns stored in the readout unit pattern DB 5611 and the respective readout order patterns stored in the readout order pattern DB 5621, on the basis of at least one of items of information associated with given recognition information, pixel data, vehicle information and environment information, and clarity of a determination basis.

The readout unit pattern selection section 5610 selects a readout unit pattern for which the highest priority has been set, in the respective readout unit patterns stored in the readout unit pattern DB 5611. The readout unit pattern selection section 5610 gives the readout unit pattern selected from the readout unit pattern DB 5611 to the readout determination processing section 5630. Similarly, the readout order pattern selection section 5620 selects the readout order pattern for which the highest priority has been set, in the respective readout order patterns stored in the readout order pattern DB 5621. The readout order pattern selection section 5620 gives the readout order pattern selected from the readout order pattern DB 5621 to the readout determination processing section 5630.

The readout determination processing section 5630 determines a readout region to be read next from a frame, on the basis of the readout information given from the feature value accumulation control section 121, the readout unit pattern given from the readout unit pattern selection section 5610, and the readout order pattern given from the readout order pattern selection section 5620, and gives readout region information indicating the determined readout region to the readout section 2101.

Subsequently described will be a method performed by the readout determination section 2114 depicted in FIG. 56 for setting a readout unit pattern and a readout order pattern.

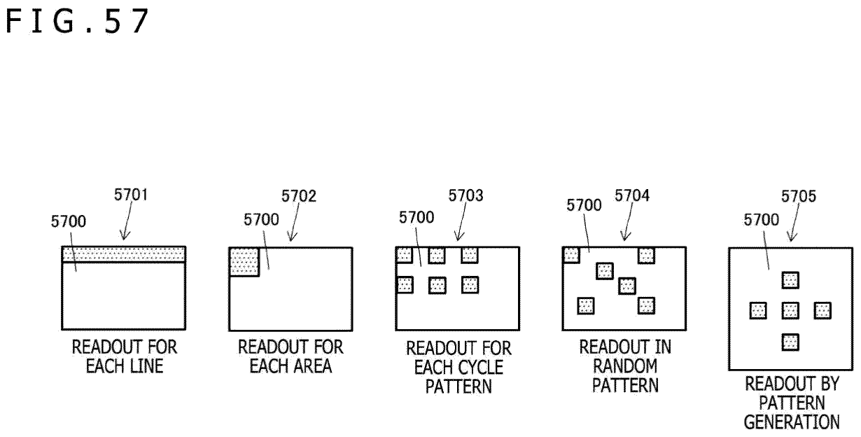

FIG. 57 depicts an example of readout unit patterns applicable to the second embodiment. The example depicted in the figure includes five readout unit patterns, i.e., readout unit patterns 5701, 5702, 5703, 5704, and 5705. The respective readout unit patterns 5701 to 5705 are stored beforehand in the readout unit pattern DB 5611 depicted in FIG. 56.

The readout unit pattern 5701 is a readout unit pattern which designates a line as a readout unit and achieves readout for each line in a frame 5700. The readout unit pattern 5702 is a readout pattern which designates an area having a predetermined size as a readout unit in the frame 5700 and achieves readout for each area in the frame 5700.

The readout unit pattern 5703 is a readout unit pattern which designates as a readout unit a pixel set including a plurality of pixels which includes pixels not adjacent to each other and are cyclically arranged, and achieves readout for each set of the plurality of pixels in the frame 5700. The readout unit pattern 5704 is a readout unit pattern which designates as a readout unit a plurality of pixels (random pattern) discretely and non-cyclically arranged and achieves readout while updating the random pattern in the frame 5700. Each of the readout unit patterns 5703 and 5704 described above achieves more uniform sampling of pixels from the frame 5700.

In addition, the readout unit pattern 5705 is a readout unit pattern configured to adaptively generate a pattern on the basis of recognition information.

Note that the readout unit applicable as the readout unit pattern according to the second embodiment is not limited to the examples depicted in FIG. 57. For example, each of the readout units described in the first embodiment and the respective modifications of the first embodiment is applicable as the readout unit pattern according to the second embodiment.

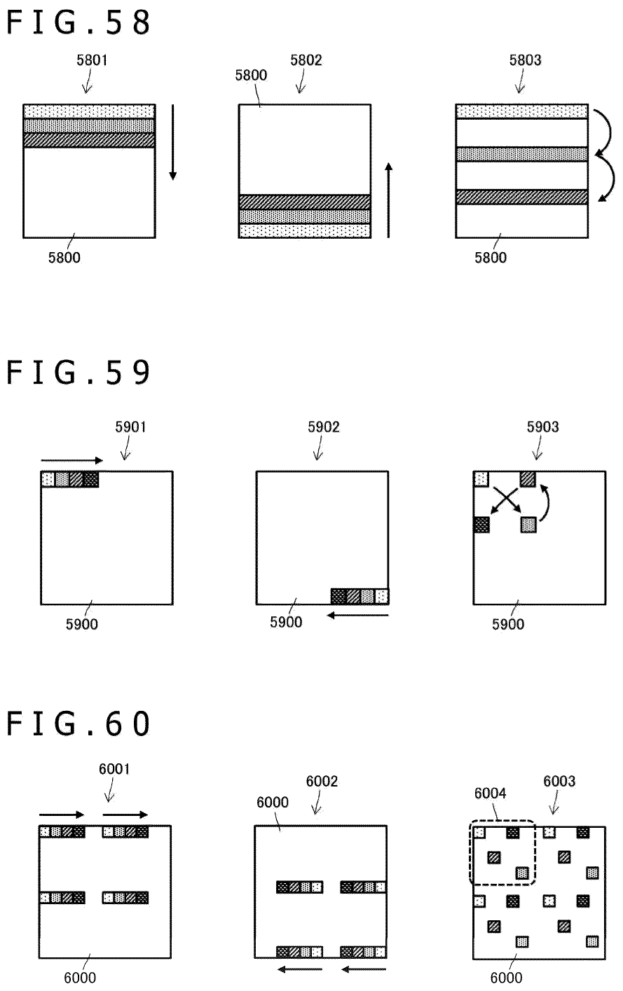

Each of FIGS. 58 to 60 depicts an example of readout order patterns applicable to the second embodiment. FIG. 58 depicts an example of a readout order pattern in a case where a line is designated as the readout unit. FIG. 59 depicts an example of a readout order pattern in a case where an area is designated as the readout unit. FIG. 60 depicts an example of a readout order pattern in a case where a pixel set described above is designated as the readout unit. Readout order patterns 5801, 5901, and 6001 in left parts of FIGS. 58 to 60, respectively, each represent an example of a readout order pattern for sequentially achieving readout in an order of lines or pixels.

The readout order pattern 5801 in FIG. 58 is an example which achieves readout in a line sequential order from an upper end to a lower end of a frame 5800. Each of the readout order pattern 5901 in FIG. 59 and the readout order pattern 6001 in FIG. 60 is an example which sequentially achieves readout from an upper left corner of a frame 5900 or 6000 in a line direction for each area or pixel set and repeats this line-directional readout in the vertical direction of the frame 5900 or 6000. Each of the readout order patterns 5801, 5901, and 6001 will be referred to as a forward readout order pattern.

On the other hand, a readout order pattern 5802 in FIG. 58 is an example which achieves readout in a line sequential order from the lower end to the upper end of the frame 5800. Each of readout order patterns 5902 and 6002 in FIGS. 59 and 60 is an example which sequentially achieves readout from a lower right corner of the frame 5900 or 6000 in the line direction for each area or pixel set and repeats this line-directional readout in the vertical direction of the frame 5700. Each of the readout order patterns 5802, 5902, and 6002 will be referred to as a backward readout order pattern.

Further, a readout order pattern 5803 in FIG. 58 is an example which achieves readout from the upper end to the lower end of the frame 5800 while thinning out lines. Each of readout order patterns 5903 and 6003 in FIGS. 59 and 60 is an example which achieves readout of an area at a discrete position and readout order within the frame 5900 or 6000. For example, the readout order pattern 5903 achieves readout of respective pixels in an order indicated by arrows in the figure in a case where the readout unit includes four pixels. For example, the readout order pattern 6003 achieves readout of respective pixels as a pattern reference in an order different from the order of the pixel positions in the line direction and the column direction while shifting the pixels to discrete positions, as in an area indicated by a reference number 6004 in FIG. 60.

The respective readout order patterns 5801 to 5803, the readout order patterns 5901 to 5903, and the readout order patterns 6001 to 6003 described with reference to FIGS. 58 to 60 are stored beforehand in the readout order pattern DB 5621 depicted in FIG. 56.

### Readout Unit Pattern Setting Method:

An example of a method for setting a readout unit pattern according to the second embodiment will be specifically described with reference to FIGS. 57 to 60.

Initially described will be a method for setting a readout unit pattern on the basis of image information (pixel data). The readout determination section 2114 detects noise contained in pixel data given from the readout section 2101. Note herein that noise immunity is higher when a plurality of pixels is collectively arranged than when independent pixels are discretely arranged. Accordingly, the readout determination section 2114 sets higher priority for the readout unit pattern 5701 or 5702 than for the other readout unit patterns in the respective readout unit patterns 5701 to 5705 stored in the readout unit pattern DB 5611, in a case where a predetermined level or higher noise is contained in the pixel data given from the readout section 2101.

Subsequently described will be a method for setting a readout unit pattern on the basis of recognition information. A first setting method is applied in a case where a large number of objects each having a predetermined size or larger are recognized in the frame 5700 on the basis of recognition information given from the recognition process execution section 2115. In this case, the readout determination section 2114 sets higher priority for the readout unit pattern 5703 or 5704 than for the other readout unit patterns in the respective readout unit patterns 5701 to 5705 stored in the readout unit pattern DB 5611. This priority is set because immediate reportability is more enhanced by uniform sampling from the entire frame 5700.

A second setting method is applied in a case where a flicker is detected in an image captured on the basis of pixel data, for example. In this case, the readout determination section 2114 sets higher priority for the readout unit pattern 5704 than for the other readout unit patterns in the respective readout unit patterns 5701 to 5705 stored in the readout unit pattern DB 5611. This priority is set because an artifact produced by the flicker can be reduced by sampling from the entire frame 5700 on the basis of a random pattern for the flicker.

A third setting method is applied in a case where a readout unit configuration considered to more efficiently execute the recognition process is generated in a situation where a readout unit configuration is adaptively changed on the basis of recognition information. In this case, the readout determination section 2114 sets higher priority for the readout unit pattern 5705 than for the other readout unit patterns in the respective readout unit patterns 5701 to 5705 stored in the readout unit pattern DB 5611.

Subsequently described will be a method for setting a readout unit pattern on the basis of external information acquired by the external information acquisition section 5501. A first setting method is applied in a case where the vehicle carrying the imaging device 1 turns to either the left or the right on the basis of external information. In this case, the readout determination section 2114 sets higher priority for the readout unit pattern 5701 or 5702 than for the other readout unit patterns in the respective readout unit patterns 5701 to 5705 stored in the readout unit pattern DB 5611.

Note herein that the readout determination section 2114 in the first setting method selects the column direction as the readout unit from the row and column directions of the pixel array section 601 and sets execution of column-sequential readout in the line direction of the frame 5700 for the readout unit pattern 5701. Moreover, the readout determination section 2114 sets execution of area readout in the column direction and repeats this readout in the line direction for the readout unit pattern 5702.

In a case where the vehicle turns to the left, the readout determination section 2114 sets column-sequential readout or area readout in the column direction for the readout determination processing section 5630 such that readout starts from the left end of the frame 5700. On the other hand, in a case where the vehicle turns to the right, the readout determination section 2114 sets column-sequential readout or area readout in the column direction for the readout determination processing section 5630 such that the readout starts from the right end of the frame 5700.

In addition, in a case where the vehicle carrying the imaging device 100 is running straight, the readout determination section 2114 may set ordinary readout for each line unit or area readout in the line direction. In a case where the vehicle turns to the left or the right, a feature value accumulated in the feature value accumulation section 2113 may be initialized, and the readout process may be restarted by performing readout for each column or area readout in the column direction as described above, for example.

A second setting method for setting a readout unit pattern based on external information is applied in a case where the vehicle carrying the imaging device 100 is travelling on a highway, for example. In this case, the readout determination section 2114 sets higher priority for the readout unit pattern 5701 or 5702 than for the other readout unit patterns in the respective readout unit patterns 5701 to 5705 stored in the readout unit pattern DB 5611. In the case of highway traveling, it is considered to be important to achieve recognition of an object constituted by a far small body. Accordingly, sequential readout from the upper end of the frame 5700 is carried out to further raise immediate reportability to an object constituted by a far small body.

### Readout Order Pattern Setting Method:

An example of a method for setting a readout order pattern according to the second embodiment will be specifically described with reference to FIGS. 57 to 60.

Initially described will be a method for setting a readout order pattern on the basis of image information (pixel data). The readout determination section 2114 detects noise contained in pixel data given from the readout section 2101. Note herein that a noise effect on the recognition process decreases as a change of a region corresponding to a target of the recognition process is smaller. Reduction of the noise effect contributes to facilitation of the recognition process. Accordingly, the readout determination section 2114 sets higher priority for any of the readout order patterns 5801, 5901, and 6001 than for the other readout order patterns in the respective readout order patterns 5801 to 5803, 5901 to 5903, and 6001 to 6003 stored in the readout order pattern DB 5621 in a case where a predetermined level or higher noise is contained in the pixel data given from the readout section 2101. Alternatively, the readout determination section 2114 may set higher priority for any of the readout order patterns 5802, 5902, and 6002 than for the other readout order patterns.

Note that which of the readout order patterns 5801, 5901, and 6001, and the readout order patterns 5802, 5902, and 6002 is given higher priority may be determined on the basis of which of the readout unit patterns 5701 to 5705 is given higher priority by the readout unit pattern selection section 5610, and from which of the upper end and the lower end of the frame 5700 readout is performed, for example.

Subsequently described will be a method for setting a readout order pattern on the basis of recognition information. The readout determination section 2114 sets higher priority for any of the readout order patterns 5803, 5903, and 6003 than for the other readout order patterns in the respective readout order patterns 5801 to 5803, 5901 to 5903, and 6001 to 6003 stored in the readout order pattern DB 5621, on the basis of recognition information given from the recognition process execution section 2115, in a case where a large number of objects each having a predetermined size or larger are recognized in the frame 5700. This priority is set because immediate reportability more improves by uniform sampling than sequential readout from the entire frames 5800, 5900, and 6000.

Subsequently described will be a method for setting a readout order pattern on the basis of external information. A first setting method is an example in a case where the vehicle carrying the imaging device 1 turns to either the left or the right on the basis of external information. In this case, the readout determination section 2114 sets higher priority for any of the readout order patterns 5801, 5901, and 6001 than for the other readout unit patterns in the respective readout order patterns 5801 to 5803, 5901 to 5903, and 6001 to 6003 stored in the readout order pattern DB 5621.

Note herein that the readout determination section 2114 in the first setting method selects the column direction as the readout unit from the row and column directions of the pixel array section 601 and sets execution of column-sequential readout in the line direction of the frame 5700 for the readout order pattern 5801. Moreover, the readout determination section 2114 sets execution of area readout in the column direction and repeats this readout in the line direction for the readout order pattern 5901. Further, the readout determination section 2114 sets execution of pixel set readout in the column direction and repeats this readout in the line direction for the readout order pattern 6001.

In a case where the vehicle turns to the left, the readout determination section 2114 sets column-sequential readout or area readout in the column direction for the readout determination processing section 5630 such that readout starts from the left end of the frame 5700. On the other hand, in a case where the vehicle turns to the right, the readout determination section 2114 sets column-sequential readout or area readout in the column direction for the readout determination processing section 5630 such that the readout starts from the right end of the frame 5700.

In addition, in a case where the vehicle is running straight, the readout determination section 2114 may set ordinary line unit readout or area readout in the line direction. In a case where the vehicle turns to the left or the right, a feature value accumulated in the feature value accumulation section 2113 may be initialized, and the readout process may be restarted by column-sequential readout or area readout in the column direction as described above, for example.

A second setting method for setting readout order pattern based on external information is applied on the basis of external information in a case where the vehicle carrying the imaging device 1 is travelling on a highway. In this case, the readout determination section 2114 sets higher priority for any of the readout order patterns 5801, 5901, and 6001 than for the other readout order patterns in the respective readout order patterns 5801 to 5803, 5901 to 5903, and 6001 to 6003 stored in the readout order pattern DB 5621. In the case where the vehicle is traveling on a highway, it is considered to be important to achieve recognition of an object constituted by a far small body. Accordingly, sequential readout from the upper ends of the respective frames 5800, 5900, and 6000 is carried out to further raise immediate reportability to an object constituted by a far small body.

Note herein that a conflict may be caused between different readout unit patterns or between different readout order patterns in a case where priorities for the readout unit patterns or the readout order patterns are set on the basis of a plurality of different items of information (image information, recognition information, external information) as described above. For avoiding this conflict, different priorities may be designated beforehand as the priorities set on the basis of the respective items of information, for example.

### F-1. First Modification of Second Embodiment

A first modification of the second embodiment will be subsequently described. The first modification of the second embodiment adaptively sets a readout region in the case of frame readout. The first modification of the second embodiment is practiced using the recognition processing section 104 depicted in FIG. 55.

A method for adaptively setting a readout region according to the first modification of the second embodiment will be described. Note that the following description will be presented on an assumption that the imaging device 100 is provided as an in-vehicle device.

### F-1-1. Example of Setting Readout Region on Basis of Recognition Information

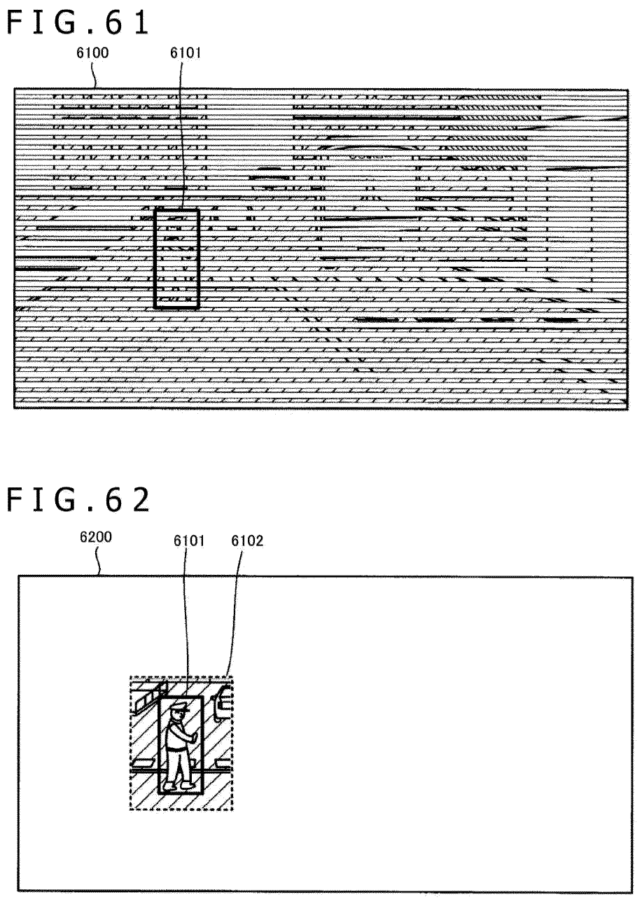

Initially described will be a first setting method for adaptively setting a readout region on the basis of recognition information. In the first setting method, the readout determination section 2114 adaptively sets a region within a frame on the basis of a region or a class detected in the recognition process performed by the recognition process execution section 2115, to limit a readout region to be read next. This first setting method will be described with reference to FIGS. 61 and 62.

In FIG. 61, line readout designating a line as a readout unit is performed for a frame 6100 in a line sequential order and with thinning-out of lines. According to the example depicted in FIG. 61, the recognition process execution section 2115 executes the recognition process for the entire frame 6100 on the basis of pixel data read by line readout. As a result, the recognition process execution section 2115 detects a particular object (a person in the example depicted in FIG. 61) from a region 6101 within the frame 6100. The recognition process execution section 2115 gives recognition information indicating this recognition result to the readout determination section 2114.

The readout determination section 2114 determines a readout region to be read next, on the basis of the recognition information given from the recognition process execution section 2115. For example, the readout determination section 2114 determines a region containing the recognized region 6101 and a peripheral portion around the region 6101, as the readout region to be read next. The readout determination section 2114 gives readout region information indicating the readout region constituted by a region 6102 to the readout section 2101.

The readout section 2101 achieves frame readout without thinning-out of lines, for example, according to the readout region information given from the readout determination section 2114, and gives read pixel data to the recognition processing section 104. FIG. 62 depicts an example of an image read according to the readout region. According to the example depicted in FIG. 62, pixel data of the region 6102 indicated by the readout region information is acquired from a frame 6200 which is a frame next to the frame 6100, for example, while the outside of the region 6102 is ignored. The recognition process execution section 2115 included in the recognition processing section 104 performs the recognition process for the region 6102. As a result, the recognition process execution section 2115 recognizes the person detected from the region 6101 as a pedestrian. 2116 calculates a basis for recognition as the pedestrian for the region 6102.

Further, the first determination method described above may limit the readout region to be read next, according to a recognized object type. For example, when the object recognized in the frame 6100 is a traffic light, the readout determination section 2114 may limit the readout region to be read in the next frame 6200 to a lamp portion of the traffic light. Moreover, when the object recognized in the frame 6100 is a traffic light, the readout determination section 2114 may change the frame readout method to such a readout method which reduces a flicker effect, and achieve readout from the next frame 6200. For example, the pattern Rd#m_x according to the fifth modification of the second embodiment described above is applicable to the readout method for reducing the flicker effect.

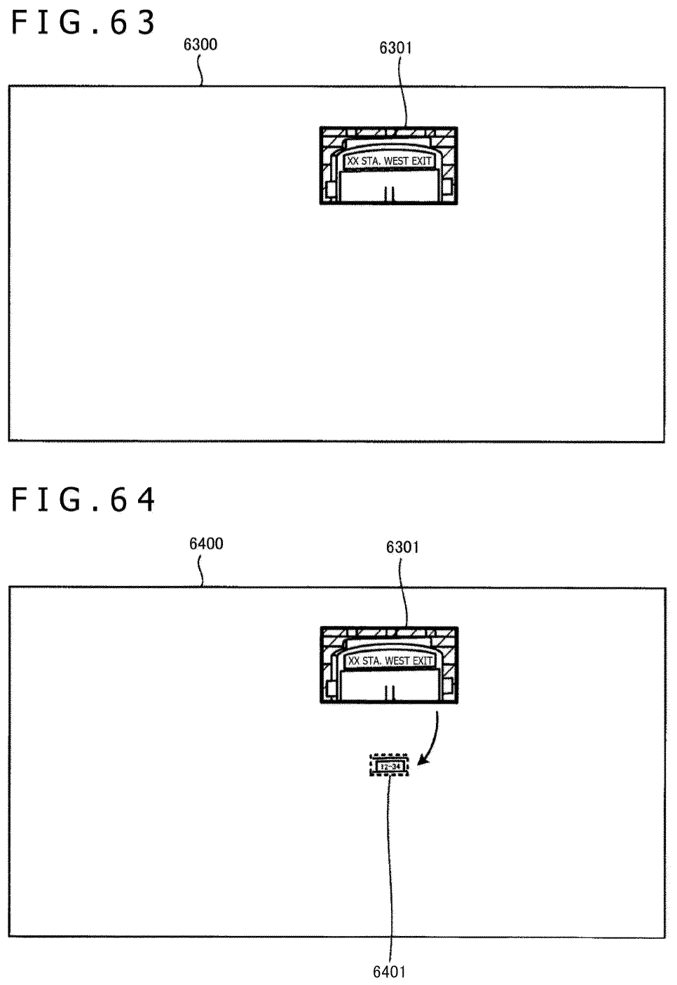

Subsequently described will be a second setting method for adaptively setting a readout region on the basis of recognition information. In the second setting method, the readout determination section 2114 limits a readout region to be read next, on the basis of recognition information obtained in the middle of the recognition process performed by the recognition process execution section 2115. This second setting method will be specifically described with reference to FIGS. 63 and 64.

It is assumed that a recognition target object in the example depicted in FIGS. 63 and 64 is a registration plate of a vehicle. FIG. 63 depicts an example where an object indicating a bus vehicle is recognized in a region 6301 in the middle of the recognition process performed in correspondence with frame readout for the frame 6300. Specifically, the readout section 2101 reads the region 6301, and the recognition process execution section 2115 is allowed to perform the recognition process limited to the region 6301.

In a case where the object recognized herein is a bus vehicle in the region 6301 in the middle of the recognition process performed by the recognition process execution section 2115, a position of a registration plate of this bus vehicle can be predicted on the basis of details recognized in the region 6301. The readout determination section 2114 determines a readout region to be read next, on the basis of the predicted position of the registration plate, and gives readout region information indicating the determined readout region to the readout section 2101.

The readout section 2101 achieves readout from a frame 6400 next to the frame 6300, for example, according to the readout region information given from the readout determination section 2114, and gives read pixel data to the recognition processing section 104. FIG. 64 depicts an example of an image read according to the readout region. According to the example depicted in FIG. 64, pixel data of a region 6401 that includes the predicted position of the registration plate and is indicated by the readout region information is acquired from the frame 6400. The recognition process execution section 2115 included in the recognition processing section 104 performs the recognition process for the region 6401. In this manner, the recognition process is performed for the registration plate corresponding to the object contained in the region 6401, to acquire a vehicle registration number of the bus vehicle detected by the recognition process performed for the region 6301, for example. 2116 calculates a basis for recognition as the vehicle registration number of the bus vehicle for the region 6401.

The second setting method determines the readout region of the next frame 6400 in the middle of the recognition process for the entire object as the target corresponding to readout performed by the recognition process execution section 2115 for the frame 6300. Accordingly, the recognition process can be executed accurately at higher speed.

Note that the readout determination section 2114 can determine the region 6401 as the readout region to be read next, and achieve readout depicted in FIG. 64 in a case where reliability indicated by recognition information given from the recognition process execution section 2115 in the middle of the recognition has a predetermined level or higher in the recognition process performed for the frame 6300 depicted in FIG. 63. In this case, the recognition process is executed for the entire object in the frame 6300 in a case where the reliability indicated by the recognition information is lower than the predetermined level. Moreover, the determination basis calculation section 2116 calculates a determination basis for the entire object in the frame 6300.

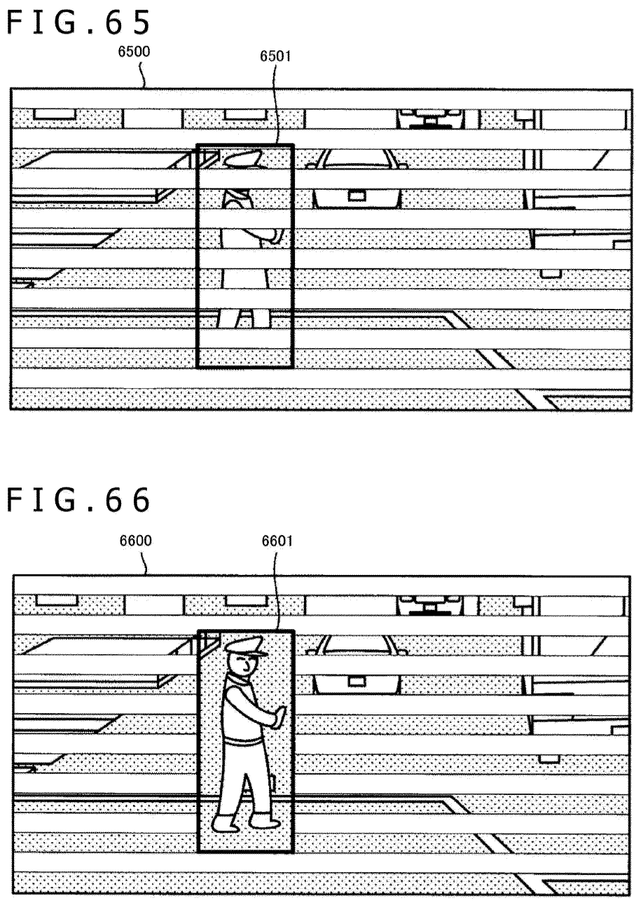

Subsequently described will be a third setting method for adaptively setting a readout region on the basis of recognition information. In the third setting method, the readout determination section 2114 limits a readout region to be read next, on the basis of reliability of the recognition process performed by the recognition process execution section 2115 or clarity of a calculated determination basis. This third setting method will be specifically described with reference to FIGS. 65 and 66.

In FIG. 65, line readout designating a line as a readout unit is performed for a frame 6500 in a line sequential order and with thinning-out of lines. According to the example depicted in FIG. 65, the recognition process execution section 2115 executes the recognition process based on pixel data read by line readout for the entire frame 6500 and detects a particular object (a person in this example) from a region 6501 within the frame 6500. The recognition process execution section 2115 gives recognition information indicating this recognition result to the readout determination section 2114.

When reliability indicated by the recognition information given from the recognition process execution section 2115 has a predetermined level or higher, the readout determination section 2114 generates readout region information indicating that readout for a frame next to the frame 6500 is not to be performed, for example. The readout determination section 2114 gives the generated readout region information to the readout section 2101.

On the other hand, in a case where reliability indicated by the recognition information given from the recognition process execution section 2115 is lower than the predetermined level, or where a basis for determination calculated by the determination basis calculation section 2116 is not clear, the readout determination section 2114 generates readout region information indicating that readout for a frame next to the frame 6500 is to be performed. For example, the readout determination section 2114 generates readout region information designating as a readout region a region corresponding to the region 6501 where the particular object (person) has been detected in the frame 6500. The readout determination section 2114 gives the generated readout region information to the readout section 2101.

The readout section 2101 achieves readout from the frame next to the frame 6500 according to the readout region information given from the readout determination section 2114. The readout determination section 2114 herein can add, to the readout region information, an instruction for readout from a region that is included in the frame next to the frame 6500 and corresponds to the region 6501, without thinning out. The readout section 2101 achieves readout from the frame next to the frame 6500 according to this readout region information and gives read pixel data to the recognition processing section 104.

FIG. 66 depicts an example of an image read according to this readout region information. For example, pixel data of a region 6601 that corresponds to the region 6501 and is indicated by readout region information is acquired from a frame 6600 which is a frame next to the frame 6500. For example, pixel data of the frame 6500 can be used without readout, for example, for a portion other than the region 6601 in the frame 6600. The recognition process execution section 2115 included in the recognition processing section 104 performs the recognition process for the region 6601. As a result, a person detected from the region 6101 can be recognized as a pedestrian with higher reliability. Moreover, the determination basis calculation section 2116 can calculate a basis for recognition as the pedestrian at high speed for the region 6601.

### F-1-2. Example of Setting Readout Region on Basis of External Information

Subsequently described will be a first setting method for adaptively setting a readout region on the basis of external information. In the first setting method, the readout determination section 2114 adaptively sets a region within a frame on the basis of vehicle information given from the external information acquisition section 5501 to limit a readout region to be read next. In this manner, the recognition process can be executed in a manner suitable for traveling of the vehicle.

For example, the readout determination section 2114 included in the readout determination section 2114 acquires inclination of the vehicle on the basis of vehicle information and determines a readout region according to the acquired inclination. For example, in a case where the readout determination section 2114 acquires information indicating such a state that the vehicle rides on a step or the like with the front side raised, on the basis of the vehicle information, the readout region is corrected toward the upper end of the frame. Moreover, in a case where the readout determination section 2114 acquires information indicating such a state that the vehicle is turning, on the basis of the vehicle information, a region not observed yet in the turning direction (e.g., a left end side region in a case of a left turn) is determined as the readout region.

Subsequently described will be a second setting method for adaptively setting a readout region on the basis of external information. The second setting method uses, as external information, map information where a current position is allowed to be sequentially reflected. According to this method, in a case where a current position is in an area requiring a caution of a traveling vehicle (e.g., an area around a school or a nursery school), the readout determination section 2114 generates readout region information issuing an instruction to increase a frame readout frequency, for example. In this manner, accidents caused by rush-out of children or the like are avoidable.

Subsequently described will be a third setting method for adaptively setting a readout region on the basis of external information. The third setting method uses detection information obtained by a different sensor as external information. For example, the different sensor may be a LiDAR (Laser Imaging Detection and Ranging) system sensor. The readout determination section 2114 generates readout region information for skipping readout from a region exhibiting a predetermined level or higher reliability of detection information obtained by the different sensor. In this manner, power saving and speed-up of frame readout and the recognition process are achievable.

### G. APPLICATION FIELD

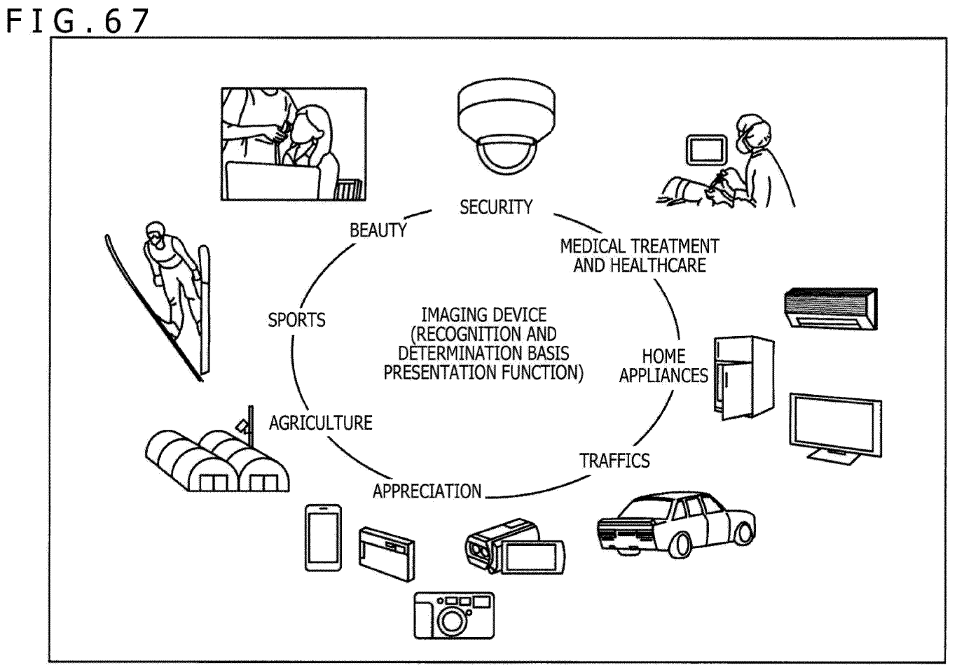

The present disclosure is applicable to the imaging device 100 which chiefly senses visible light, and is also applicable to a device which senses various types of light, such as infrared light, ultraviolet light, and X-rays. Accordingly, the technology according to the present disclosure is applicable to various fields to achieve speed-up and power saving of a recognition process, and real-time presentation of a determination basis for a recognition result. FIG. 67 summarizes fields to which the technology according to the present disclosure is applicable.

### (1) Appreciation:

A device that captures images used for purposes of appreciation, such as a digital camera and a portable device equipped with a camera function

### (2) Traffics:

A device for traffic purposes, such as an in-vehicle sensor for capturing images in front and rear, surroundings, an interior of a car and the like for purposes of safe driving including an automatic stop, recognition of a state of a driver, and the like, a monitoring camera for monitoring traveling vehicles and roads, and a distance measuring sensor for measuring distances between vehicles

### (3) Home Appliances:

A device provided for home appliances for capturing an image of a gesture of a user to achieve a device operation corresponding to this gesture, such as a TV set, a refrigerator, an air conditioner, and a robot

### (4) Medical Treatment and Healthcare:

A device for purposes of medical treatment and healthcare, such as an endoscope and a device for performing angiogram by receiving infrared light

### (5) Security:

A device for security purposes, such as a monitoring camera for crime prevention, and a camera for person authentication

### (6) Beauty:

A device for purposes of beauty, such as a skin measuring device for capturing images of skin, and a microscope for imaging a scalp

### (7) Sports:

A device for purposes of sports, such as an action camera for sports, and a wearable camera.

### (8) Agriculture:

A device for agricultural purposes, such as a camera for monitoring a state of fields and crops

### (9) Production, Manufacture, and Services:

A device for purposes of production, manufacture, and services, such as a camera or a robot for monitoring a state of production, manufacture, processing, service offering, or the like associated with products

### H. APPLICATION EXAMPLE

The technology according to the present disclosure is applicable to imaging devices mounted on various mobile bodies, such as cars, electric cars, hybrid electric cars, motorcycles, bicycles, personal mobilities, air planes, drones, vessels, and robots.

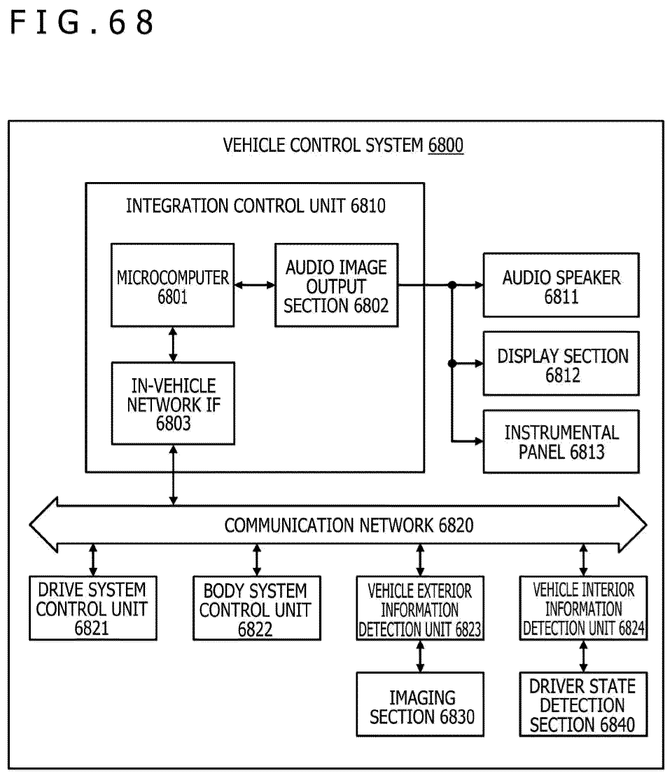

FIG. 68 depicts a schematic configuration example of a vehicle control system 6800 as one example of a mobile body control system to which the technology according to the present disclosure is applicable.

The vehicle control system 6800 includes multiple electronic control units connected to each other via a communication network 6820. According to the example depicted in FIG. 68, the vehicle control system 6800 includes a drive system control unit 6821, a body system control unit 6822, a vehicle exterior information detection unit 6823, a vehicle interior information detection unit 6824, and an integration control unit 6810. Moreover, a microcomputer 6801, an audio image output section 6802, and an in-vehicle network I/F (interface) 6803 are depicted as functional components of the integration control unit 6810.

The drive system control unit 6821 controls operations of devices associated with a drive system of a vehicle according to various programs. For example, the drive system of the vehicle includes a driving force generation device for generating a driving force of the vehicle, such as an internal combustion engine and a driving motor, a driving force transmission mechanism for transmitting a driving force to wheels, a steering mechanism which adjusts a steering angle of the vehicle, and a braking device which generates a braking force of the vehicle. The drive system control unit 6821 functions as a control device for these components.

The body system control unit 6822 controls operations of various devices provided on a vehicle body according to various programs. For example, a keyless entry system, a smart key system, and an automatic window device are provided on the vehicle body. Moreover, various types of lamps such as headlamps, back lamps, brake lamps, direction indicators, or fog lamps are provided on the vehicle body. In other words, the body system control unit 6822 functions as a control device for these devices provided on the vehicle body. In this case, radio waves transmitted from a portable device substituting for a key or signals from various switches may be input to the body system control unit 6822. The body system control unit 6822 receives input of these radio waves or signals, and controls a door locking device, the automatic window device, the lamps, and the like of the vehicle.

The vehicle exterior information detection unit 6823 detects information associated with an exterior of the vehicle carrying the vehicle control system 6800. For example, an imaging section 6830 is connected to the vehicle exterior information detection unit 6823. The vehicle exterior information detection unit 6823 causes the imaging section 6830 to capture an image of the exterior of the vehicle and receives the captured image. The vehicle exterior information detection unit 6823 may perform an object detection process for detecting a human, a car, an obstacle, a sign, a road marking, or the like or a distance detection process on the basis of the image received from the imaging section 6830. For example, the vehicle exterior information detection unit 6823 performs image processing for the received image to achieve the object detection process or the distance detection process on the basis of a result of the image processing.

The vehicle exterior information detection unit 6823 performs the object detection process according to a program of a learning model trained beforehand so as to achieve object detection in images. Moreover, the vehicle exterior information detection unit 6823 may further perform real-time calculation and presentation of a determination basis for an object detection result.

The imaging section 6830 is an optical sensor which receives light and outputs an electric signal corresponding to a light amount of the received light. The imaging section 6830 is capable of outputting the electric signal either as an image or as information associated with distance measurement. Moreover, the light received by the imaging section 6830 may be either visible light or non-visible light such as infrared light. It is assumed that the vehicle control system 6800 includes imaging sections that constitute the imaging section 6830 and are provided at several places on the vehicle body. The installation position of the imaging section 6830 will be described below.

The vehicle interior information detection unit 6824 detects information associated with the interior of the vehicle. For example, a driver state detection section 6840 which detects a state of the driver is connected to the vehicle interior information detection unit 6824. For example, the driver state detection section 6840 may include a camera for capturing an image of the driver such that the vehicle interior information detection unit 6824 can calculate a degree of fatigue or a degree of concentration of the driver or determine whether or not the driver is dozing, on the basis of detection information input from the driver state detection section 6840. Moreover, the driver state detection section 6840 may further include a biosensor for detecting biological information associated with the driver, such as an electroencephalogram, pulses, body temperature, and exhaled breath.

The microcomputer 6801 is capable of calculating a control target value of the driving force generation device, the steering mechanism, or the braking device and outputting a control command to the drive system control unit 6821 on the basis of vehicle exterior or interior information acquired by the vehicle exterior information detection unit 6823 or the vehicle interior information detection unit 6824. For example, the microcomputer 6801 is capable of performing cooperative control for a purpose of achieving functions of ADAS (Advanced Driver Assistance System) including collision avoidance or shock mitigation of the vehicle, following traveling based on distances between vehicles, constant speed traveling, vehicle collision warning, vehicle lane departure warning, or the like.

Moreover, the microcomputer 6801 is capable of performing cooperative control for purposes such as automated driving for autonomously traveling without a necessity of operation by the driver, by controlling the driving force generation device, the steering mechanism, the braking device, or the like on the basis of information associated with surroundings of the vehicle and acquired by the vehicle exterior information detection unit 6823 or the vehicle interior information detection unit 6824.

Further, the microcomputer 6801 is capable of issuing a control command to the body system control unit 6822 on the basis of vehicle exterior information acquired by the vehicle exterior information detection unit 6823. For example, the microcomputer 6801 is capable of performing cooperative control, such as switching the headlamps from high beams to low beams for an antiglare purpose by controlling the headlamps according to a position of a preceding vehicle or an oncoming vehicle detected by the vehicle exterior information detection unit 6823.

The audio image output section 6802 transmits an output signal of at least either sound or an image to an output device capable of giving a notification of visual or auditory information to a passenger on the vehicle or to the outside of the vehicle. According to the system configuration example depicted in FIG. 68, there are provided an audio speaker 6811, a display section 6812, and an instrumental panel 6813 as the output device. For example, the display section 6812 may include at least either an on-board display or a head-up display.

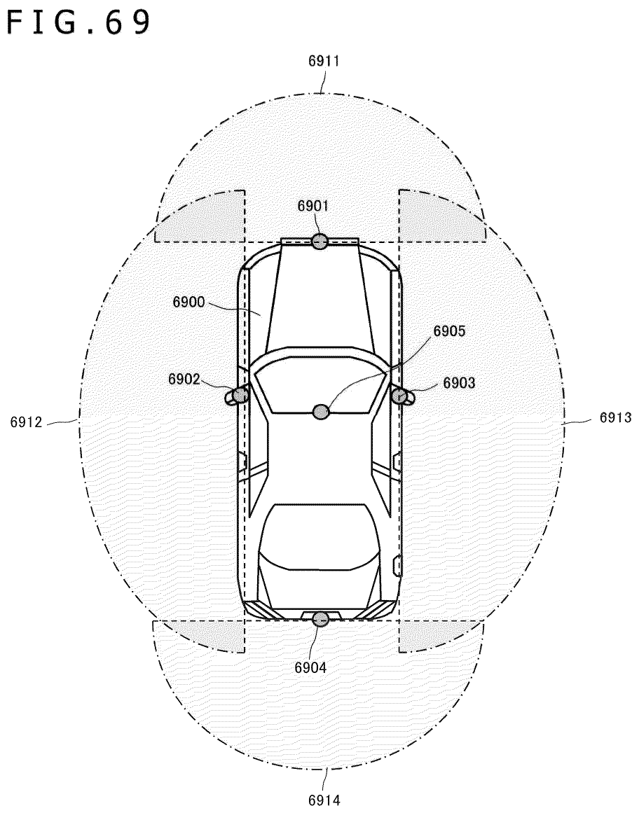

FIG. 69 is a diagram depicting an example of the installation position of the imaging section 6830. According to the example depicted in FIG. 69, a vehicle 6900 includes imaging sections 6901, 6902, 6903, 6904, and 6905 as the imaging section 6830.

For example, the imaging sections 6901, 6902, 6903, 6904, and 6905 are provided at positions such as a front nose, side mirrors, a rear bumper, a back door, an upper part of a windshield in a vehicle interior, and the like of the vehicle 6900. The imaging section 6901 provided on the front nose and the imaging section 6905 provided on the upper part of the windshield in the vehicle interior each chiefly acquire an image in front of the vehicle 6900. The imaging sections 6902 and 6903 provided on the left and right side mirrors chiefly acquire images on the left and right sides of the vehicle 6900, respectively. The imaging section 6904 provided on the rear bumper or the back door chiefly acquires an image behind the vehicle 6900. The front images acquired by the imaging sections 6901 and 6905 are chiefly used for detection of a preceding vehicle, a pedestrian, an obstacle, a traffic light, a traffic sign, a lane, or a road marking.

Note that FIG. 69 also presents an example of imaging ranges of the respective imaging sections 6901 to 6904. An imaging range 6911 represents the imaging range of the imaging section 6901 provided on the front nose. Imaging ranges 6912 and 6913 represent the imaging ranges of the imaging sections 6902 and 6903 provided on the side mirrors, respectively. An imaging range 6914 represents the imaging range of the imaging section 6904 provided on the rear bumper or the back door. For example, a bird's eye view image viewed from above the vehicle 6900 is obtained by overlapping pieces of image data captured by the imaging sections 6901 to 6904.

At least one of the imaging sections 6901 to 6904 may have a function of acquiring distance information. For example, at least one of the imaging sections 6901 to 6904 may be a stereo camera including a plurality of imaging elements or an imaging element having pixels for phase difference detection.

For example, the microcomputer 6801 is capable of extracting, as a preceding vehicle, a three-dimensional object that is particularly located nearest on a traveling road of the vehicle 6900 and is traveling at predetermined speed (e.g., 0 km/h or higher) substantially in the same direction as a traveling direction of the vehicle 6900, by obtaining distances to respective three-dimensional objects within the imaging ranges 6911 to 6914 and changes of these distances with time (relative speeds to the vehicle 6900) on the basis of distance information acquired from the imaging sections 6901 to 6904. Moreover, the microcomputer 6801 is capable of setting a distance between vehicles as a distance to be maintained from the preceding vehicle beforehand and issuing an instruction of automatic brake control (including following stop control), automatic acceleration control (including following departure control), or the like to the body system control unit 6822. In this manner, the vehicle control system 6800 is capable of achieving cooperative control for a purpose of automated driving for autonomously traveling with a necessity of operation by the driver, and other purposes.

For example, the microcomputer 6801 is capable of classifying three-dimensional object data indicating three-dimensional objects into a two-wheeled vehicle, a standard-sized vehicle, a large-sized vehicle, a pedestrian, an electric pole, and other three-dimensional objects on the basis of the distance information obtained from the imaging sections 6901 to 6904, and extracting the classified data to use the three-dimensional object data for automatic avoidance from obstacles. For example, the microcomputer 6801 classifies obstacles around the vehicle 6900 into obstacles visible for the driver of the vehicle 6900 and obstacles difficult to view for the driver. In addition, the microcomputer 6801 determines a collision risk indicating a level of danger of collision with the respective obstacles. When a collision risk has a setting value or higher and indicates a possibility of collision, the microcomputer 6801 is capable of offering driving assistance for avoiding collision with the obstacles by outputting a warning to the driver via the audio speaker 6811 or the display section 6812, or executing forced speed reduction or avoidant steering via the drive system control unit 6821.

At least one of the imaging sections 6901 to 6904 may be an infrared camera for detecting infrared light. For example, the microcomputer 6801 is capable of recognizing presence of a pedestrian by determining whether or not any of images captured by the imaging sections 6901 to 6904 contains a pedestrian. For example, this recognition of a pedestrian is achieved by a procedure for extracting feature points in the images captured by the imaging sections 6901 to 6904 which are infrared cameras, and a procedure for determining whether or not a pedestrian is present on the basis of pattern matching performed for a series of feature points indicating a contour of an object. When the microcomputer 6801 determines that a pedestrian is present in the images captured by the imaging sections 6901 to 6904 and recognizes this pedestrian, the audio image output section 6802 causes the display section 6812 to superimpose display of a square contour line for emphasis on the recognized pedestrian. Moreover, the audio image output section 6802 may cause the display section 6812 to display an icon or the like representing the pedestrian at a desired position.

### INDUSTRIAL APPLICABILITY

The present disclosure has been described in detail with reference to the specific embodiments. It is obvious, however, that those skilled in the art can make corrections or substitutions in association with the embodiments without departing from the subject matters of the present disclosure.

While described in the present description have been mainly the embodiments each applying the present disclosure to the imaging device which chiefly senses visible light, the subject matters of the present disclosure are not limited to these examples. Moreover, the present disclosure can be similarly applied to a device which senses various types of light such as infrared light, ultraviolet light, and X-rays to achieve speed-up and power saving according to reduction of a processing volume of the recognition process, and also achieve real-time presentation of a determination basis associated with a recognition result. Further, the technology according to the present disclosure can be applied to various fields to achieve speed-up and power saving of a recognition process and real-time presentation of a determination basis for a recognition result.

In short, the description of the present disclosure has been presented only in a form of examples. It is not intended that the present disclosure be limitedly interpreted on the basis of the contents of the present description. The claims should be taken into consideration in determining the subject matters of the present disclosure.

Note that the present disclosure may also adopt the following configurations.

(1)

An imaging device including:
an imaging section that has a pixel region where a plurality of pixels is arrayed;
a readout unit control section that controls readout units each set as a part of the pixel region;
a readout control section that controls readout of pixel signals from the pixels included in the pixel region for each of the readout units set by the readout unit control section;
a recognition section that has a machine learning model trained on the basis of leaning data; and
a determination basis calculation section that calculates a determination basis of a recognition process performed by the recognition section,
in which the recognition section performs the recognition process for the pixel signals for each of the readout units, and
the determination basis calculation section calculates a determination basis for a result of the recognition process performed for each of the readout units.
   (2)

The imaging device according to (1) above,
in which the recognition section learns learning data for each of the readout units by using a neural network model, and
the determination basis calculation section infers a part that is included in the pixel region of each of the readout units and that affects respective classes, in an inference result of classification obtained by the neural network model.
   (3)

The imaging device according to (1) or (2) above, in which the recognition section executes a machine learning process using an RNN for pixel data of a plurality of the readout units in an identical frame image, to execute the recognition process on the basis of a result of the machine learning process.

(4)

The imaging device according to any one of (1) to (3) above, in which the readout unit control section issues an instruction of an end of the readout to the readout control section when the recognition section outputs the recognition result meeting a predetermined condition, or when the determination basis calculation section calculates a determination basis meeting a predetermined condition for the recognition result.

(5)

The imaging device according to any one of (1) to (4) above, in which the readout unit control section issues, to the readout control section, an instruction to achieve the readout from the readout unit at a position where acquisition of the recognition result meeting a predetermined condition or presentation of a determination basis meeting a predetermined condition is expected, when the recognition section outputs a candidate for the recognition result meeting the predetermined condition, or when the determination basis calculation section is allowed to calculate a candidate for the determination basis meeting the predetermined condition.

(6)

The imaging device according to (5) above, in which the readout unit control section issues, to the readout control section, an instruction to read the pixel signals while thinning out the pixels contained in the pixel region for each of the readout units, and issues an instruction to achieve the readout of the readout unit where a recognition result meeting a predetermined condition or a determination basis meeting a predetermined condition is expected in the thinned-out readout units, in a case where the recognition section outputs the candidate.

(7)

The imaging device according to (1) above, in which the readout unit control section controls the readout units on the basis of at least one of pixel information based on the pixel signals, recognition information output from the recognition section, the determination basis calculated by the determination basis calculation section, or external information externally acquired.

(8)

The imaging device according to (1) above, in which the readout unit control section designates, as each of the readout units, a line including a plurality of the pixels arranged in one row of the array.

(9)

The imaging device according to (1) above, in which the readout unit control section designates, as each of the readout units, a pattern including a plurality of the pixels containing the pixels not adjacent to each other.

(10)

The imaging device according to (9) above, in which the readout unit control section arranges the plurality of pixels in accordance with a predetermined rule to form the pattern.

(11)

The imaging device according to (1) above, in which the readout unit control section sets priority for each of a plurality of the readout units on the basis of at least one of pixel information based on the pixel signals, recognition information output from the recognition section, the basis calculated by the determination basis calculation section, or external information externally acquired.

(12)

An imaging system including:
an imaging device including an imaging section that has a pixel region where a plurality of pixels is arrayed, a readout unit control section that controls readout units each set as a part of the pixel region, and a readout control section that controls readout of pixel signals from the pixels included in the pixel region for each of the readout units set by the readout unit control section; and
an information processing device including a recognition section that has a machine learning model trained on the basis of learning data, and a determination basis calculation section that calculates a determination basis of a recognition process performed by the recognition section,
in which the recognition section performs the recognition process for the pixel signals for each of the readout units, and
the determination basis calculation section calculates a determination basis for a result of the recognition process performed for each of the readout units.
   (13)

An imaging method executed by a processor, the imaging method including:
a readout unit control step that controls readout units each set as a part of a pixel region that is included in an imaging section and contains an array of a plurality of pixels;
a readout control step that controls readout of pixel signals from the pixels included in the pixel region for each of the readout units set by the readout unit control step;
a recognition step based on a machine learning model trained on the basis of leaning data; and
a determination basis calculation step that calculates a determination basis of a recognition process performed by the recognition step,
in which the recognition step performs the recognition process for the pixel signals for each of the readout units, and
the determination basis calculation step calculates a determination basis for a result of the recognition process performed for each of the readout units.
   (14)

A computer program written in a computer-readable form, the computer program causing a computer to function as:
a readout unit control section that controls readout units each set as a part of a pixel region that is included in an imaging section and contains an array of a plurality of pixels;
a readout control section that controls readout of pixel signals from the pixels included in the pixel region for each of the readout units set by the readout unit control section;
a recognition section that has a machine learning model trained on the basis of leaning data; and
a determination basis calculation section that calculates a determination basis of a recognition process performed by the recognition step,
in which the recognition section performs the recognition process for the pixel signals for each of the readout units, and
the determination basis calculation section calculates a determination basis for a result of the recognition process performed for each of the readout units.

### REFERENCE SIGNS LIST

100: Imaging device
101: Optical section
102: Sensor section
103: Sensor control section
104: Recognition processing section
105: Memory
106: Image processing section
107: Output control section
108: Display section
601: Pixel array section
602: Vertical scanning section
603: AD conversion section
604: Horizontal scanning section
605: Pixel signal line
606: Control section
607: Signal processing section
610: Pixel circuit
611: AD converter
612: Reference signal generation section
6800: Vehicle control system
6801: Microcomputer
6802: Audio image output section
6803: In-vehicle network IF
6810: Integration control unit
6811: Audio speaker
6812: Display section
6813: Instrumental panel
6820: Communication network
6821: Drive system control unit
6822: Body system control unit
6823: Vehicle exterior information detection unit
6824: In-house information detection unit
6830: Imaging section
6840: Driver state detection section

1. An imaging device comprising:
an imaging section that has a pixel region where a plurality of pixels is arrayed;
a readout unit control section that controls readout units each set as a part of the pixel region;
a readout control section that controls readout of pixel signals from the pixels included in the pixel region for each of the readout units set by the readout unit control section;
a recognition section that has a machine learning model trained on a basis of leaning data; and
a determination basis calculation section that calculates a determination basis of a recognition process performed by the recognition section,
wherein the recognition section performs the recognition process for the pixel signals for each of the readout units, and
the determination basis calculation section calculates a determination basis for a result of the recognition process performed for each of the readout units.

2. The imaging device according to claim 1,
wherein the recognition section learns learning data for each of the readout units by using a neural network model, and
the determination basis calculation section infers a part that is included in the pixel region of each of the readout units and that affects respective classes, in an inference result of classification obtained by the neural network model.

3. The imaging device according to claim 1, wherein the recognition section executes a machine learning process using an RNN for pixel data of a plurality of the readout units in an identical frame image, to execute the recognition process on a basis of a result of the machine learning process.

4. The imaging device according to claim 1, wherein the readout unit control section issues an instruction of an end of the readout to the readout control section when the recognition section outputs the recognition result meeting a predetermined condition, or when the determination basis calculation section calculates a determination basis meeting a predetermined condition for the recognition result.

5. The imaging device according to claim 1, wherein the readout unit control section issues, to the readout control section, an instruction to achieve the readout from the readout unit at a position where acquisition of the recognition result meeting a predetermined condition or presentation of a determination basis meeting a predetermined condition is expected, when the recognition section outputs a candidate for the recognition result meeting the predetermined condition, or when the determination basis calculation section is allowed to calculate a candidate for the determination basis meeting the predetermined condition.

6. The imaging device according to claim 5, wherein the readout unit control section issues, to the readout control section, an instruction to read the pixel signals while thinning out the pixels contained in the pixel region for each of the readout units, and issues an instruction to achieve the readout of the readout unit where a recognition result meeting a predetermined condition or a determination basis meeting a predetermined condition is expected in the thinned-out readout units, in a case where the recognition section outputs the candidate.

7. The imaging device according to claim 1, wherein the readout unit control section controls the readout units on a basis of at least one of pixel information based on the pixel signals, recognition information output from the recognition section, the determination basis calculated by the determination basis calculation section, or external information externally acquired.

8. The imaging device according to claim 1, wherein the readout unit control section designates, as each of the readout units, a line including a plurality of the pixels arranged in one row of the array.

9. The imaging device according to claim 1, wherein the readout unit control section designates, as each of the readout units, a pattern including a plurality of the pixels containing the pixels not adjacent to each other.

10. The imaging device according to claim 9, wherein the readout unit control section arranges the plurality of pixels in accordance with a predetermined rule to form the pattern.

11. The imaging device according to claim 1, wherein the readout unit control section sets priority for each of a plurality of the readout units on a basis of at least one of pixel information based on the pixel signals, recognition information output from the recognition section, the basis calculated by the determination basis calculation section, or external information externally acquired.

12. An imaging system comprising:
an imaging device including an imaging section that has a pixel region where a plurality of pixels is arrayed, a readout unit control section that controls readout units each set as a part of the pixel region, and a readout control section that controls readout of pixel signals from the pixels included in the pixel region for each of the readout units set by the readout unit control section; and
an information processing device including a recognition section that has a machine learning model trained on a basis of learning data, and a determination basis calculation section that calculates a determination basis of a recognition process performed by the recognition section,
wherein the recognition section performs the recognition process for the pixel signals for each of the readout units, and
the determination basis calculation section calculates a determination basis for a result of the recognition process performed for each of the readout units.

13. An imaging method executed by a processor, the imaging method comprising:
a readout unit control step that controls readout units each set as a part of a pixel region that is included in an imaging section and contains an array of a plurality of pixels;
a readout control step that controls readout of pixel signals from the pixels included in the pixel region for each of the readout units set by the readout unit control step;
a recognition step based on a machine learning model trained on a basis of leaning data; and
a determination basis calculation step that calculates a determination basis of a recognition process performed by the recognition step,
wherein the recognition step performs the recognition process for the pixel signals for each of the readout units, and
the determination basis calculation step calculates a determination basis for a result of the recognition process performed for each of the readout units.

14. A computer program written in a computer-readable form, the computer program causing a computer to function as:
a readout unit control section that controls readout units each set as a part of a pixel region that is included in an imaging section and contains an array of a plurality of pixels;
a readout control section that controls readout of pixel signals from the pixels included in the pixel region for each of the readout units set by the readout unit control section;
a recognition section that has a machine learning model trained on a basis of leaning data; and
a determination basis calculation section that calculates a determination basis of a recognition process performed by the recognition step,
wherein the recognition section performs the recognition process for the pixel signals for each of the readout units, and
the determination basis calculation section calculates a determination basis for a result of the recognition process performed for each of the readout units.
